(19) United States
(12) Patent Application Publication
(10) Pub. No.: US 2020/0254407 A1
(43) Pub. Date: Aug. 13, 2020

(54) SECURE PORTABLE, ON-DEMAND MICROFLUIDIC DEVICE FOR MIXING AND DISPENSING BLENDS OF LIQUIDS, SOLUTIONS, SUSPENSIONS, EMULSIONS, AND COLLOIDS

(71) Applicant: ALTOPA, INC., Raleigh, NC (US)

(72) Inventors: Matt WILSON, Vashon, WA (US); Scott Eric LIDDLE, Raleigh, NC (US); Keith GAUSMANN, Cary, NC (US); Jaysun GIESLER, Cary, NC (US); Nathan Thomas LUCK, Apex, NC (US); Lonnie Brent POOLE, Vashon, WA (US); Jon WHALEN, Vashon, WA (US); Todd WILSON, Delray Beach, FL (US); Pete CRAWFORD, Bend, OR (US); Nicole Kaylor WICKER, Raleigh, NC (US); Jon COLLETTE, Issaquah, WA (US)

(73) Assignee: ALTOPA, INC., Raleigh, NC (US)

(21) Appl. No.: 16/652,936

(22) PCT Filed: Oct. 9, 2018
(86) PCT No.: PCT/US2018/055054

§ 371 Date: Apr. 1, 2020

Related U.S. Application Data
(60) Provisional application No. 62/570,063, filed on Oct. 9, 2017.

(51) Int. Cl. B01F 13/10; B01F 13/00; B01F 15/02; B01F 15/06; B01F 5/06; B01F 3/08

(52) U.S. Cl. CPC B01F 13/1066; B01F 13/0059; B01F 13/1063; B01F 13/0033; B01F 15/0244; B01F 2015/062; B01F 15/065; B01F 5/0648; B01F 5/0655; B01F 3/0807; B01F 15/026

(57) ABSTRACT

A portable microfluidic mixer system includes a blend application to issue blend instructions, and a microfluidic mixer device. The microfluidic mixer device includes a housing, microfluidic pumps and valves within the device housing, a microfluidic dispenser, a microfluidic mixer chip, and a mix controller. The microfluidic mixer chip receives and meters microfluidic amounts of one or more fluids. The mix controller electronically communicates with the blend application to receives blend application blend instructions. The microfluidic mixer device includes fluid pathways for fluid communication between one or more fluid canisters and the microfluidic mixer chip, and between the microfluidic mixer chip and the microfluidic dispenser. The mix controller controls the microfluidic pumps and the microfluidic valves, to control a system pressure within the microfluidic mixer device, for the delivery of the one or more fluids to the microfluidic mixer chip, and to dispense a microfluidic mixture from the microfluidic dispenser.

### CROSS-REFERENCE TO RELATED APPLICATIONS

This application claims priority to and benefit of U.S. Provisional Application No. 62/570,063, titled “Secure Portable, On-Demand, Microfluidic Blender Device for Mixing and Dispensing Blends of Liquids, Solutions, Suspensions, Emulsions, and Colloids,” filed on Oct. 9, 2017, the disclosure of which is incorporated herein by reference in its entirety.

### BACKGROUND

Electric home appliances have automated repetitive tasks previously done manually. For example, electric kitchen mixers can replace stirring, whisking, and beating. Stand mixers, using a dough hook, can be used to knead bread. Electric kitchen mixers with a variety of speeds allow users to have more control over the mixing/blending process and the development of the mixtures.

### SUMMARY

Embodiments of the present disclosure of SECURE PORTABLE, ON-DEMAND, MICROFLUIDIC DEVICE FOR MIXING AND DISPENSING BLENDS OF LIQUIDS, SOLUTIONS, SUSPENSIONS, EMULSIONS, AND COLLOIDS (hereinafter “OBB” or “OBD”) include, by way of non-limiting example, a device configured for portable, on-demand, app-controlled (IoT), microfluidic mixing and dispensing, as well as microfluidic oil and fluid blending with enhanced content uniformity for vaping, transdermal patches, capsules, vitamins, aroma therapy, scents, perfumes, topicals, sublinguals, nutraceuticals, eye drops, cosmetics, lubricants, shampoos, hair conditioners, beverages, entertainment-related products, food, and pharmaceutical products. In some embodiments, the OBB can provide mixtures/blends with enhanced content uniformity, such as better than 10% variance, better than 9% variance, better than 8% variance, better than 7% variance, better than 6% variance, better than 5% variance, better than 4% variance, better than 3% variance, better than 2.5% variance, better than 2% variance, better than 1.5% variance, and/or better than 1% variance. In some embodiments, the OBB can be configured for use as a miniature compounding pharmacy. The attached Appendices include results from some sample studies of an embodiment of the OBB. In some embodiments, one or more ingredients can be micro-encapsulated prior to mixing, thereby extending the shelf life of the mixed formulations, extending the serviceable life of the OBB, facilitating viscosity management within the device, and/or facilitating cleaning the device (i.e., cleaning between blends), and/or facilitating blends of various ingredients (e.g., polar/nonpolar, oil/water, etc.).

Some embodiments include a device comprising a plurality of microfluidic pumps, microfluidic valves, pistons, solenoids, at least one heater, a microfluidic mixer chip and/or multiple microfluidic chips configured to receive and mix microfluidic amounts of a plurality of fluids having different viscosities from one another is disclosed. Some embodiments include multiple microfluidic chips (e.g., arranged serially or in parallel) such that one microfluidic chip or array of microfluidic chips can handle a first set of fluids and a second microfluidic chip or set of microfluidic chips can process a second set of fluids. The device includes a plurality of pathways defined therein for moving each of the plurality of fluids from a respective tank or reservoir to the microfluidic mixer chip. A mix controller is configured to control the microfluidic pumps, valves, pistons, solenoids, and optionally at least one heater so that the fluids having different viscosities can be accurately mixed at specified microfluidic amounts or volumes according to a specified microfluidic recipe, and the microfluidic mixture dispensed from the device.

In some embodiments, the device can be in communication with a software application implemented on a mobile compute device, such as a smartphone, and receive instructions for implementing the specified microfluidic recipe from the software application such that the operation of device components is at the direction of the software application executed on the mobile compute device. In some embodiments, the software application can provide functionality for one or more of: locating recipes for blending, customizing ingredients for a predetermined user, present educational information to a user regarding potential uses and/or benefits of ingredients, searching ingredients (locally and/or remotely) based on indication, desired effect, or potential benefit, and sharing of recipes (e.g., via text message, social media, and/or other network/internet-based platforms/communities).

Some embodiments include a microfluidic cannabinoid mixer system, comprising: a blend application implemented on a mobile compute device and a microfluidic mixer device. The microfluidic mixer device includes, a microfluidic mixer device hinged housing, at least one microfluidic pump, at least one microfluidic valve, a microfluidic dispenser, and a microfluidic mixer chip configured to receive and mix a microfluidic amount of a first cannabinoid oil, a microfluidic amount of at least one second cannabinoid oil, and a microfluidic amount of an at least one terpene to form a microfluidic cannabinoid mixture, the first cannabinoid oil and the second cannabinoid oil each having a viscosity different from a viscosity of the at least one terpene. Some embodiments can be configured to only include cannabinoids. The microfluidic mixer device includes a plurality of fluid pathways defined therein, including a fluid pathway providing fluid communication from a first cannabinoid canister (or “cartridge”) containing the first cannabinoid oil to the microfluidic mixer chip, a fluid pathway providing fluid communication from a second cannabinoid canister (or “cartridge”) containing the second cannabinoid oil to the microfluidic mixer chip, a fluid pathway providing fluid communication from a terpene canister containing the at least one terpene to the microfluidic mixer chip, and a fluid pathway providing fluid communication from the microfluidic mixer chip and a microfluidic dispenser, the microfluidic dispenser configured to receive the microfluidic mixture from the microfluidic mixer chip and dispense the microfluidic mixture from the device. The microfluidic mixer device also includes a microfluidic mixer chip heater configured to heat the microfluidic mixer chip and/or a canister heater configured to heat at least one of the first cannabinoid canister, the second cannabinoid canister, and/or the terpene canister. The microfluidic mixer device includes a mix controller in communication with the blend application implemented on the mobile compute device, and configured to, based on instructions received from the blend application, control each of the at least one microfluidic pump, the at least one microfluidic valve, the microfluidic mixer chip heater, and the canister heater, such that: (1) a microfluidic amount specified by the instructions from the blend application of the first cannabinoid oil is delivered to the microfluidic mixer chip, (2) a microfluidic amount specified by the instructions from the blend application of the second cannabinoid oil is delivered to the microfluidic mixer chip, (3) a microfluidic amount specified by the instructions from the blend application of the at least one terpene is delivered to the microfluidic mixer chip, (4) the microfluidic mixer chips mixes the first cannabinoid oil, the second cannabinoid oil, and the at least one terpene to form the microfluidic mixture, and (5) the microfluidic mixture is dispensed from the microfluidic dispenser. In some embodiments, there is a base or carrier fluid or material into which the microfluidic mixtures are added, e.g., a base oil, and the strength of a particular blend can be determined by the amount of the base or carrier percentage. Although discussed in terms of mixing of fluids occurring in a microfluidic mixer chip, it is to be understood that in some embodiments of the OBB, the microfluidic mixer chip (mixer chip, or chip) can instead accurately microfluidically meter and dispense the fluids (i.e., not actively mix the fluids together in the chip) and the mixing can occur in the a collection vessel such as a vial, vape cartridge, vape pen (or a straw thereof), bowl, etc. For example, when mixing occurs in a bowl-type vessel, a heated magnet (e.g., heated via induction) can be used to perform or assist with the mixing (e.g., of chocolate and/or lotions). Depending upon the implementation, the system can include one canister heater per canister, canister heaters only for each of a subset of the canisters (such that not all canisters are heated), or no canister heaters.

In some embodiments, a portable microfluidic system includes a software application configured to issue instructions based on a specified recipe, and a microfluidic recipe. The microfluidic device, includes a microfluidic device housing with a hinged articulated opening, a microfluidic pump and a microfluidic valve each disposed within the device housing, a microfluidic dispenser at least partially extending through the device housing, a microfluidic chip disposed within the device housing and configured to receive and meter a microfluidic amount of a fluid, and a controller disposed within the device housing and configured to electronically communicate with the software application and receive instructions therefrom. The microfluidic device includes a fluid pathway defined therein and contained within the device housing. The fluid pathway provides fluid communication from a fluid canister containing the fluid to the microfluidic chip, and a fluid pathway providing fluid communication from the microfluidic chip to the microfluidic dispenser. The microfluidic dispenser is configured to receive metered microfluidic amounts of the fluid from the microfluidic chip for dispensing. The controller is configured to communicate with the software application and receive instructions, and based on instructions received from the software application, perform steps. The steps include controlling the microfluidic pump and the microfluidic valve to control a system pressure within the microfluidic device, such that the fluid is delivered to the microfluidic chip, and the fluid is metered at a microfluidic amount according to the recipe to provide a microfluidic volume of the fluid. The steps also include controlling each of the microfluidic pump and the microfluidic valve such that the microfluidic volume of the fluid is dispensed from the microfluidic dispenser.

In some embodiments, ingredients are displayed to a user (e.g., through a user interface on the OBB or via a smartphone app), for example by percentage(s), gram quantity (e.g., milligrams), or volume quantity (e.g., milliliters or microliters). One or more of the cartridges can contain a whole plant extract, rather than an extract of a plant derivative or component. As discussed in further detail below, one or more of the ingredients can be nano-encapsulated or micro-encapsulated, for example, to achieve an “extended release” effect for a consumer of the completed formulation. In some embodiments, the OBB can provide/dispense solution, suspension, gel and/or the like with nanoparticles disposed therein, the nanoparticles providing a particular absorption profile and/or administration (e.g., buccal).

It should be appreciated that all combinations of the concepts discussed herein and detailed below (provided such concepts are not mutually inconsistent) are contemplated as being part of the inventive subject matter disclosed herein. In particular, all combinations of subject matter appearing in this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1C illustrates aspects of embodiments of the OBB according to the disclosure;

FIGS. 2A and 2B illustrate aspects of a pressure-driven pneumatic OBB with rotary valve control according to some embodiments of the disclosure;

FIGS. 3A and 3B illustrate aspects of pneumatic volume-driven OBB according to some embodiments of the disclosure;

FIGS. 4A and 4B illustrate aspects of fluidic volume-driven OBB according to some embodiments of the disclosure;

FIG. 5 is an overview of an OBB having pressure-driven pneumatics with solenoid control for a microfluidics mixer chip according to some embodiments of the disclosure:

FIG. 6A illustrates aspects of embodiments of the OBB in which transducers are aligned perpendicularly around a chamber, according to the disclosure;

FIGS. 6B and 6C provide example OBB structures for some embodiments according to the disclosure;

FIG. 7A provides an example fluidics diagram for some embodiments of the OBB;

FIG. 7B provides an example electrical architecture diagram for some embodiments of the OBB;

FIG. 7C provides an example basic circuitry diagram according to some embodiments of the OBB;

FIG. 7D and FIG. 7E provide additional electronic/circuitry details for some embodiments of the OBB:

FIG. 7F provides an example electronics architecture for some embodiments of the OBB;

FIG. 8A provides an overview of heating the OBB for some embodiments;

FIG. 8B and FIG. 8C provide an overview of microfluidic control in the OBB, according to some embodiments;

FIG. 8D provides an overview of system feedback for some embodiments of the OBB;

FIG. 8E and FIG. 8F provide an overview of microfluidic mixture dispensing for some embodiments of the OBB;

FIG. 8G provides an overview of inserting and/or replacing a microfluidic mixer chip, for some embodiments of the OBB;

FIG. 8H provides an overview of inserting and/or replacing fluid vials for some embodiments of the OBB;

FIG. 8I provides example user guidance illustrations for some embodiments of the OBB;

FIGS. 9A, 9B, and 9C illustrate example OBB microfluidic mixer chips for some embodiments according to the disclosure;

FIG. 10-FIG. 10D illustrate an example microfluidic mixer chip assembly according to some embodiments;

FIG. 10E-FIG. 10G are pictures of a heat-bonded FEP microfluidic mixer chip according to some embodiments of the disclosure;

FIG. 11A provides an overview of a OBB system cleaning implementation, according to some embodiments;

FIG. 12A shows a OBB microfluidic mixer chip with a plurality of fluid tanks/cartridges disposed thereon for some embodiments according to the disclosure;

FIGS. 12B and 12C illustrate valving for some embodiments according to the disclosure;

FIGS. 13A to 13F show examples of OBB fluid tanks for some embodiments according to the disclosure;

FIGS. 14A to 19B provide designs and configurations for some OBB embodiments according to the disclosure:

FIG. 20 provides an example OBB mobile device application user interface for some embodiments according to the disclosure:

FIGS. 21 and 22 provide example configurations for some embodiments of the OBB according to the disclosure;

FIGS. 23A to 23F provide details for example OBB chips according to some embodiments of the disclosure;

FIGS. 24A to 26E provide details for example OBBs according to some embodiments of the disclosure;

FIGS. 27A to 27E provide details for an example OBB with a cover removed according to some embodiments of the disclosure;

FIG. 27F provides details for an example OBB with cover removed with components labeled;

FIG. 27G shows a view of an example OBB showing the fluid dispensing region/cavity;

FIG. 27H shows an embodiment of the OBB in a base housing component with an activity indicator;

FIG. 27I shows an embodiment of the OBB in a base and middle housing;

FIGS. 28A to 28H provide internal details of some example OBBs according to some embodiments of the disclosure;

FIG. 29 provides a view of an example OBB microfluidic mixer chip according to some embodiments of the disclosure;

FIGS. 30A-30C shows an example OBB with the cover removed, and including removable reservoirs and an OBB microfluidic mixer chip;

FIG. 30D illustrates an example edit/create blend recipe flow for an OBB interface according to some embodiments;

FIG. 30E illustrates an example recipe/recipe collection overview for an OBB interface according to some embodiments;

FIG. 30F illustrates an example user profile and history overview for an OBB interface according to some embodiments;

FIG. 30G provides an example OBB mobile application architecture according to some embodiments;

FIG. 30H to FIG. 30V provide example user interfaces for an OBB mobile application according to some embodiments;

FIG. 30W provides examples of blends/recipes that the OBB produces;

FIG. 31 provides a flow chart illustrating an example OBB start sequence, according to some embodiments;

FIG. 31A illustrates an example OBB peripheral self-test flow, according to some embodiments:

FIG. 31B illustrates an example OBB pre-mix self-test flow, according to some embodiments;

FIG. 31C illustrates example OBB mix state processes, according to some embodiments;

FIG. 31D illustrates an example OBB mix state control flow, according to some embodiments; and

FIG. 31E and FIG. 31F provide a flow chart illustrating example OBB tablet/smart phone application processes, according to some embodiments.

FIG. 32 illustrates an example OBB microfluidic mixer chip for some embodiments according to the disclosure.

FIGS. 33A and 33B show renderings of an example vape cartridge tray in raised and lowered configurations, respectively, for some embodiments of the OBB.

FIG. 34A is a global view of a wireframe schematic showing elements of an application interface, and FIGS. 34B-34R are zoomed-in views of the constituent regions of the schematic of FIG. 34A.

FIGS. 35A-35G are photographic images of an implementation of an embodiment of the OBB, during use.

Appendix 1 includes a sample of some analytical tests performed on an implementation of an embodiment of the OBB.

### DETAILED DESCRIPTION

Following below are more detailed descriptions of various concepts related to, and embodiments of SECURE PORTABLE, ON-DEMAND, MICROFLUIDIC DEVICE FOR MIXING AND DISPENSING BLENDS OF LIQUIDS, SOLUTIONS, SUSPENSIONS, EMULSIONS, AND COLLOIDS (hereinafter “OBB”). It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Embodiments of the present disclosure include, by way of non-limiting example, a microfluidic chip and apparatus configured for portable, on-demand, app-controlled (IoT), microfluidic mixing and dispensing, as well as microfluidic blending for essential oils, whole plant oils, whole plant distillates, plant derivatives and/or plant isolates, e.g., for vaping, nasal sprays, aroma therapy, scents, entertainment products, and food.

In some embodiments, the OBB comprises a device that can store, mix to specific ratios in microliter quantities, and dispense a blend of fluids, on demand, to be ingested, vaped, inhaled, applied to the body, taken sublingually, etc. Embodiments of the OBB can be Internet-connected and controlled manually (e.g., via touch-screen and/or by a smartphone app), to produce a custom mixture or recipe using of the available onboard fluids. In some embodiments, the OBB can receive (e.g., via touch-screen and/or by a smartphone app) feedback from one or more users/consumers and adjust an ingredient set (e.g., including making adjustments to one or more ingredients or setting) in response to the feedback.

In some embodiments, the OBB is configured to receive input directly, via one or more of: a manual control (knob(s), dial(s), switch(es), etc.), an onboard electronic touchscreen panel, and/or remotely, via a Universal Serial Bus (USB), Bluetooth communication, WiFi® communication. Remote communication can be triggered, for example, in response to one or more of: manual control(s), dedicated hardware, a mobile software application (“app”), voice commands, gesture commands, a desktop software application, and a cloud computing network (“the cloud”).

Implementations of the OBB may be provided for the medical and/or cannabis industry for use in producing blends of, by way of non-limiting example, cannabinoid oils, terpenes, terpinoids, flavonoids, cannaflavins, various bases (such as propylene glycol, vegetable glycerin, etc), and/or “flavors,” for recreational and medicinal use in vaping, eating, aroma therapy, skin care, and/or the like. In some embodiments, a blend comprises a beverage including one or more cannabinoids and/or terpenes, and may optionally also include EtOH (C₂H₅OH), for example as a solubilizer, component, and/or base.

In some embodiments, a volatile solvent (e.g., EtOH, CH₃)₂CO), etc.) can be added during mixing/blending of ingredients, where the mixture is subsequently heated to a temperature sufficient to fully evaporate (i.e., “bake off”) the solvent, such that no (or substantially no) residue remains prior to dispensing of the formulation from the OBB, or in some implementations, where the dispensed mixture or blend is not for ingestion.

In some embodiments, the OBB can produce “Micro-vape” (e.g., 0.1 mL or less) for a user that wants a small (e.g., 5 puff, or 10 puff, or 20 puff, or 30 puff) vape. Alternatively or in addition, the OBB produces/dispenses a single-use vape formulation, e.g., in an amount of about 1 μL, or about 5 μL, or about 10 μL, or about 20 μL) for use in a single-use vape pen. Alternatively or in addition, the OBB produces/dispenses a blend having an elevated temperature and which, after cooling, crystallizes or hardens into a resin. Alternatively or in addition, the OBB produces/dispenses a blend suitable for use as a dab.

The OBB can also be used in the aromatherapy industry for customized blending of various aromatherapy oils to obtain varying effects not possible in single oil solutions. Also, in cooking, the OBB can be utilized to create customized blends of cooking oils with terpenes, esters, essential oils, whole plant oils, etc., to manipulate the subtle flavorings in the oil and subsequently the foods. Combining various skin care lotions with different terpenes is another of the numerous applications of the OBB. In some embodiments, the OBB can also be used for entertainment purposes, for example, by connecting the OBB and/or associated component (e.g., via a home network) to televisions, creating scents in public areas such as hotels or bars or different rooms within the home, computers gaming consoles, and/or VR devices and content, such as the OCULUS RIFT. The OBB (and/or associated components that use output from the OBB) can produce aromas that match the content being viewed on these devices. Accordingly, it could also be utilized in public places, such as movie theaters, hotels, and bars, to blend and provide particular smells. The OBB could also be used in the beverage industry in formulating consumables with certain flavors, smells, and/or other attributes (health, recreation, and/or medical purposes).

In some embodiments, the OBB is configured to place or trigger an automatic order and/or delivery of one or more ingredients (e.g., fluids) for a consumer when the OBB detects that one or more of the ingredients (e.g., fluids) has become depleted (e.g., is below a threshold re-order level).

In some embodiments, the OBB is a commercial device for creating custom blends of components (e.g., oils, waxes, flavors, etc.; generally referred to hereafter as “liquids” with the understanding that some may not be liquid at room temperature) for a diverse range of volumes (e.g., 0.1 nanoliters to 1 microliters, 0.01 microliters to 1 milliliter, 1 microliters to 10 milliliters, 100 microliters to 1 milliliter, etc.). Some implementations of the OBB are configured for cannabis extract and related markets, and provide users with the ability to mix chemical components found in cannabis, including cannabinoids and terpenes, and a base (e.g., propylene glycol, vegetable glycerin, a terpene blend, and/or the like). The OBB can include and/or be configured to utilize cartridges containing a set of mixing fluids/components.

In some embodiments, some or all of the fluids/components may be safety restricted (i.e., the OBB will only accept cartridges/containers that satisfy a specified authentication or source verification), while in additional or alternative embodiments, the OBB can be configured to allow a user or other party to fill/refill cartridges with specified or custom fluids, such as flavoring agents. In some embodiments, fluid cartridges can include a memory device component that can be read by the OBB to identify key information about the contents (e.g., fluid), including volume, viscosity, fill date/shelf life, etc. For user safety, some embodiments of the OBB can be configured to restrict or limit the types of additives/fluids that users can utilize to fill/refill a cartridge/container. Such limitations may be based on the amount to be added (either to the cartridge and/or to the end product), shelf life, viscosity, and/or the like. In some embodiments, the OBB can receive user input regarding additives/fluids through a mobile app. In some embodiments, cartridges/tanks/reservoirs are configured for secure/attach to an OBB, such as by a secure fitting, including a Luer taper fittings (Luer-locking and/or Luer-slipping), compression fittings, flare fittings, screw fittings, flange fittings, etc.

Embodiments of the OBB utilize microfluidic technologies in a compact, consumer-oriented commercial device to meter, mix, and dispense fluids in highly accurate, ultra-small amounts/volumes (including μL, nL, pL, and/or fL amounts, depending on the implementation and embodiment—generally referred to herein as “microfluidic amounts”), and do so in a way that that is repeatable. The OBB can be can be used in commercial, industrial, or medicinal environments, as well as in a consumer's home.

Embodiments of the OBB meter, mix, and dispense a custom mixture of a plurality of fluids/components. By way of non-limiting example, one implementation is configured to mix any quantity from 1 up to 24 fluids (e.g., four cannabinoids, one base, one user-filled cartridge, and a blend of terpenes and flavonoids) with a total volume ranging from 100 microliters to 3 milliliters in approximately one minute.

The OBB can meter as little as 0.1 microliter, 0.01 microliter, 1 nanoliter, or 0.1 nanoliters of a single fluid into an overall mixture. In some instances, the OBB is configured to keep dead volume to a minimum and thus provide efficient use of resources (e.g., cannabinoids which can be expensive, and/or other compounds that may have a short effective life once removed from their storage environment), and to reduce areas where cross contamination could occur to disposable or replaceable components. It is to be understood that the discussion of cannabinoids and oils herein is illustrative, and numerous other liquids can be utilized additionally or alternatively, including alcohols, organics, polar and non-polar solvents and liquids, propylene glycol, vegetable glycerin, medicines/pharmaceuticals, nicotine, extracts, artificial flavorings, natural flavorings, etc.

Functions of the microfluidic system in the OBB include: (1) metering controlled volumes of each fluid, (2) transporting fluid through the OBB, and (3) mixing the fluids. To handle the small volumes, some embodiments of the OBB use an array of small bore tubing. Other embodiments use one or more microfluidic chips with enclosed channels in order to provide efficient and hygienic components, and so can be replaced/recycled as needed. A number of methods and materials can be used to produce microfluidic chips according to the disclosure, and the methods and materials can be selected based on application, production capacity, cost, and/or complexity. Non-limiting examples of materials and production methods are provided below.

Silicon: Some embodiments utilize silicon. For some applications of the disclosure, silicon provides a versatile material for creating microfluidic and microelectromechanical devices due to its low electrical and high thermal conductivity and the ability to create complex features and devices through additive and subtractive processes. Silicon can also be scaled to large production volumes, but can be limited to applications having relatively lower flow rates, e.g., particularly if using piezo-driven pumps built into the silicon chip. In some instances, features of silicon, such as brittleness and/or appearance, may not be desired.

Glass: Some embodiments of the disclosure utilize glass. Glass can be used to create microfluidic channels and devices using etching processes. For some applications, glass can provide better thermal conductivity than polymers, can be easily coated, and is recyclable. However, for some applications, glass can be relatively more expensive than polymer (e.g., particularly in high volumes), and some manufacturing methods for glass microfluidics do not scale easily.

PDMS: Some embodiments of the disclosure utilize polydimethlysiloxane (PDMS) and/or like materials. Use of a flexible, cast elastomer, such as PDMS, allows for the incorporation of components, such as pumps and valves, directly into a chip according to the disclosure. Using soft lithography processes with a material such as PDMS, microfluidics according to the disclosure can be produced quickly. Materials such as PDMS can also bond to materials such as glass, and, in some embodiments, can thus be used to produce closed microchannels. Some designs utilizing PDMS may be configured for low aspect ratios which limit fluid flow rates.

Injection Molded Polymers: Some embodiments of the disclosure utilize injection molded polymers. Injection molding provides a cost-effective method for producing large volumes of microfluidic devices according to the disclosure. A wide variety of plastic resins can be used, depending on the implementation, and material(s) suited to the particular design/configuration are selected to meet particular specifications of an embodiment, such as fluid contact angle, permeability, and pH tolerance. Some embodiments may be configured from multiple materials and/or material types, and/or components moved off the chip, for example, in some embodiments, complex components, such as pumps and valves, may be moved off-chip for micro-injection molded microfluidics.

In some embodiments, the microfluidic chip is formed from stainless steel, aluminum, or any other suitable metal alloy.

Materials for the OBB, including but not limited to those noted above, can be configured to be appropriate for particular applications of the OBB. The OBB and/or components thereof (e.g., valves, connectors, pathways, etc.) are configured to be non-reactive or resistant to corrosive or otherwise reactive ingredients (e.g., made of or coated with non-reactive or resistant materials). For example, the OBB or portions thereof can be configured for handling terpenes, such as limonene, that could act as a solvent for certain materials, such as materials generally used for making laminated chips with laser cut or machined layers, or adhesives used to bond different layers together to create integrated valving in chips. Some embodiments of the OBB utilize materials and/or adhesives that are resistant to terpenes and other ingredients/oils. Some embodiments utilize alternative bonds/bonding methods, such as heat bonding, ultrasonic welding, and solvent bonding that are resistant to terpenes and other ingredients/oils. Various materials can be utilized for the OBB, and while some embodiments of the OBB are configured to be formed from a single source/material, in some embodiments, various materials are utilized for one or more of the rigid and/or elastomeric components of the OBB. For example, elastomeric components of the OBB can utilize fluoroelastomers or Teflon in PTFE, FEP, or PFA form. Additional details for configuring materials for some embodiments of the OBB can be found in U.S. Pat. App. Pub. No. 2016/0250639, and “Solvent resistant microfluidic platform for complete SiFA-based PET tracer synthesis” Rensch et al., J Nucl Med May 2014 vol. 55 No. Supplement 1 1247; the entirety of each of the aforementioned documents is herein expressly incorporated by reference for all purposes.

In some embodiments, one or more fluid pumps and/or active valves are configured to be and/or located within permanent components of an OBB and/or in replaceable fluid cartridges.

For metering and transport, a variety of pumping and valving components can be utilized. Some examples with non-limiting example configurations are provided below.

Piezoelectric-Driven Diaphragm Pump: Piezoelectric pumps can be utilized in a variety of configurations for the OBB. Piezoelectric pumps can be situated between the fluid cartridge and the mixer chip and used to meter fluid into the mixing path. This provides a direct way of controlling fluid flow with low lag time due to system elasticity and pressure drop. In some such embodiments, a separate pump is provided for each fluid cartridge. Such embodiments can be configured to address issues resulting from a pump diaphragm being in direct contact with a fluid to reduce or avoid residue buildup inside the pump or cross-contamination between fluids (e.g., using a materials or coating that do not accumulate buildup and/or utilizing a cleaning-cycle within the OBB).

Some embodiments can use a direct pumping configuration using piezo micropumps where one or more micropumps are built directly into the fluid cartridge(s). Such embodiments can reduce or eliminate the possibility for cross-contamination.

Pressure-Driven Microfluidics: Some embodiments can additionally or alternatively use diaphragm pumps (whether piezo-driven or cam-driven) to pneumatically pressurize the fluid cartridges, creating a pressure-driven system. Each fluid cartridge could still have its own pump, but the pump would only be in contact with air as it pressurized the fluid cartridge through a port in the top. The differential pressure between the fluid cartridge and the mixer chip would cause fluid to flow at a controlled rate directly related to the pump pressure and could be stopped by removing the drive voltage to the pump. Use of diaphragm pumps can prevent backflow as the diaphragm is sealed when the pump is off.

Some embodiments use a single pump to pressurize a pressure chamber, and use valve(s) to apply and release pneumatic pressure to each fluid cartridge individually. By maintaining a constant (or relatively constant) pressure inside the chamber, such embodiments can provide for improved control. The same pump and pressure chamber can be used to transport the fluids within the mixer chip to produce a continuous flow system that uses air or other gas (e.g., nitrogen) as the carrier. Such embodiments can also be configured to allow for the use of air or other gas to purge the mixer chip (and/or the entire flow path of the system) at the completion of each use cycle, and thereby improve safety, reliability, and prolong the service life of the mixer chip. It is to be understood that generally, when air is referred to in the context of some example embodiments, other or additional embodiments may be configured to use a gas or mixtures of gasses different from atmospheric air. For example, some embodiments can be closed loop systems that include non-reactive gas or gasses therein, depending on the liquids/ingredients being processed (e.g., nitrogen can be used for terpenes).

Syringe Pump: Some embodiments of the disclosure utilize one or more syringe pumps. A syringe pump can be used to dispense fluid from each cartridge into the mixer chip. In some embodiment, a single syringe pump is used for all of the cartridges along with a carousel to index each cartridge into place. Such embodiments can be configured with precision motors, e.g., one for the syringe pump and another for the carousel, to achieve a balance of speed and precision using a single mechanical pump, and avoid the potential for metering error caused by flow pulsations.

Peristaltic Pump: Some embodiments of the disclosure utilize one or more peristaltic pumps. Some such embodiments include a permanent (or semi-permanent) tubing set that is contacted by rollers that force fluid through the system. Peristaltic pumps provide high accuracy, and the tubing set can be configured to be replaced periodically as it wears over time.

The pump (or pumps) can be selected for the particular application and implementation of the OBB. For example, a pressure-driven system has a variety of benefits, as discussed above, and may be preferred for some embodiments, depending on precision and size parameters. As another example, a direct fluid-driven piezo pump provides high accuracy, but may not be suitable for some embodiments that have a relatively high flow rate. Depending on the embodiment, the pump or pumps can be integrated as part of the OBB (either permanent or semi-permanent), and/or integrated into the fluid cartridge(s). The OBB can be configured to clean, purge, and/or sterilize the system, including cleaning a pump diaphragm after it has come into contact with fluids.

The OBB can utilize a variety of methods and mechanisms to provide mixing, including passive microfluidic mixing and active microfluidic mixing. Passive mixing can be provided with OBB systems having tortuous paths configured into the mixer chip that can take a variety of shapes, including zigzags, delta patterns, obstructions, and/or orifices. Active mixing can be provided with OBB systems that utilize the application of an external energy source to achieve mixing, such as acoustic waves, magnetic stir bars, thermal energy, and/or electrical fields. The methods and mechanisms used can be configured based on the application(s), for example, temperature changes may have undesirable effects on some liquids, such as cannabis extracts, and electrical fields may be most effective on polar molecules as in water-based solutions (and may not be as effective for other less-polar or non-polar fluids utilized in some applications).

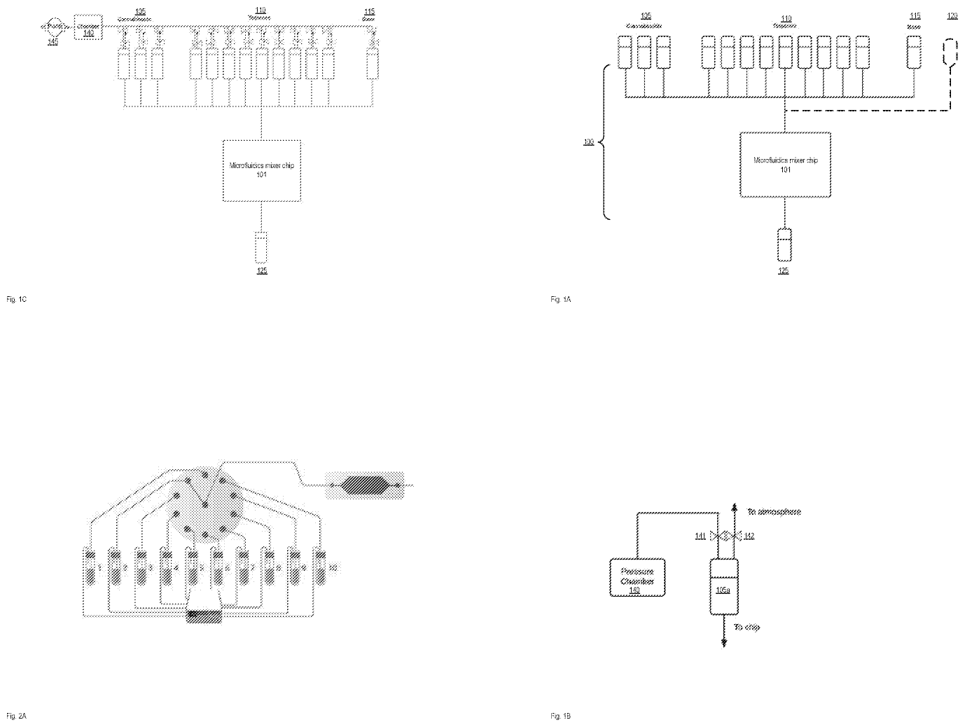

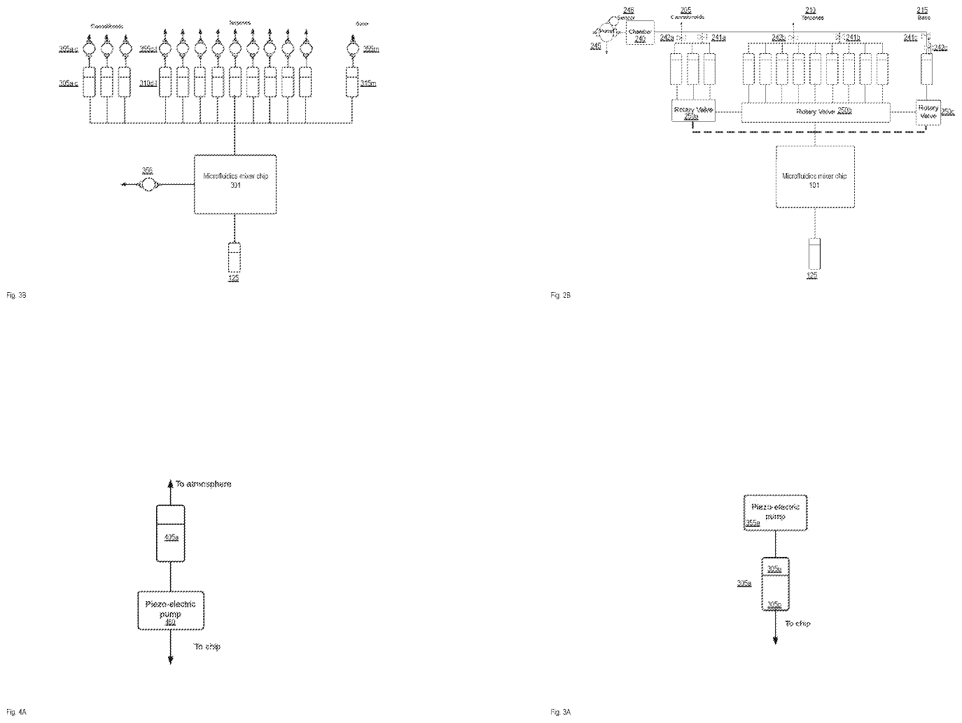

FIG. 1A provides an example overview of one implementation of the OBB 100 configured to meter, mix, and dispense fluids according to the disclosure. Such embodiments can include additional components discussed in the disclosure, such as a wireless communications interface, housing, heaters, etc. A variety of housing materials can be used, including plastic, metal, anodized metal, glass, etc., and some housings can be configured with removable sections or skins. The illustrated embodiment includes an array of liquid vials containing a combination of cannabinoids 105, terpenes 110, and bases 115. A user-filled vial 120 can also be included, depending on the implementation.

The cannabinoids 105, terpenes 110, and base 115 tanks/vials/cartridges/canisters are loaded/attached to (i.e., put in fluid communication with) the OBB 100 and the contents thereof received into the OBB 100 and mixed in a microfluidics mixer chip 101. The mixed fluids are dispensed via an outlet and/or dispenser to a vial 125 or other receptacle that can be changed per use. The microfluidics mixer chip 101 can, in some embodiments, include multiple mixer components/paths for mixing, depending on the fluids and/or amount thereof to be mixed.

In some embodiments, fluids are moved using one or more diaphragm pumps, which can draw in a gas or fluid and forces it out due to the movement of the diaphragm. Piezo-electric diaphragm pumps can create a deformity in the diaphragm used to move the gas or fluid by applying a voltage. A variety of configurations using such pumps can be utilized for moving the fluids, depending on the embodiment. For example, a piezo-electric pump can be used to create a pressure chamber and provide a pneumatic mechanism in which the pump only pushes air into the chamber and is not in contact with the fluid. The pressure chamber can then be directed to different tanks. In some implementations, each tank can be configured with two, two-way solenoid valves that connect directly to a port on the top of the fluid tank. By controlling the solenoid valves, pressure can be applied or relieved from each fluid tank, thereby controlling the flow of fluid from the tank into the mixer chip. FIG. 1B is a diagram illustrating the pressure chamber 140 connected to a tank 105a having solenoid valves 141, 142. FIG. 1C shows a diagram illustrating single pressure chamber 140 and pump 145 incorporated into an OBB system, and where the fluid tanks in the system include two, two-way solenoid valves.

Some implementations may be configured with a single diaphragm pump, while other implementations can utilize more than one pump, and as such, may not utilize the two, two-way solenoids for each tank (and/or may reduce the number of solenoids based on using pumps for a subset of tanks). In some instances, the pressure in the chamber can be varied based on the total amount of fluid being dispensed. For example: if a smaller total volume of fluid, such as 100 microliters, is being mixed then the pressure is set to a lower level. The fluid will flow at a slower rate, providing increased control over the dispense volume. If a larger amount of fluid, such as one milliliter, is being mixed then the pressure can be set to a relatively higher level, increasing the flow rate so the user does not have to wait an extended period of time for the product. Depending on the embodiment and implementation, the percent error on the accuracy for the larger fluid and greater pressure can be comparable to that of the smaller fluid with lesser pressure.

Such pressure-driven embodiments can be configured based on the viscosities of each of the fluids (e.g., by determination when a tank is inserted and/or by providing/requiring tanks that have fluids of known viscosity). As pressure is applied to the fluid for a controlled amount of time through a microfluidic path of known dimensions, a known volume will be dispensed.

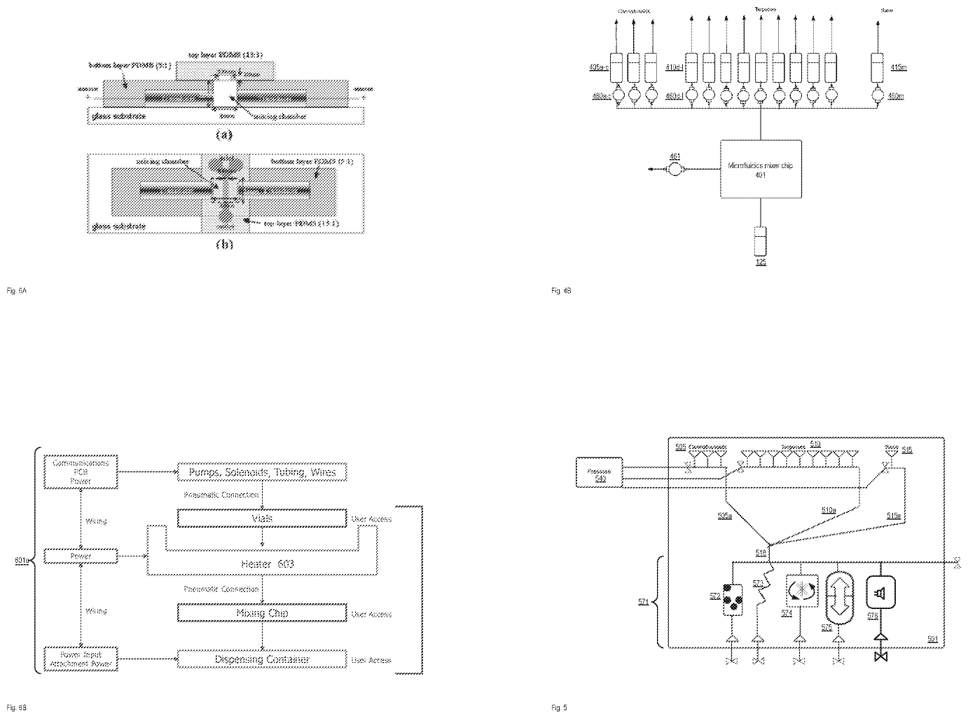

FIG. 2A illustrates a pressure-driven pneumatic system with rotary valve control according to some embodiments of the OBB. Such embodiments can include one or more rotary valves (e.g., in a mixer chip), and thereby reduce the number of valves (e.g., relative to the embodiment illustrated in FIG. 1C) required for a pressure-driven system. In some implementations of such embodiments, one, some, or each rotary valve is controlled by a servo or stepper motor in the OBB. As the OBB turns the rotary valve to a specific position, a single fluid can flow from its respective tank to the mixing chamber while obstructing all other fluid paths, as shown in the figure. FIG. 2B illustrates a pneumatic pressure-driven OBB system with rotary valves. In some embodiments, to address viscosity differences between the fluids (e.g. the viscosity difference between cannabinoids and terpenes), such a rotary valve may be provided based on groups of fluids with relatively similar viscosities (e.g., a terpenes group and a cannabinoids group). As shown in FIG. 2B, the OBB includes a pump 245, pressure chamber 240, and sensor 246, along with separate rotary valves for groups of liquids (i.e., a rotary valve 250a for cannabinoids group of tanks 205, with a two, two-way solenoids 241a, 242a for that group; similarly for the terpenes group of tanks 210 and base tank 215). Such embodiments can be configured so that each group has its own rotary valve (e.g., 250a, 250b, 250c), each with a different channel size to meet the various flow requirements for that group. The rotary valves can be connect to each other and/or connected directly to the microfluidics mixer chip 101. Table 1 below provides example viscosities of ingredients that are utilized in some embodiment of the OBB, along with their respective temperature sensitivities.

TABLE 1

| | Viscosity | Viscosity | Sensitivity |
|---|---|---|---|
| Sample | @ 60 C. | @ 70 C. | (%/C.) |
| CBD 80% | 124.40523 | 67.07008 | 4.6 |
| CBG 80% | 46.08678 | 28.9006 | 3.7 |
| THC 80% | 582.98408 | 219.13165 | 6.2 |
| PEG | 13.20703 | 9.97539 | 2.4 |
| PG | 8.68223 | 6.10031 | 3.0 |
| Bisabolene | 1.50375 | 1.29836 | 1.4 |
| L-Borneol | 3.35655 | 2.30842 | 3.1 |
| delta-3-Carene | 0.72011 | 0.63903 | 1.1 |
| beta-Caryophyllene | 3.02548 | 2.49506 | 1.8 |
| 1-8-Cineole | 1.39024 | 1.18889 | 1.4 |
| Citronellol | 3.13805 | 2.43081 | 2.3 |
| d-Limonene | 0.59933 | 0.54232 | 1.0 |
| Linalool | 1.44909 | 1.17585 | 1.9 |
| Myrcene | 249.1163 | 221.55281 | 1.1 |
| Nerolidol | 3.44688 | 2.68387 | 2.2 |
| trans beta-Ocimene | 0.6227 | 0.55306 | 1.1 |
| alpha-Pinene | 0.82406 | 0.72887 | 1.2 |
| beta-Pinene | 0.96999 | 0.85135 | 1.2 |
| alpha-Terpinene | 0.59094 | 0.53321 | 1.0 |
| Terpinolene | 0.72378 | 0.64495 | 1.1 |
| alpha-Terpineol | 4.39011 | 3.02056 | 3.1 |

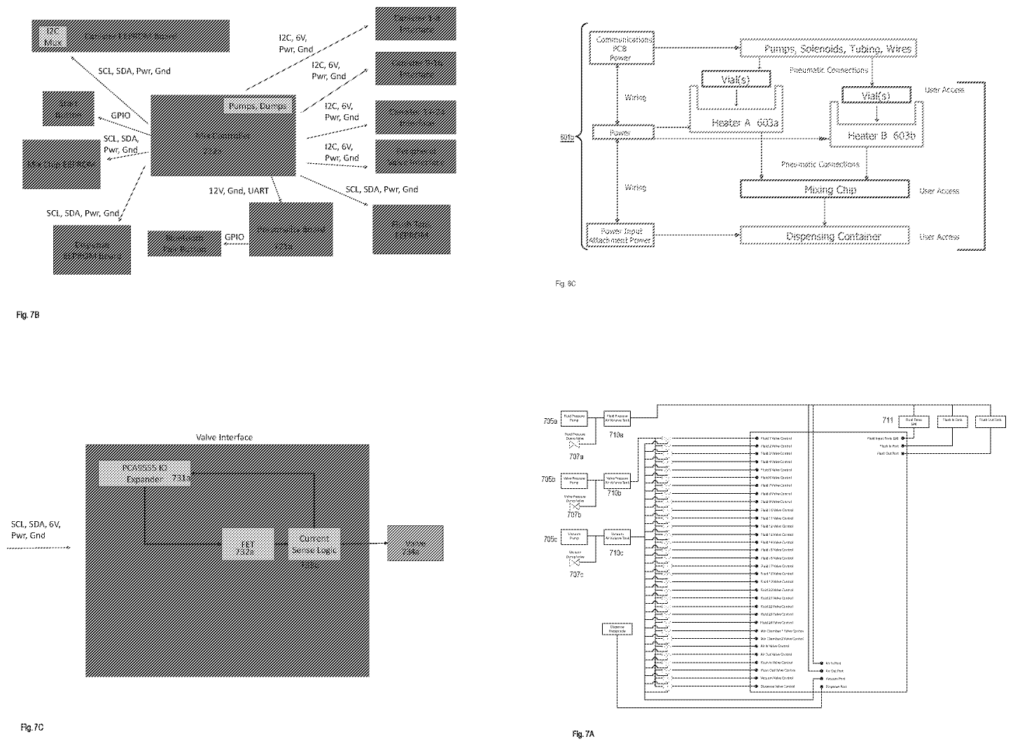

Some embodiments of the OBB include pneumatic volume-driven micropump(s). Such embodiments of the OBB can include a separate pump for each tank, and can utilize different pressures to be used to different fluids from their respective tanks. Such embodiments can in turn provide for the flow rates of fluids with different viscosities to be closer to one another and therefore facilitate coordinating the timing of the meeting of fluids/groups of fluids, in the mixing chamber and/or prior to entry into the mixing chamber. Additionally, multiple pumps can be run simultaneously and reduce the overall dispense time. FIG. 3A shows an example pneumatic volume-driven configuration using separate pump for some embodiments of the OBB. Following the configuration shown in FIG. 3A, a pump 355 can be situated above the fluid tank 305a and pumps air (and/or another gas, such as nitrogen) into the upper portion 305u of the tank, causing fluid to flow through a port 305P on the bottom of the tank to the mixer chip. In such an embodiment, since only air/gas would be flowing through the pump, the potential for cross-contamination between fluids and the potential for residual buildup within the body of the pump is reduced or eliminated. FIG. 3B illustrates pneumatic volume-driven OBB system with separate pumps 355a-m for each tank in the groups of cannabinoids tanks 305a-c, terpenes tanks 310d-l, and base tank 315m. A pump 356 (or multiple pumps) can also be provided for the microfluidics mixer chip 301. Each pump can be controlled to infuse a controlled volume of air or other gas into the respective fluid tank. The pressure in the tank rises and causes fluid to flow from the port in the bottom of the tank. As it does, the pressure in the tank will decay until it reaches equilibrium. Such embodiments can be configured to handle variable fluid flow rates resulting from such volume-based pumping (i.e., the fluid flow rate will not be constant because the pressure is changing over time).

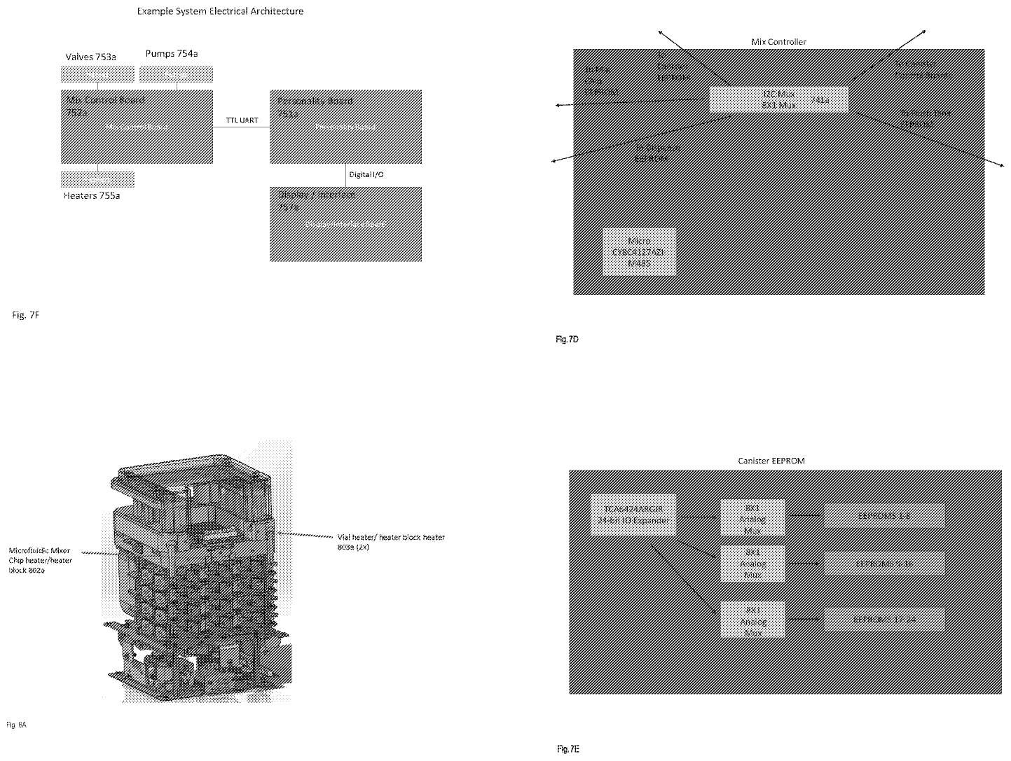

In some embodiments, the OBB is configured with one or more fluidic volume-driven micropumps, such as illustrated in FIG. 4A. In such embodiments, a pump 460 is in direct contact with the fluid from the tank 405a. Although illustrated with the tank 405a open to (i.e., in fluid communication with) the atmosphere, some embodiments can provide an inert/sterile alternative for one, some or all tanks, such as nitrogen gas. Such implementations can be configured to exposure to the atmosphere (which could contaminate and/or cause degradation of certain fluids), and/or to provide security (i.e., so no fluids could unintentionally leave the OBB if it is tipped over, etc.). Depending on the implementation, the pump can be integrated in to the tank design, or the pump can be a permanent/semi-permanent component in the OBB, and in either implementation, fluid is processed/forced through the pump 460. In configurations where pump is permanent/semi-permanent, the OBB can be configured with a cleaning/cleansing cycle to clear/remove residual fluid from the pump periodically (e.g., when swapping/changing out tanks). For embodiments where a pump is integrated into the fluid tank, the pump can be disposed of/recycled as fluids/fluid tanks are changed out. In the case of a permanent/semi-permanent pump, the OBB can be configured to purge the dead volume and any residual fluid from the system when changing fluid tanks, such as by running the pump when the fluid cartridge is removed to pump air (or other fluid/gas, such as nitrogen, water, dilute H₂₀₂, H₂O/EtOH mixture, etc.) through the line and thereby clean it out. Additionally or alternatively, the OBB can provide a clean or rinse cycle/setting in which sterile/non-toxic fluids are run through the OBB. Such a configuration can include one or more cleaning cartridges, and such cleaning cartridges can be configured for general use (i.e., cleaning the whole system) or for cleaning a particular liquid (e.g., for cleaning a cannabinoids pump, the cartridge includes a liquid (e.g., EtOH) configured to remove high viscosity liquid buildup from a cannabinoids path and pump). FIG. 4B illustrates a fluidic volume-driven OBB system with micropumps 460a-m for each tank in the group of cannabinoids tanks 405a-c, terpenes tanks 410d-l, and base tank 415m. In some embodiments, the base tank 415m and micropump 460m can be used to dispense the product, while in some embodiments, a separate pump 461 (or multiple pumps) can additionally or alternatively be provided for the microfluidics mixer chip 401 (to dispense the mixture and/or to clean the chip).

Although the above discussion addresses various methods and configurations as separate embodiments, it is to be understood that the disclosed methods and configurations can be used together in some embodiments of the OBB. For example, some embodiments can utilize pressure-driven pneumatics with rotary valve control in concert with fluidic volume-driven micropumps. While some aspects and features of the OBB are discussed in the context of particular embodiments for brevity and to facilitate understanding of the OBB, it is to be understood that such aspects and features are not limited to those particular embodiments. For example, if a feature or component were discussed in the context of an embodiment having pressure-driven pneumatics with solenoid valve control, it is to be understood that the disclosure includes that feature or component applied to an embodiment having volume-driven pneumatics with micropumps.

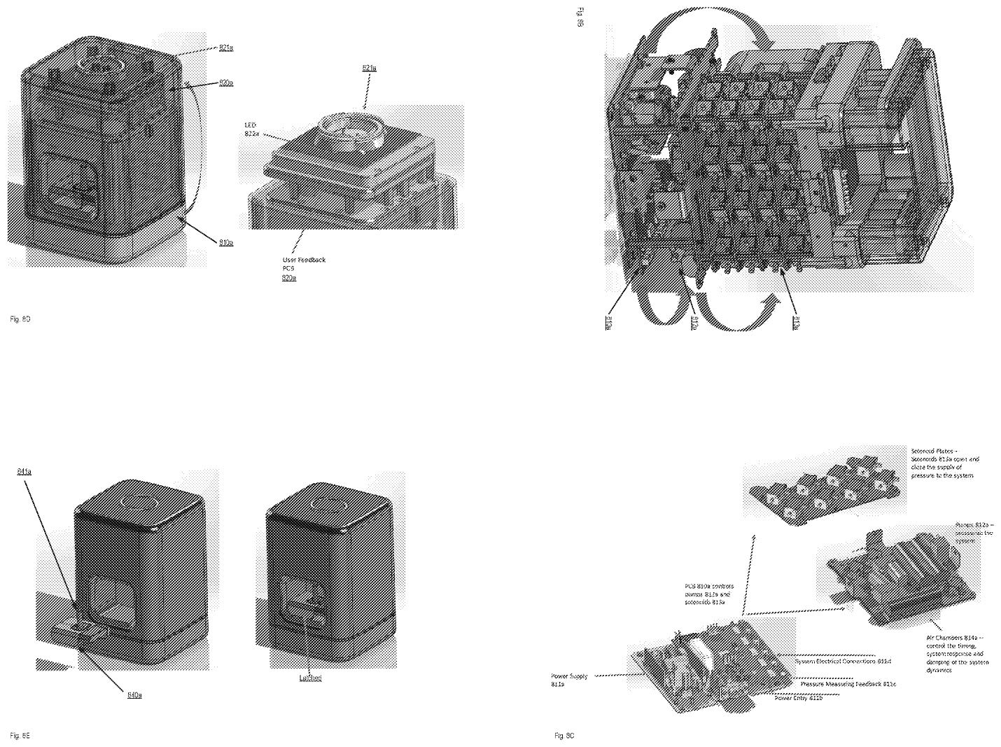

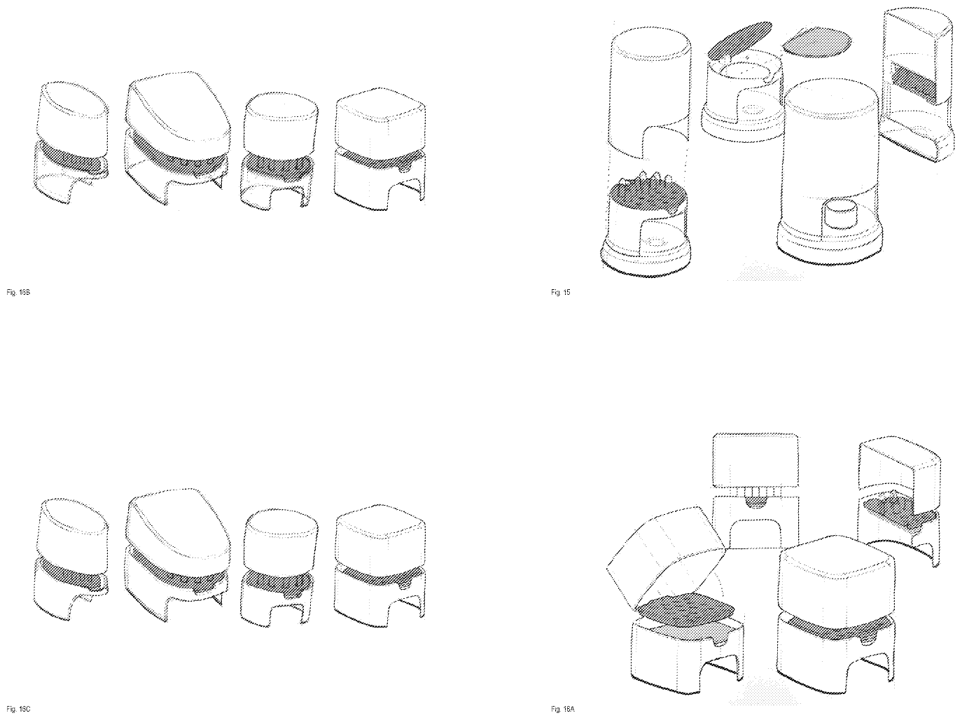

FIG. 5 provides an overview of an embodiment of the OBB having pressure-driven pneumatics (e.g., via a pressure tank 540) with solenoid control for a microfluidics mixer chip 501. In this embodiment, the cannabinoids 505 are joined together in a group/channel 505a and the terpenes 510 are joined together in a group/channel 510a, creating three groups of fluids (505a, 510a, and the base 515a), with the only dead volume being that which exists in the fluid path from each tank prior to joining the main group/channel 518. The fluids then all flow towards the mixing region 571 at the same time. Since microfluidic mixing can be complicated for certain fluids, particularly fluids that have laminar flow, streamlined in the forward direction parallel to the channels, and some types of mixing microfluidics can create chaotic or potentially turbulent flow, a OBB can be configured to provide a variety of mixers/mixing options, each of which can be controlled or valved, so that, depending on the mixture/fluids, the correct mixer(s)/mixing option(s) can be utilized at the correct time(s). The fluid(s) continue down the designated mixing region(s) and are then directed to an output container. One or more passive mixers/mixing regions and/or chambers for active mixing/mixers can be incorporated into one microfluidic mixer chip. Passive mixing regions can include a region with barriers built-in the passage throughout 572, a zig-zag type mixer 573 (see also FIG. 9A), etc. (e.g., as illustrated by the microfluidic mixer chip of FIG. 9B). The barriers in 572 cause the fluids to move in a turbulent manner, and overall, forces different fluids to mix together. The zig-zag pattern mixer 573 can also cause turbulent flow and mixing. Either or both can be utilized, depending on the application/implementation, and configured to provide proper timing of the different fluids so that they reach the mixing area at the same (or substantially the same) time. Such passive mixers can have the benefit of being built into a OBB chip with no additional features (e.g., wiring) required to be added, and also may not require additional outside energy, such as electricity.

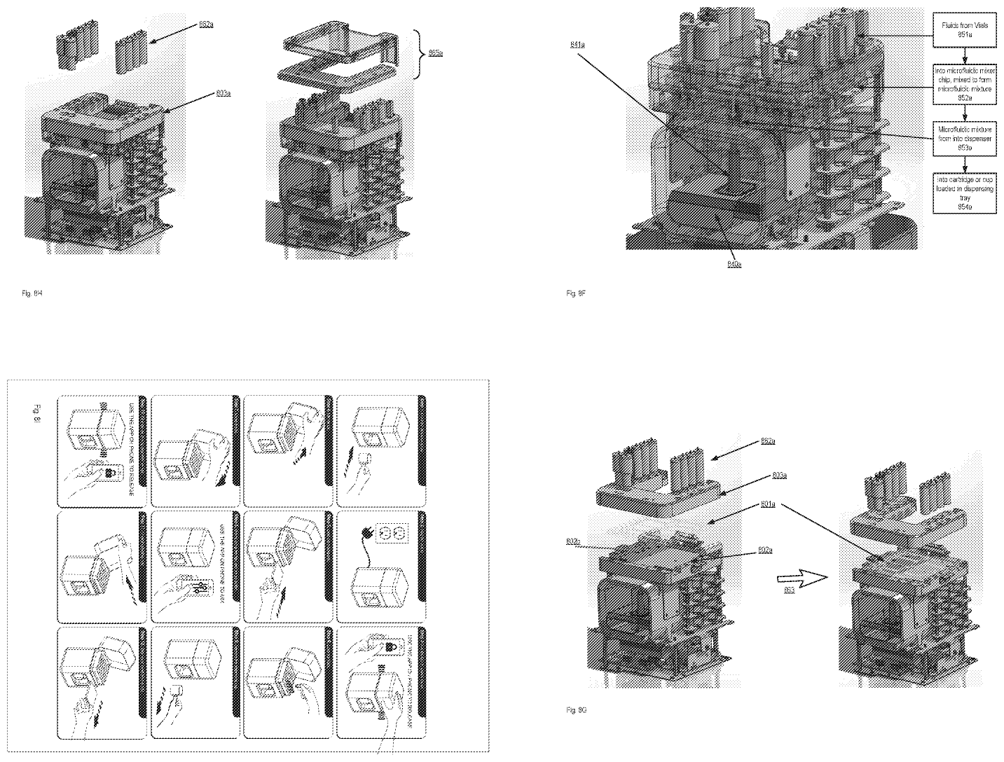

In some embodiments, active mixers/active mixing regions are additionally or alternatively included. Such active mixers can, for some implementations, provide more coherent/comprehensive mixing of certain fluids when compared to passive mixers. Active mixers/active mixing regions include ultrasonic wave mixing/mixers 576 and/or magnetic stirring 574. In some instances, ultrasonic wave mixing is conducted using one or more piezoelectric transducers that generate the ultrasonic waves by rapidly expanding and contracting when electrical voltage is applied. The configuration of such ultrasonic mixers can be changed depending on the implementation. As an example, the transducers can be placed such that they are aligned perpendicularly outside the chamber, as shown in FIG. 6A. The transducers in FIG. 6A are on both sides of the channel and point into the mixing region, causing mixing perpendicular to the flow of fluid and creating effective mixing. Alternatively, or additionally, a magnetic stirring mixer 574 can be provided, such as by a small stir bar disposed inside a built-in mixing region. An alternative can include a plurality of tiny magnetic beads inside such a region, either alone or in addition to a larger stir bar. A magnetic field is created by conductors, and the OBB can utilize a miniature magnetic stir plate, or conductors can be integrated into the design of the microfluidic mixer chip and/or OBB, and/or conductors could be embedded in a substrate below the channel. Another active mixing region/active mixer option can utilize opening different valves to force fluid back and forth in a region 575 with a middle/central aperture (e.g., resembling an hourglass shape) that facilitates the mixing (e.g., see also the microfluidic mixer chip illustrated in FIG. 9C).

The OBB can include one or more heaters/heating elements, and such heaters and heating controlled by the OBB. In some implementations, individual paths or portions thereof in a microfluidic mixer chip can be heated based on the fluid specified for that path (e.g., a path configured to carry a substance that is wax-like at room temperature can include a heater, while a path that is configured to carry a low viscosity fluid may not include a heater). Alternatively or additionally, the OBB can be configured to heat tanks/cartridges (or a subset thereof) prior to entry of the fluid into the OBB or microfluidic mixer chip. Some embodiments can include heaters for certain tanks, while other embodiments can utilize tanks that include a heater or heat element therein. Additionally or alternatively, the microfluidic mixer chip can be heated by the OBB to facilitate measuring and mixing the different fluids.

FIG. 6B and FIG. 6C provide example OBB system structures according to some embodiments. The embodiment illustrated in FIG. 6B, the OBB system 601a utilizes a single heater 603 to heat the vials/tanks/cartridge(s). In the embodiment illustrated in FIG. 6C, the OBB system 601b utilizes two heaters, 603a, 603b, to heat different groups/sets of vials/tanks/cartridge(s), and can be used to set different heats for different components/regions of the system, and/or to set one or more heat gradients or heat differentials within the OBB system 601b. It is to be understood that, depending on the implementation and/or embodiment, heaters can be provided for each vial, a set of vials, one or more flow paths, one or more regions, or a combination thereof, depending on the particular use and/or configuration.

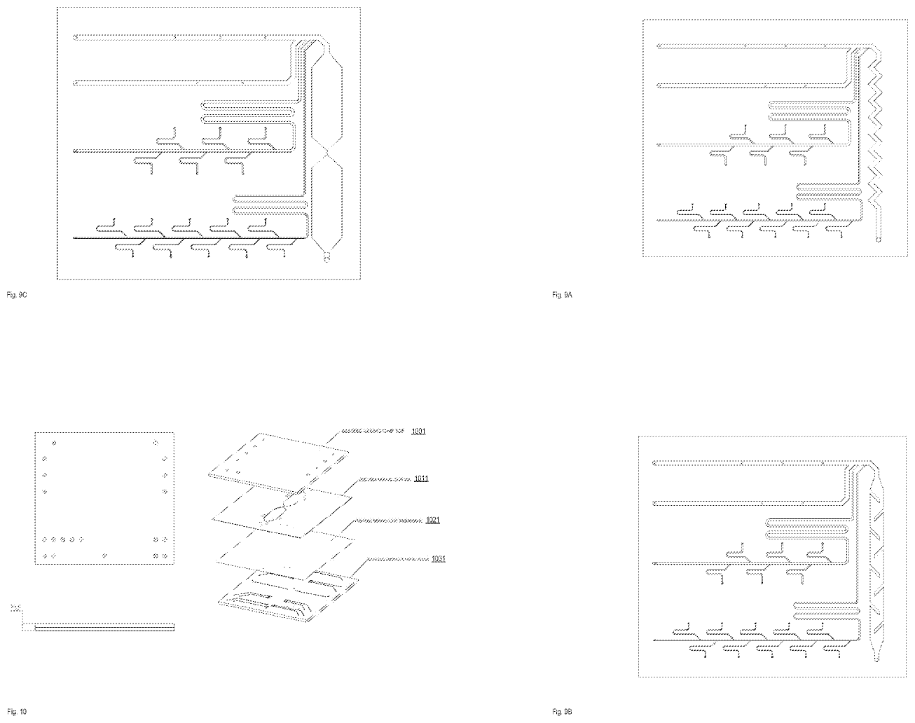

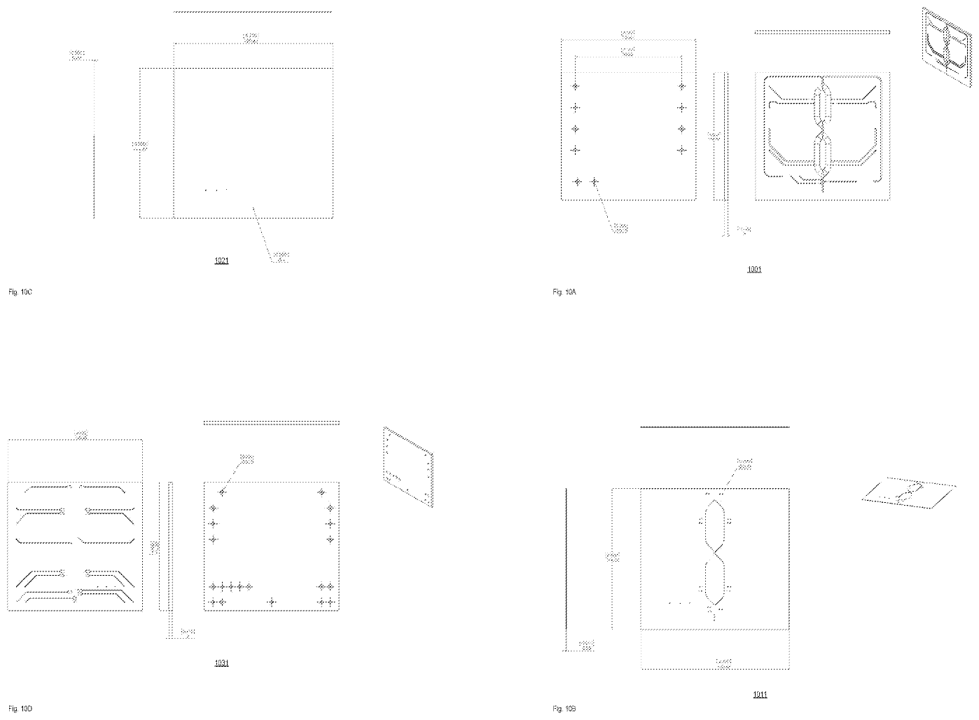

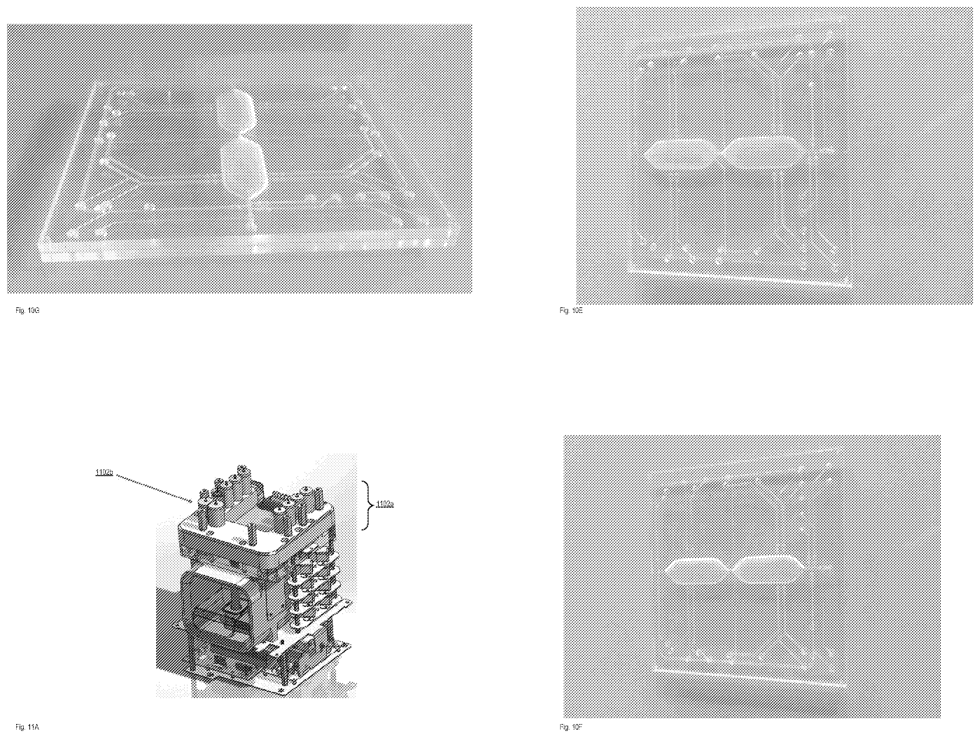

FIG. 7A provides an example fluidics diagram for some embodiments of the OBB. As shown, each of the pumps (including fluid pressure pump 705a, valve pressure pump 705b, vacuum pump 705c), dump valves (including fluid pressure dump valve 707a, valve pressure dump valve 707b, vacuum dump valve 707c), and solenoid valves is independently controlled (e.g., by a mix board/mix controller/mixer controller). For example, in some embodiments, the general process is that the valve pressure air volume tank 710b is pressurized to a specific level (e.g., controlled by the fluid pressure pump 705a and dump valve 707a) sufficient to close the valves. Each of the valves can be configured to normally be closed such that when the solenoid is not powered the pressure from the air volume tank is applied to the valve, closing it. The fluid pressure air volume tank 710a is pressurized to a specific level and that pressure is applied to all of the fluid tanks 711. As the three-way solenoid associated with a tank is opened, the pressure applied to that tank causes fluid to flow at a known rate into the mixing chamber. There can also be several accessory valves (each controlled by its own three-way solenoid) that control other functions, such as opening the dispense port, introducing pressurized air at the inlet or outlet of the mixing chamber, introducing a flushing fluid at the inlet or outlet of the mixing chamber, pulling a vacuum on the outlet of the mixing chamber, and/or causing the membrane at the base of each mixing chamber to inflate, thereby evacuating the contents of that mixing chamber.

FIG. 7B provides an example electrical architecture diagram for some embodiments, showing major electrical components of some OBB systems and how they communicate with one another. For example, a blend recipe is retrieved to and/or received at the personality board 721a (e.g., received from an OBB smart phone app on a smart phone), which relays it to the mix controller 722a. The mix controller 722a directly energizes the pumps and solenoids responsible for dispensing and mixing the fluids. In some embodiments, the mix controller 722a can also directly read information from the EEPROM on each canister to ensure that it is a valid canister and/or to allow for the OBB smart phone app to retrieve information about the contents of that canister to generate the mix instruction.

FIG. 7C provides an example basic circuitry diagram according to some embodiments that can be used to control each of the three-way solenoid and dump valves. In this example, the main processors on the mix controller board uses an IO expander 731a to drive a field effect transistor (FET) 732a, which applies voltage to the valve 734a. A current sense element 733a can be used to ensure that current is flowing to the valve. If the current to the valve is different from the expected value, an error can be initiated.

FIG. 7D provides shows an example inter-integrated circuit (I2C) 741a interface used to communicate with the various peripherals, including the EEPROMs located on the canisters, microfluidic chip, flush tanks, and dispense accessory, according to some embodiments.

FIG. 7E provides an example use of an IO expander to communicate with three separate 8×1 analog multiplexers, each of which can read and write the EEPROMs of 8 canisters.

FIG. 7F provides an example electronics architecture showing an abstracted view according to some embodiments of the OBB system. The mixer controller/mix control board 752a is responsible for the control of valves 753a, pumps 754a, and heaters 755a and/or heater elements. The mix control board 752a communicates with the personality board 751a which can drive a display 757a or other interface. In some embodiments, the display 757a is an array of multicolored LEDs that can, for example, be located on the personality board 751a, a secondary board, an LCD display, a touchscreen, and/or the like.

Below are various pin designations for example programmable system-on-chip (PSoC) processors on the mixing board and the personality board according to some embodiments of the OBB system (e.g., as discussed in FIGS. 7A-7F).

Mix Control Board

PSOC 3—100 pin (CY8C3866AXI-040)

Flash for temporary recipe storage (S25FL116KoXMFIo43) (16M, 2×8)

3 PWM outputs for pump control (buffered for 6V pumps). 3 digital outputs for dump control (buffered for 6V valves)

24 digital outputs for fluid control (buffered for 6V valves)

2 digital outputs for air control (buffered for 6V valves)

2 digital outputs for flush control (buffered for 6V valves)

1 digital output for vacuum control (buffered for 6V valve)

1 digital output for dispense control (buffered for 6V valve)

2 digital outputs for mix chamber control (buffered for 6V valves)

2 digital outputs for heater control (buffered for heater voltage)

3 analog inputs for pressure sensors (buffered for +/− output from sensor)

2 analog inputs for temperature sensors

2 GPIO lines for UART

4 GPIO lines for SPI

2 GPIO lines for I2C (canister communications)

TABLE A

| Pin | Signal |
|---|---|
| P2.5 | SPI_MISO |
| P2.6 | SPI_MOSI |
| P2.7 | SPI_CLK |
| P12.4 | SPI_SS |
| P5.6 | UART_RX |
| P5.7 | UART_TX |
| P2.4 | Analog_Pressure_1 |
| P2.3 | Analog_Pressure_2 |
| P2.2 | Analog_Pressure_3 |
| P2.1 | Analog_Temperature_1 |
| P2.0 | Analog_Temperature_2 |
| P12.0 | I2C_SCL |
| P12.1 | I2C_SDA |
| P12.5 | DigOut_Canister1 |
| P6.4 | DigOut_Canister2 |
| P6.5 | DigOut_Canister3 |
| P6.6 | DigOut_Canister4 |
| P6.7 | DigOut_Canister5 |
| P5.0 | DigOut_Canister6 |
| P5.1 | DigOut_Canister7 |
| P5.2 | DigOut_Canister8 |
| P5.3 | DigOut_Canister9 |
| P1.2 | DigOut_Canister10 |
| P1.5 | DigOut_Canister11 |
| P1.6 | DigOut_Canister12 |
| P1.7 | DigOut_Canister13 |
| P12.6 | DigOut_Canister14 |
| P12.7 | DigOut_Canister15 |
| P5.4 | DigOut_Canister16 |
| P5.5 | DigOut_Canister17 |
| P15.0 | DigOut_Canister18 |
| P15.1 | DigOut_Canister19 |
| P3.0 | DigOut_Canister20 |
| P3.1 | DigOut_Cansiter21 |
| P3.2 | DigOut_Canister22 |
| P3.3 | DigOut_Canister23 |
| P3.4 | DigOut_Canister24 |
| P3.5 | DigOut_AirControl1 |
| P3.6 | DigOut_AirControl2 |
| P3.7 | DigOut_FlushControl1 |
| P15.2 | DigOut_FlushControl2 |
| P15.3 | DigOut_VacuumControl |
| P12.2 | DigOut_DispenseControl |
| P12.3 | DigOut_MixControl1 |
| P4.0 | DigOut_MixControl2 |
| P4.1 | PWM_Pump1 |
| P4.2 | PWM_Pump2 |
| P0.0 | PWM_VacuumPump |
| P0.1 | PWM_Heater1 |
| P0.2 | PWM_Heater2 |

A2D scaled for 0 to 6.144V Bluetooth Personality Board (in some embodiments)

PSOC4 for BLE interface (CY8C4248LQI-BL483)

Flash for recipe storage (S25FL512SAGMFI011) (512M, 64×8)

USB-to-UART for USB interface (FTDI FT230XS-R)

12-output SPI DAC to drive LED driver for interface LED control (AD8804ARZ)

2 GPIO for UART to mix control board

2 GPIO for UART-to-USB interface

5 GPIO for SPI

1 GPIO for interface button

TABLE B

| Pin | Signal |
|---|---|
| P1.4 | UART_MIX_Rx |
| P1.5 | UART_MIX_Tx |
| P0.0 | UART_USB_Rx |
| P0.1 | UART_USB_Tx |
| P3.0 | SPI_MISO |
| P3.1 | SPI_MOSI |
| P3.2 | SPI_CLK |
| P3.3 | SPI_SS_FLASH |
| P3.6 | SPI_SS_DAC |
| P3.7 | DigIn_InterfaceButton |
| P3.5 | DigOut_Bluetooth_LED |
| P3.4 | DigOut_LEDDriver_Enable |

In some embodiments, the 2 UARTs and SPI fill the resources of the PSOC4 when running the BLE (BLUETOOTH low energy) stack. In some implementations, no additional internal digital peripherals (PWM, etc.) can be used. In some implementations, there are spare GPIO pins for reading status lines, etc. In some implementations, the A2D can be utilized.

According to some embodiments, an OBB mix control board can utilize a specified communications protocol to communicate with a host, e.g., via WiFi®, Bluetooth, BLE, and/or a USB-based and/or UART-based communication interface. In such embodiments, the host can send the mix control board a command in the packet format. The mix control board can respond with a response packet, e.g., of the same format, to notify if the command was processed successfully or not.

As discussed above, in some embodiments, the OBB includes a personality board providing communications path(s). In some embodiments, the personality board provides, for example, a BLUETOOTH 4.0 interface (BT4) and/or a USB interface. In some embodiments, the BT4 or similar interface is configured to be used by tablet and smart phone OBB applications to communicate with the OBB main device. The USB interface can be configured to facilitate firmware updates, manufacturing tests, service troubleshooting, etc.

In some embodiments, regardless of communication methodology (e.g., BLE, USB, etc.) 20 byte communications packet (such as discussed above in Table C) is used. In some embodiments, the communication and security can be handled via the BLE interface. In some embodiments, for the OBB to respond to BLE or USB commands, a security mechanism or control must be released in order for the OBB to respond to commands. The security mechanism/control prevents unauthorized access to the OBB. In some embodiments, the communications cycle comprises (a) host constructs communications packet it wishes to send to OBB: (b) if release security is required for the command, then host releases security; (c) host writes n-byte communications to a first characteristic; (d) after the BLE write complete response, the host can read the response data from first or second characteristic. The host can also monitor notifications for second characteristic, and read the response from second characteristic when the characteristic is notified. The security mechanism(s) or control(s) are configured to prevent unauthorized access to the OBB. For example, even though BLUETOOTH data packets are encrypted, BT4 communication may still be vulnerable to being spied upon by unauthorized listeners. OBB implements security features so that unauthorized listeners cannot discover the OBB command protocol and command the device to perform unwanted acts. When the security is active, the OBB will not execute commands. As an example, a security mechanism or tool can be implemented in the following manner: the mobile OBB application on the mobile device can ask the OBB for its security key using. The OBB will generate a specified number of random bytes and then use an encryption formula to calculate the proper response from the application. The application receives the random bytes from the OBB and perform the encryption formula. The application will then send the random bytes of the encrypted data to the OBB via a specified characteristic. OBB can check to see if the mobile application's encryption matches the OBB encryption. If the encrypted data matches, security is released and the OBB can respond to commands. However, if invalid encrypted data is received (e.g., received 3 consecutive times), the OBB can be configured to lock down and no longer process release security commands. Such embodiments can prevent or reduce the success of brute force hack attacks on the security mechanism. In some embodiments, the power to the OBB must be cycled to release the lock down.

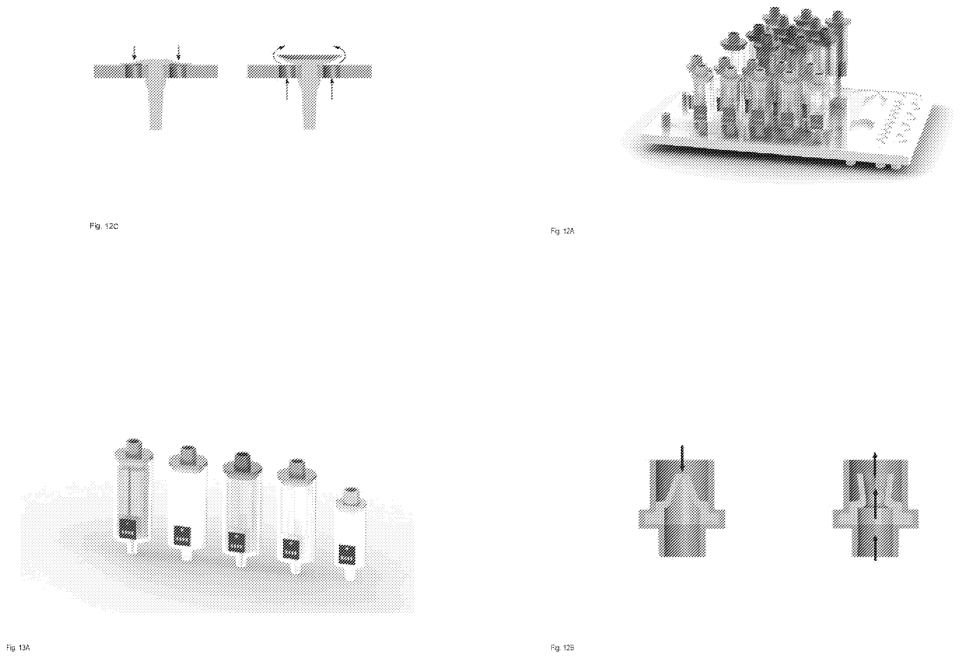

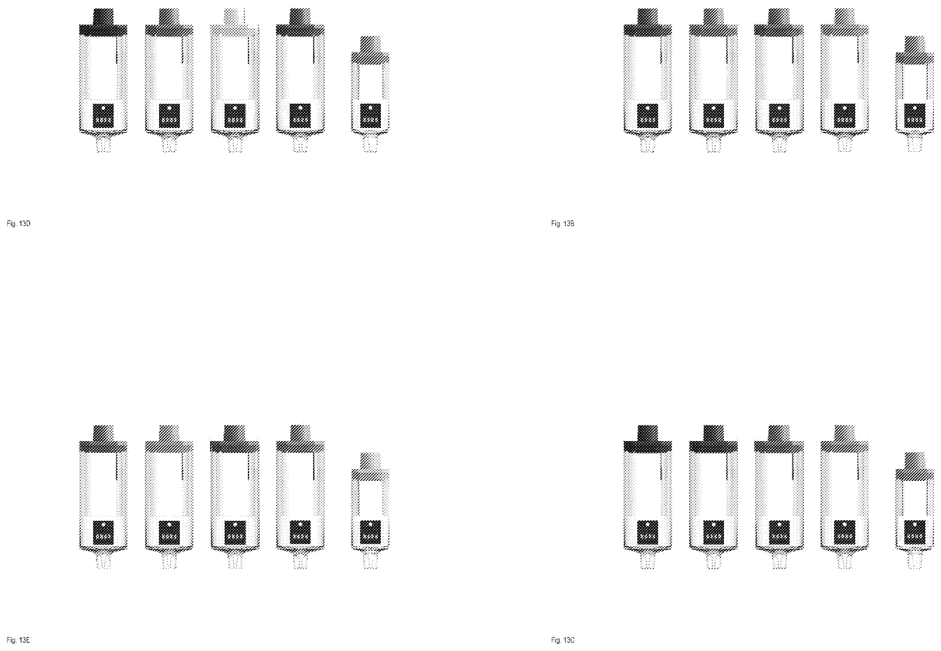

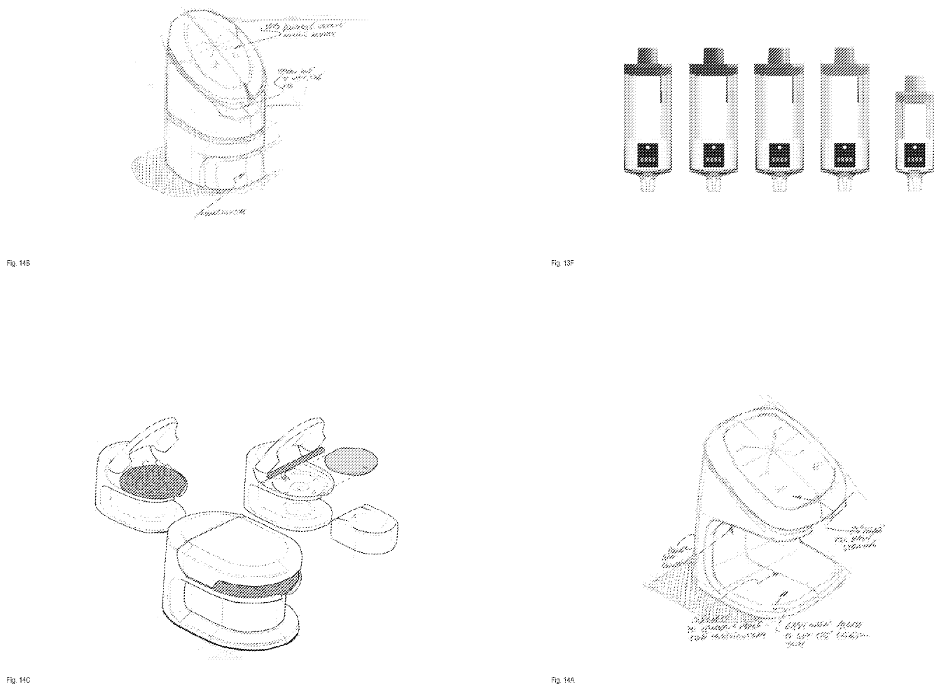

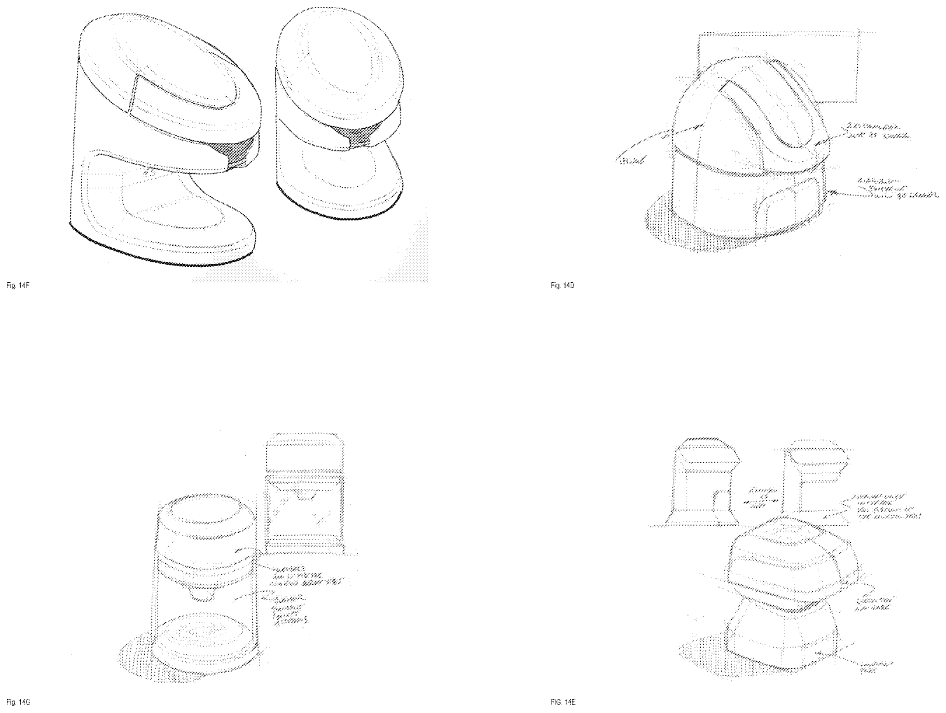

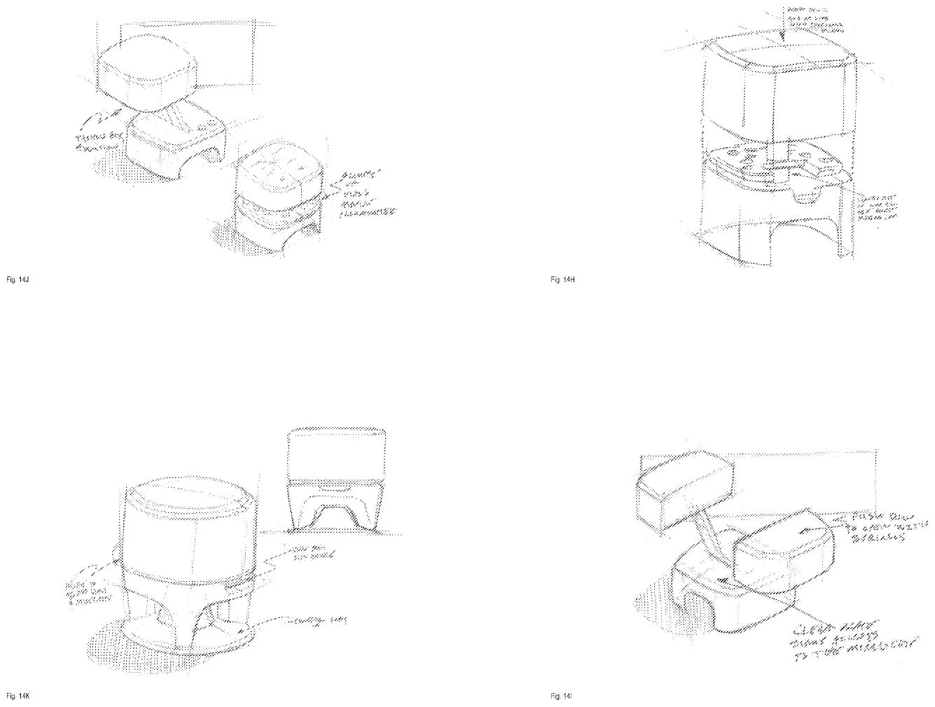

In some embodiments, heating the fluid vials and the microfluidic mixer chip can be necessary to achieve the mixing of the fluids of varying viscosities, and thus important or vital to correct, accurate, and reliable OBB system performance. The heaters/heater elements are configured to control the viscosity of the flow through the OBB system precisely. In some implementations, as illustrated in FIG. 8A, this control of heating and/or providing a specified heating to various parts of the system can be used to normalize the fluid flow, and can include heating the fluids in both the vials/reservoirs and through the mixing operation (i.e., through the flow paths and/or in the microfluidic mixer chip). Such embodiments can use a microfluidic mixer chip heater 802a (and/or heater block, heater element(s), etc.), and one or more vial/reservoir heaters 803a (and/or heater block(s), heater element(s), etc.). Heaters and/or heater blocks can include and/or be formed from a variety of materials (steel, aluminum, ceramic, etc.) and can be powered by a variety of sources (resistance heating, induction heater, radiant heating, radio heating, combustion heating, etc.).

FIG. 8B shows the internal structure for some embodiments of the OBB, including a mixer controller/PCB 810a, pumps 812a, solenoid plates/solenoids 813a. As illustrated in FIG. 8C, the mixer controller/PCB 810a includes and/or is connected to a power supply 811a, a power entry/power port 811b, pressure measuring feedback sensors/input 811c, and/or system electrical connections 811d. The mixer controller/PCB 810a is configured to control pumps 812a and solenoids 813a. The solenoid plates/solenoids 813a open and close the supply of pressure to the system, and the pumps 812a pressurize the system. Air chambers 814a can be utilized by the OBB to control the timing, system response, and/or damping of system dynamics.

FIG. 8D provides an overview of example system user feedback for some embodiments of the OBB where a main controller/mixer controller/PCB 810a communicates to a user feedback component, such as a user feedback PCB 820a, that can communicate with and/or alert a user with a communication component 821a (such as a controllable OBB logo) regarding operational details and/or status. For example, the user feedback PCB 820a can control an LED or series of LEDs 822a and the OBB logo 821a can comprise a series of light pipes connected to LEDs 822a on the user feedback PCD 820a.

FIG. 8E shows an embodiment where a dispensing tray 840a is removed from an OBB system. Such a tray can be used to facilitate secure and efficient loading of vessels/receptacles, as well as make it easier for a user utilize the system (i.e., by not requiring them to manually align a receptacle for the microfluidic mixture). The tray 840a can be loaded with a dispensing/receiving cartridge/receptacle 841a or cup, and the loaded tray can be inserted, attached, and/or latched back into the OBB system in the dispense area (which, in some embodiments, is a cavity). In some embodiments, latch or attachment mechanisms, such as magnets, can be used to secure the tray 840a to the OBB prior to dispensing the microfluidic mixture. In some embodiments, the OBB can be configured with releasable attachment mechanisms (electromagnetic latches, actuated latches, etc.). In some embodiments, the OBB can be configured to only accept specified receptacles, such as vape cartridges, vape pens (or a straw or other component thereof), OBB vials, etc., to control safety and purity of the dispensed microfluidic mixture. As illustrated in FIG. 8F, fluids from the vials flow 851a into the microfluidic mixer chip where they are mixed to form the microfluidic mixture 852a which is transferred into the dispenser 853a and from the dispenser into a cartridge or cup 854a loaded in the tray.

FIG. 8G provides an overview of inserting and/or replacing a microfluidic mixer chip, for some embodiments of the OBB. To load or reload a microfluidic mixer chip (for example, for a new use, such as fragrance making, after using the OBB for medical, recreational, or cooking application), the vials 862a and vial heater 803a are raised up. If there is an existing microfluidic mixer chip, it can be removed from the mixer chip heater block 802a and a new microfluidic mixer chip 800a placed down 863 on the mixer chip heater block 802a. In some embodiments, the mixer chip heater block 802a can include connection ports 802b that allow system pneumatics to directly couple to the microfluidic mixer chip 801a. In some such embodiments, the mixer chip heater block 802a both heats the microfluidic mixer chip 801a and provides the pneumatic path to the microfluidic mixer chip 801a so that valves can be opened and closed, allowing fluids to flow.

FIG. 8H provides an overview of inserting and/or replacing fluid vials for some embodiments of the OBB. To load or reload one or more vials (e.g., if an ingredient has run out or the user wishes to try a new ingredient), any old or empty vials are removed from the vial heater 803a, the vial heater is lowered onto and/or secured over the microfluidic mixer chip 801a, and new or replacement vials 862a are placed into the vial heater 803a. Then a cap 865a is lowered onto the vials to create a seal, on both the top interface of the vial(s) and with the bottom interface with the microfluidic mixer chip, thereby connecting and sealing the pneumatic system of the OBB. The cap 865a can comprise a unitary cap and/or comprise multiple caps, such as a sealing cap and a cable management cap.

FIG. 8I provides example user guidance illustrations for some embodiments of the OBB, with illustrations on set up, microfluidic chip replacement, and vial replacement.

In some embodiments, one or more of the following can be co-located within/on the same circuit board (e.g., printed circuit board, PCB): a personality board, a display interface board, a control interface (e.g., components associated with a user interface such as a GUI, dial, switch, etc., for example, driver circuitry and/or signal logic/mapping circuitry), a mix controller, and a processor and/or memory configured to store and/or execute a software application (e.g., the mobile OBB application).

FIG. 9A, FIG. 9B, and FIG. 9C illustrate example OBB microfluidic mixer chips, according to some embodiments. Channel parameters are determined by the application and implementation, and can correspond to the relative viscosity of the fluids for the channel(s). For example, for a microfluidic mixer chip configured for use with cannabinoids, the cannabinoid main flow channel can be configured to be 2000 micrometers wide×1000 micrometers deep. For bases and/or flavonoids, the inlet channel can be 500 micrometers wide×300 micrometers deep and the bases/flavonoids main flow channel 1000 micrometers wide×1000 micrometers deep. For terpenes, the inlet channel can be 250 micrometers wide×100 micrometers deep and the terpene main flow channel 600 micrometers wide×300 micrometers deep or 250 micrometers wide×70 micrometers deep. These parameters are examples only, and are not intended to be limiting. However, these examples provide illustrative ratios for channel size/fluid viscosity that can be generalized to some embodiments.

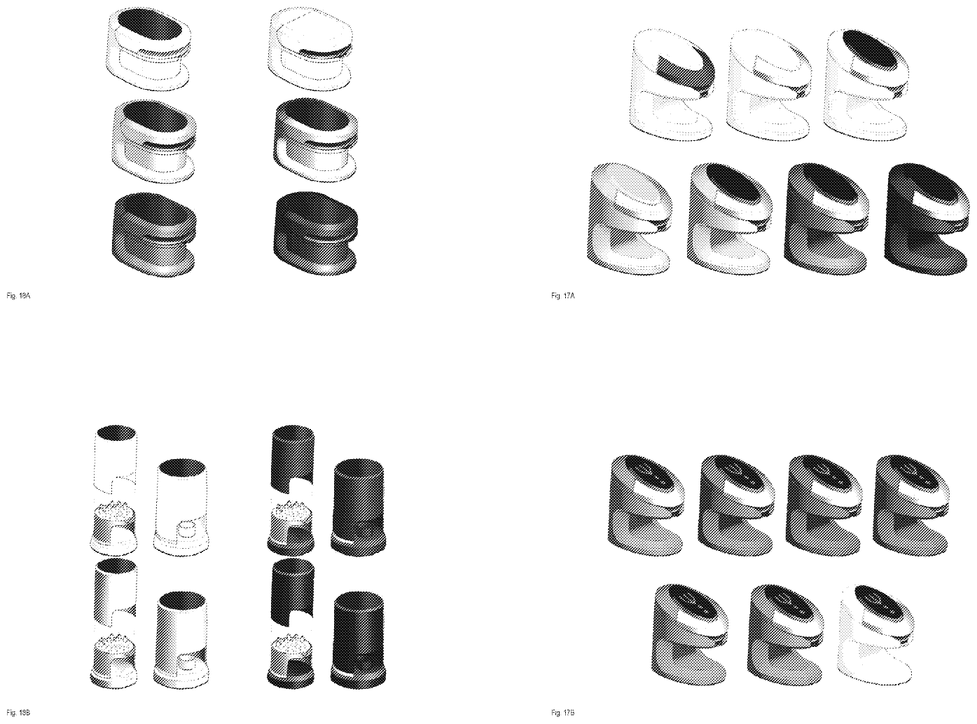

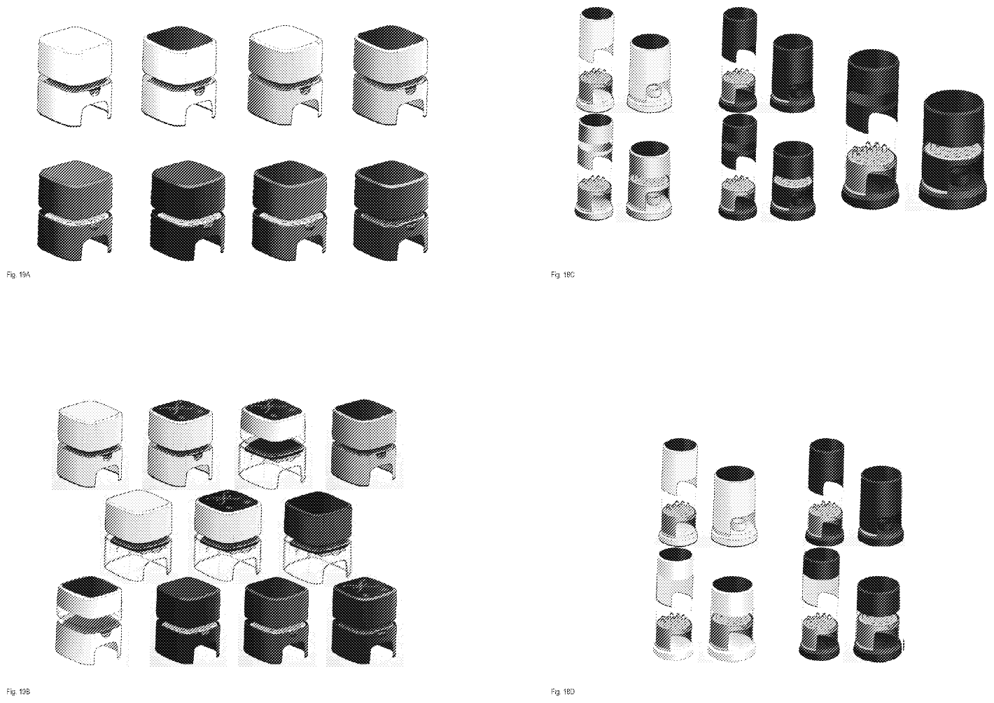

FIG. 10 shows an example microfluidic mixer chip assembly according to some embodiments. As shown, in such embodiments, there are four parts, including a mixer chip top 1001 (additional detail in FIG. 10A), mixer chip VIA 1011 (additional detail in FIG. 10B), mixer chip membrane 1021 (additional detail in FIG. 10C), and mixer chip bottom 1031 (additional detail in FIG. 10D). In some implementations, the four parts are heat-bonded, e.g., using a displacement technique in a class 100,000 clean room. In some implementations, no adhesives are used in bonding/forming the microfluidic mixer chip. In some embodiments, the parts are bonded using methods as disclosed by Ren et al., Whole-Teflon microfluidic chips (PNAS 2011 108 (20) 8162-8166; doi:10.1073/pnas.1100356108), the entirety of which is incorporated by reference for all purposes. In some embodiments, the microfluidic mixer chip can include and/or integrate monolithic pneumatic valves and/or pumps.

A variety of materials, including metals (e.g., aluminum), metal alloys (e.g., stainless steel), polymers, copolymers, resins, silicon, glass, PDMS, polytetrafluoroethylene, perfluoroalkoxy polymer resin, TEFLON etc., can be utilized in making the microfluidic mixer chips, and the microfluidic mixer chip can comprise, consist essentially of, or consist of such a material or mixtures of materials. In some embodiments, some or all of the above parts are made from fluorinated ethylene propylene (PEP), a copolymer of hexafluoropropylene and tetrafluoroethylene. In some embodiments, the microfluidic mixer chip consists of or consists essentially of FEP, and the parts are heat bonded. As disclosed herein, such embodiments are well-suited for cannabinoid-related applications, as they can resist solvent effects from terpenes, and thereby be used multiple times without risk of contamination. In some embodiments, such microfluidic mixer chips are monolithically formed and/or include elements, such as pneumatic valves and/or pumps, which are monolithically formed. FIGS. 10E-10G are pictures of a heat-bonded FEP microfluidic mixer chip according to some such embodiments of the disclosure.

Some embodiments of the OBB are configured to work with a broad range of temperatures so that can work with a variety of liquids, and some embodiments are configured to not exceed a specified temperature threshold, such as 140 F (e.g., a temperature that is safe to the touch), while other embodiments can go higher (e.g., some cannabinoids are stable up to 300 F and can require relatively high temperatures to get appropriate viscosities), and such high-temperature embodiments include safety features and insulation to avoid overheating and to prevent a user from accidentally burning themselves. Some embodiments can also be configured with a minimum temperature, such as 100 F, below which the OBB will not dispense fluids.

Depending on the embodiment, temperatures for fluids within the OBB can range from 100 degrees F. to 300 degrees F., including any integers there between, and including any ranges between integers there between, including from about 100 to 105 degrees F., from about 105 to 110 degrees F., from about 110 to 115 degrees F., from about 115 to 120 degrees F., from about 120 to 125 degrees F., from about 125 to 130 degrees F., from about 130 to 135 degrees F., from about 135 to 140 degrees F., from about 140 to 145 degrees F., from about 145 to 150 degrees F., from about 150 to 155 degrees F., from about 155 to 160 degrees F., from about 160 to 165 degrees F., from about 165 to 170 degrees F., from about 170 to 175 degrees F., from about 175 to 180 degrees F., from about 180 to 185 degrees F., from about 185 to 190 degrees F., from about 190 to 195 degrees F., from about 195 to 200 degrees F., from about 200 to 205 degrees F., from about 205 to 210 degrees F., from about 210 to 215 degrees F., from about 215 to 220 degrees F., from about 220 to 225 degrees F., from about 225 to 230 degrees F., from about 230 to 235 degrees F., from about 235 to 240 degrees F., from about 240 to 245 degrees F., from about 245 to 250 degrees F., from about 250 to 255 degrees F., from about 255 to 260 degrees F., from about 260 to 265 degrees F., from about 265 to 270 degrees F., from about 270 to 275 degrees F., from about 275 to 280 degrees F., from about 280 to 285 degrees F., from about 285 to 290 degrees F., from about 290 to 295 degrees F., from about 295 to 300 degrees F. and/or any subranges there between or combined ranges (e.g., from about 145 to 245 degrees F., etc.).

In some embodiments, temperatures/heating is focused on a tank, pathway/channel, and/or other specified portion or portions of the OBB and/or microfluidic mixer chip. In some embodiments, pressures within the OBB can range from 0 to 100 PSI, depending on the implementation. In some embodiments, pressures from 0 to 100 PST are used to control the valves, including pressures such as 0.1 to 10 PSI, 10 to 20 PSI, 20 to 30 PSI, 30 to 40 PSI, 40 to 50 PSI, 50 to 60 PSI, 60 to 70 PSI, 70 to 80 PSI, 80 to 90 PSI, 90-100 PSI, and/or any integers there between, or ranges therebetween, including, for example, about 1 PSI, about 2 PSI, about 3 PSI, about 4 PSI, about 5 PSI, about 6 PST, about 7 PSI, about 8 PSI, about 9 PSI, or about to PSI. In some embodiments, pressures from 0 to 100 PSI are used to pressurize the (typically heated) ingredients in the canisters to cause them to flow, including pressures such as 0.1 to 10 PSI, 10 to 20 PSI, 20 to 30 PSI, 30 to 40 PSI, 40 to 50 PSI, 50 to 60 PSI, 60 to 70 PSI, 70 to 80 PSI, 80 to 90 PSI, 90-100 PSI, and/or any integers there between, or ranges therebetween, including, for example, about 0.01 PSI, about 0.05 PSI, about 1 PSI, about 1.5 PSI, about 2 PSI, about 2.5 PSI, about 3 PSI, about 3.5 PSI, about 4 PSI, about 4.5 PSI, about 5 PSI, about 5.5 PSI, about 6 PSI, about 6.5 PSI, about 7 PSI, about 7.5 PSI, about 8 PSI, about 8.5 PSI, about 9 PSI, about 9.5 PSI, or about to PSI.

In some embodiments, viscosities for the fluids that the OBB handles/processes can range from 0.1 cP to 5,000 cP, including 1 cP, 100 cP, 500 cP, 1,000 cP, 2,000 cP, 3,000 cP, 4,000 cP, 5,000 cP, and/or any integers there between, or ranges therebetween.

In some embodiments, fluids/ingredients that the OBB handles/processes are flowable at a temperature of 60° C. or less. Such materials can include, but are not limited to, oil-based, water-based, and crystallized ingredients. Example fluids/ingredients include essential oils, whole plant oils, whole plant distillates, and plant isolates.

In some embodiments, fluids/ingredients can be added/introduced to the OBB via one or more canisters, tanks, vials, or cartridges (collectively referred to herein as “canisters”).

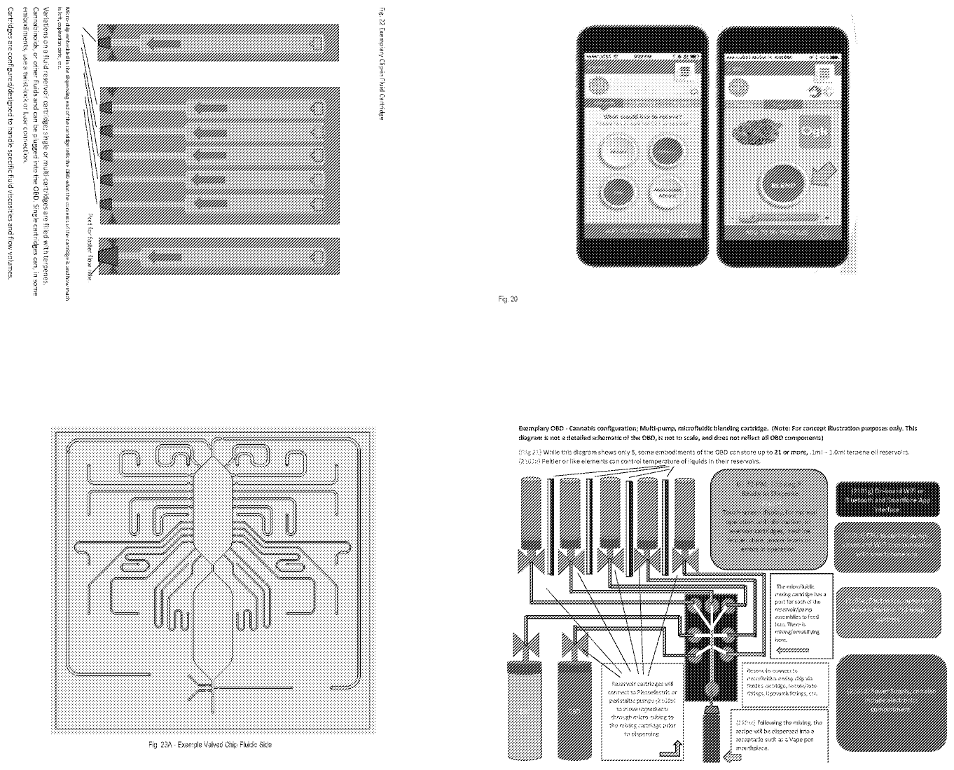

In some embodiments, the OBB can include a cleaning cycle. Such a cleaning cycle can prolong the life of the OBB and/or the microfluidic mixer chip. Such cleaning cycles/methods can include heating the microfluidic mixer chip (or portions thereof) to temperatures above its normal dispense temperature to aid in melting residual substances, passing air/gas/liquid and/or solvent through the main flow channels under pressure, and/or applying acoustic energy to the microfluidic mixer chip to aid cleaning. Additionally or alternatively, in some embodiments, the OBB can include lasers or ultra-fast lasers configured to burn away residual organics attached to the channel walls followed by a burst of air or other fluid to clean away the ash. As illustrated in FIG. 11A, in some embodiments, of the plurality of fluid vials 1102a, one or more vials 1102b can include cleaning solutions (e.g., EtOH and/or the like) that can be run through the system to clean/purge the system after each use.

In some embodiments, a microfluidic mixer chip can include piezo pumps built into the microfluidic mixer chip itself.

In some embodiments, a microfluidic mixer chip and/or the OBB processes for compounding and activating ingredients that otherwise are difficult or impossible to dispense to a user (e.g., compounding medicines that have a relatively short shelf life once compounded could otherwise require a patient to visit a compounding pharmacy several times a week).

In some embodiments, a microfluidic mixer chip and/or the OBB is configured to add an emulsifying agent, homogenize ingredients (e.g., with a homogenizer disposed within the microfluidic mixer chip or as a component of or attachment to the OBB), blend powdered ingredients/components (e.g., with a powder blender), add a filtration solution, concentrate and/or purify ingredients, provide thermal cycling, conduct/provide pH testing and/or provide pH balancing (e.g., with acidic/basic solutions in corresponding tanks), and/or provide advanced microfluidic chemical synthesis. The OBB can also include a system for analyzing the blend of ingredients prior to dispensing to ensure accuracy (e.g., by incorporation of a miniaturized molecular sensor within the OBB). The OBB can additionally or alternatively include a system for testing ingredients for purity and/or potency prior to adding/mixing them (e.g., by incorporation of a molecular sensor or sensors at or near the cartridge/tank receiver of the OBB).

In some embodiments, for complex mix and/or dispense cycles, the OBB can be configured to vary pressure within a main air channel over the dispense time, and thus provide more precise control over fluid flow rates and more accuracy for some fluids if the pressure is lowered as they are dispensed.

In some embodiments, the OBB is configured to pressurize the entire microfluidic mixer chip during a dispense cycle, e.g., by including a solenoid valve on the outlet port allowing it to be closed off. Fluid flow can then be controlled by applying pressure to individual fluid cartridges higher than the pressure within the microfluidic mixer chip. The fluid flow is dependent on the pressure differential (Pcartridge−Psystem). The compression of air within the system is dictated by (V2/V1=Psystem/Pcartridge). By increasing the system pressure and keeping the difference between cartridge pressure and system pressure constant, the OBB can provide the same flow rate with less air compression, reducing dispense error contributed by the compressibility of air within the system.

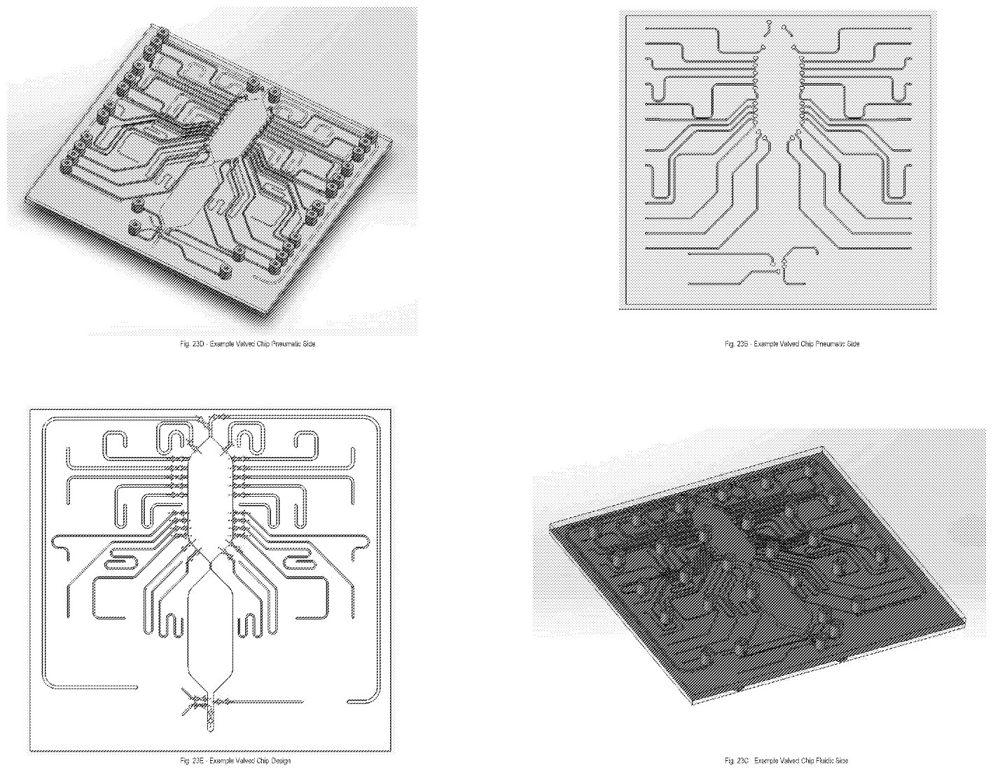

FIG. 12A shows an example OBB microfluidic mixer chip with a plurality of fluid tanks/cartridges disposed thereon. Some embodiments of the OBB microfluidic mixer chip include one or more valves near the interface between the fluid cartridge/fluid tank and the microfluidic mixer chip to prevent or reduce unwanted pressurization and compression of the air volume within the cartridge. Some embodiments utilize a check valve, such as a duckbill valve (e.g., FIG. 12B) or an umbrella valve (e.g., FIG. 12C) to the tip of the cartridge where fluid is dispensed. Additionally or alternatively, a check valve can be included at the inlet port on a microfluidic mixer chip. In some such embodiments, such a valve can also seal a port on the chip if a fluid cartridge/tank is not installed. In some embodiments, the microfluidic mixer chip includes a flexible layer, configured such that pressure-activated valves near the inlet ports can be defined or formed thereon/therein. Although discussed in terms of mixing of fluids occurring in a microfluidic mixer chip, it is to be understood that some embodiment of the OBB, the microfluidic mixer chip (mixer chip, or chip) can instead accurately meter and dispense microfluidic amounts of the fluids and the mixing be conducted outside the chip, such as in the a collection vessel (e.g., a vial, vape cartridge, bowl, etc).

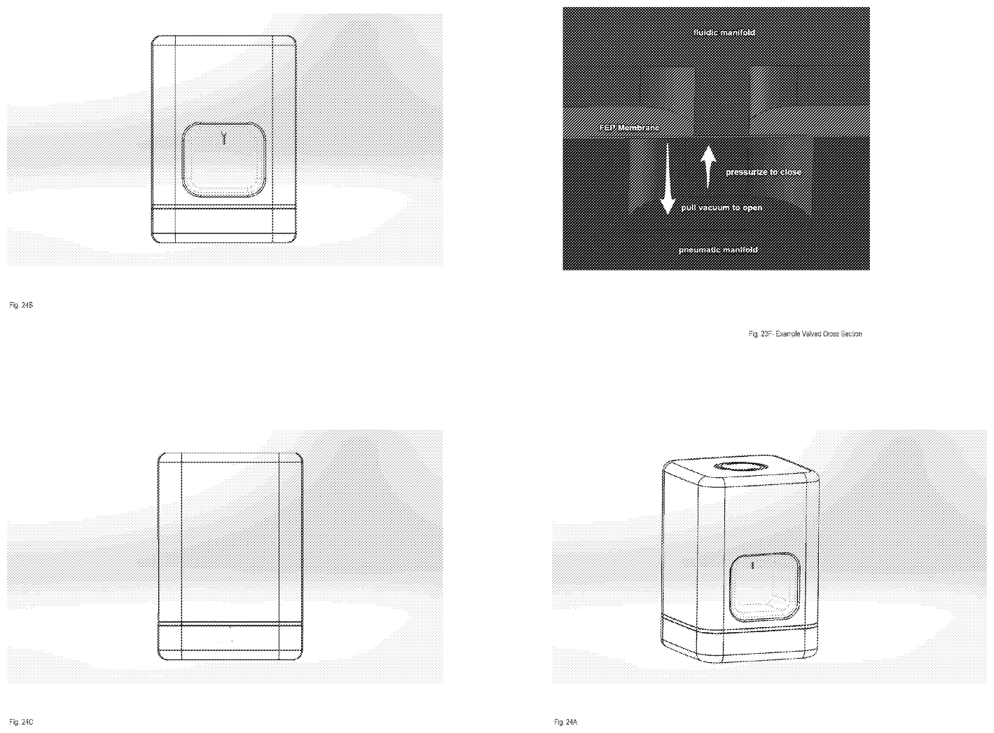

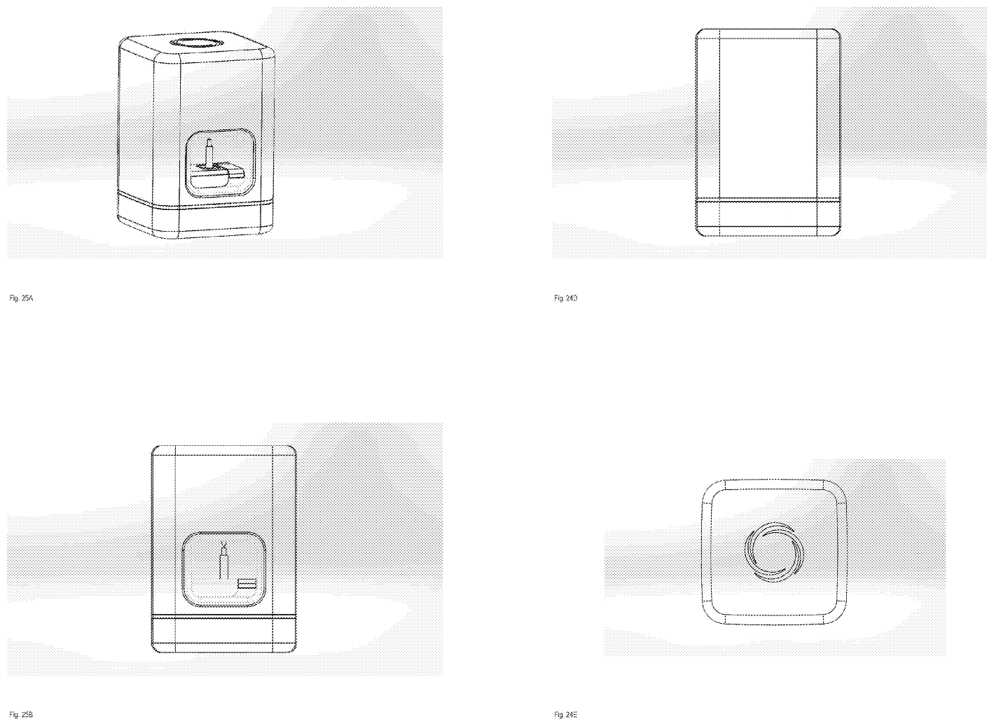

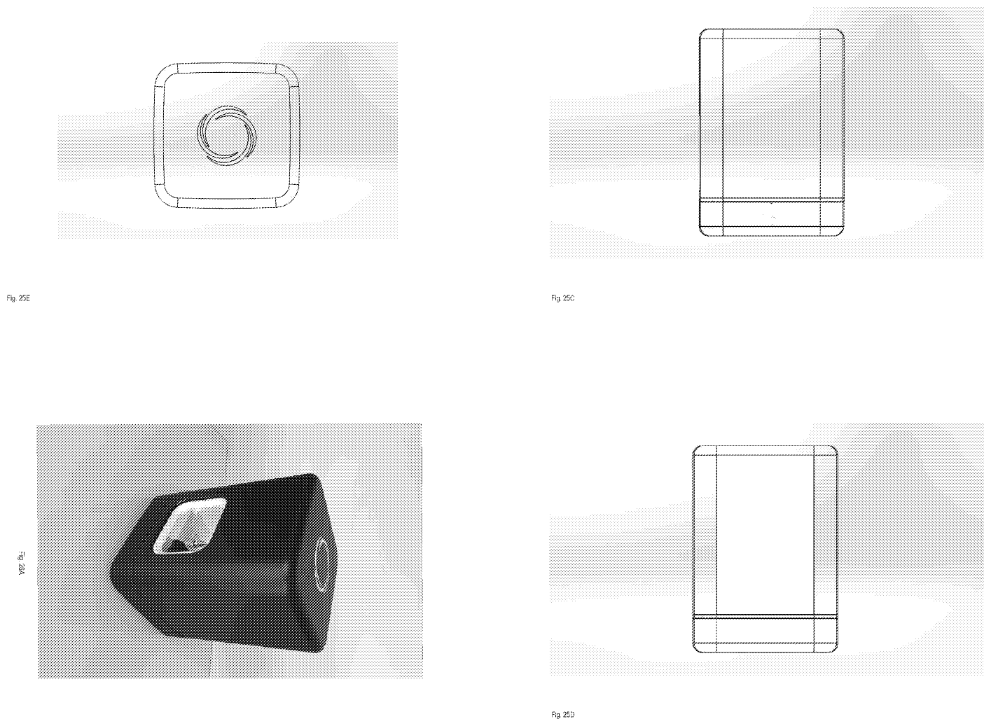

FIG. 13A-FIG. 13F show examples of OBB fluid tanks, including an identifier component (e.g., microchip, RFID, QR/bar code, etc.) disposed on a flat surface thereof, and including coloring/color coding.

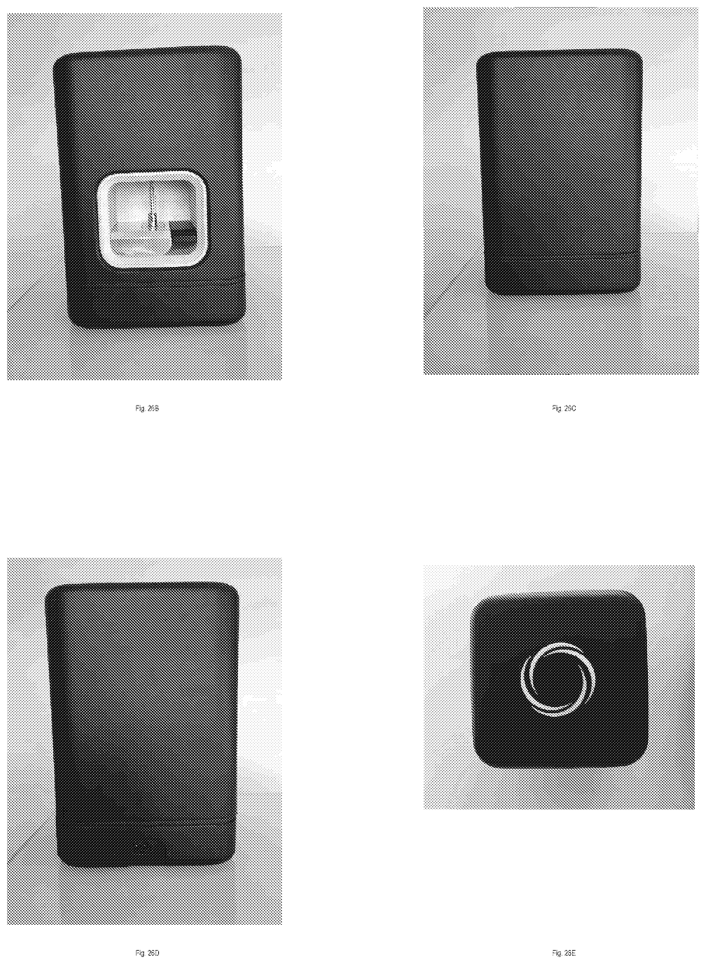

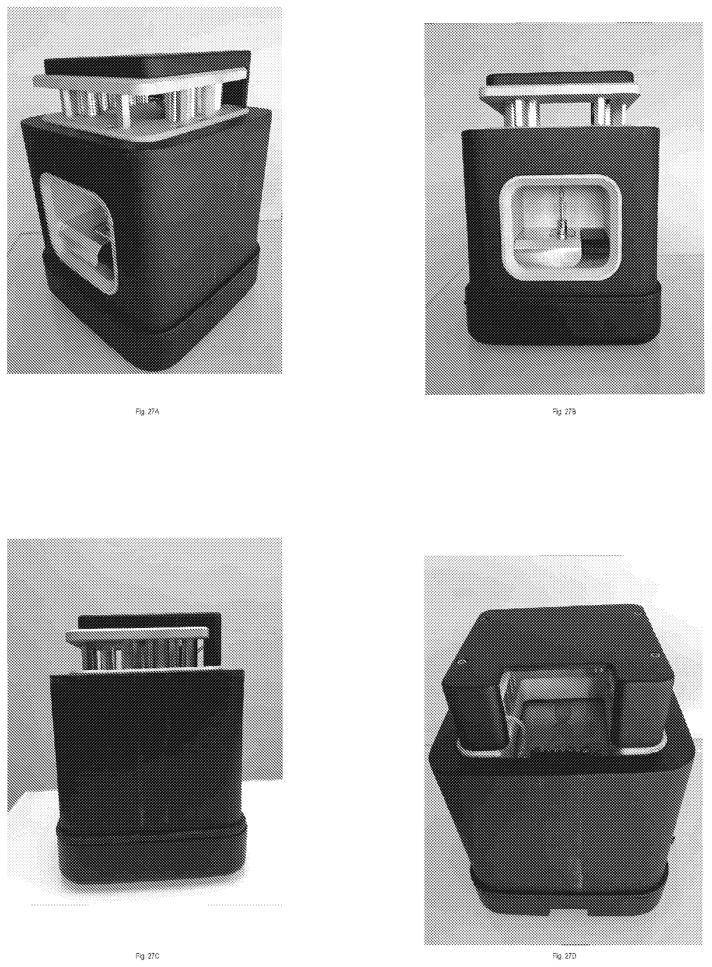

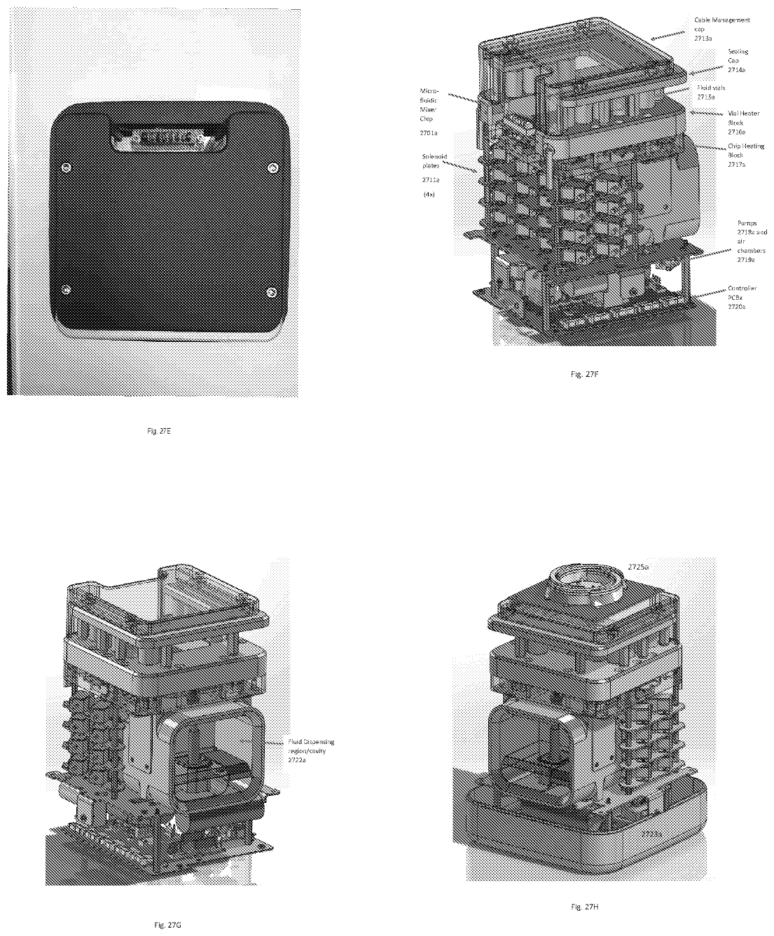

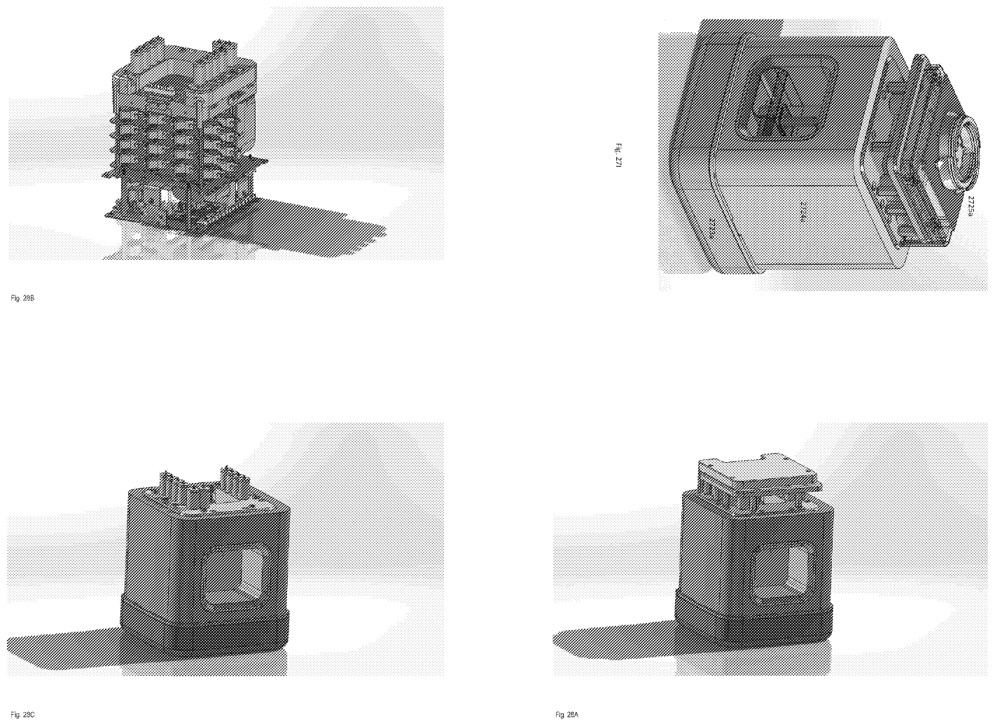

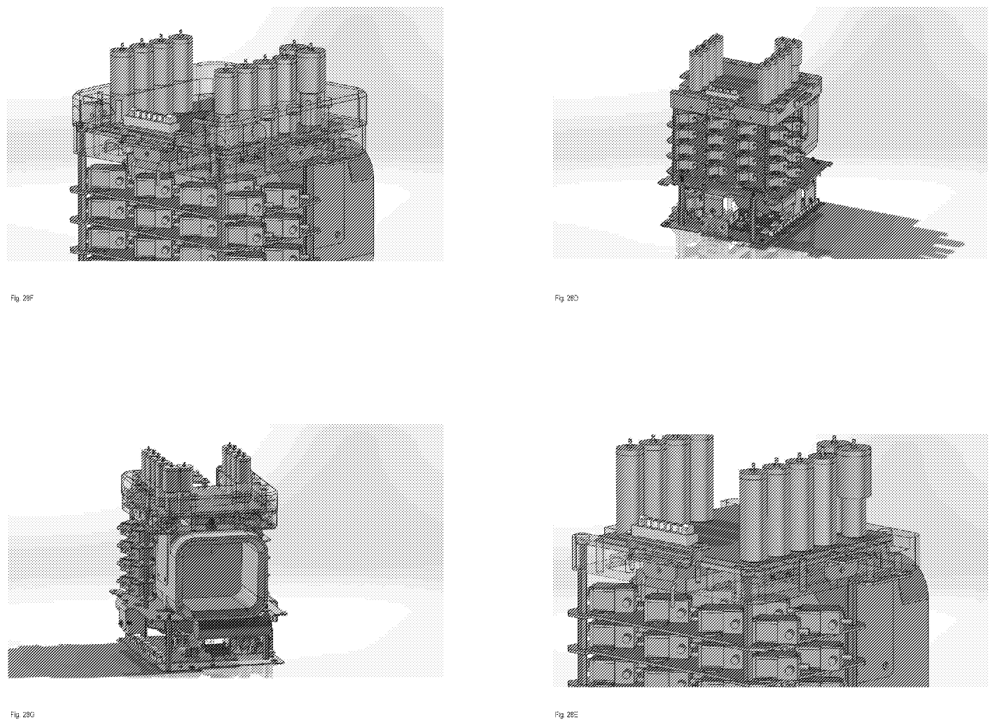

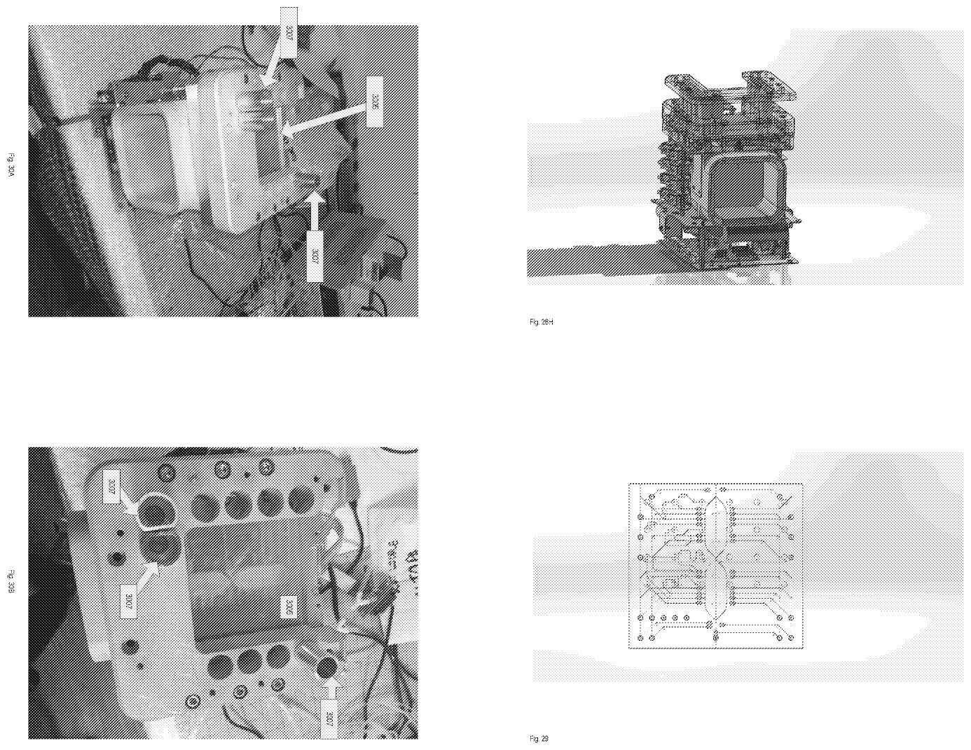

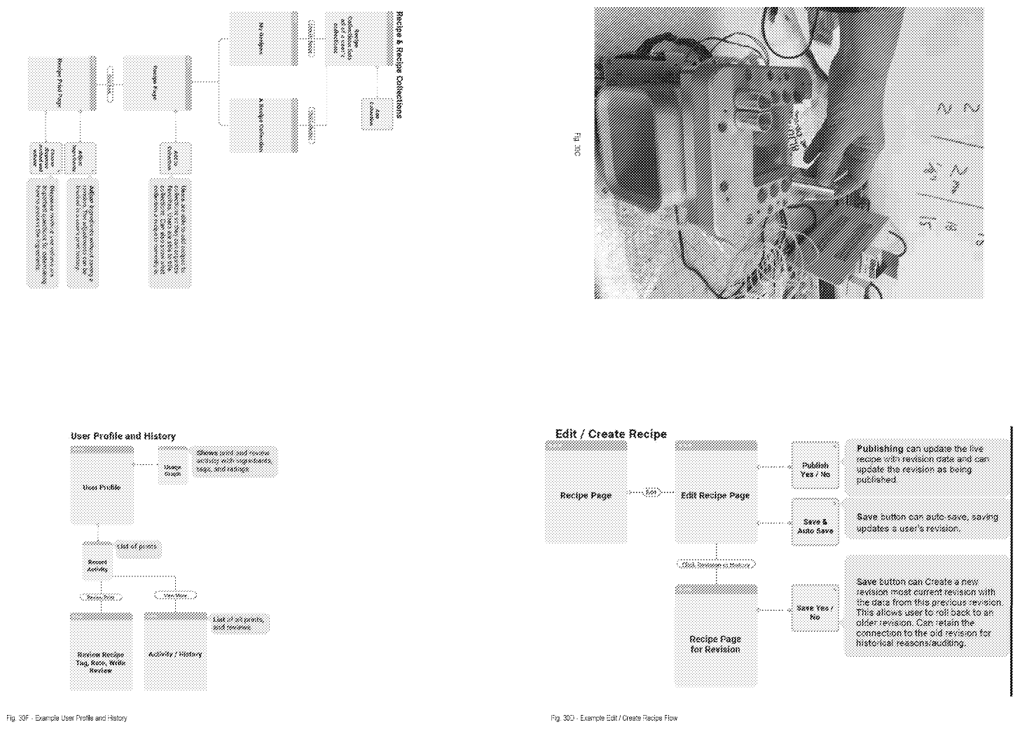

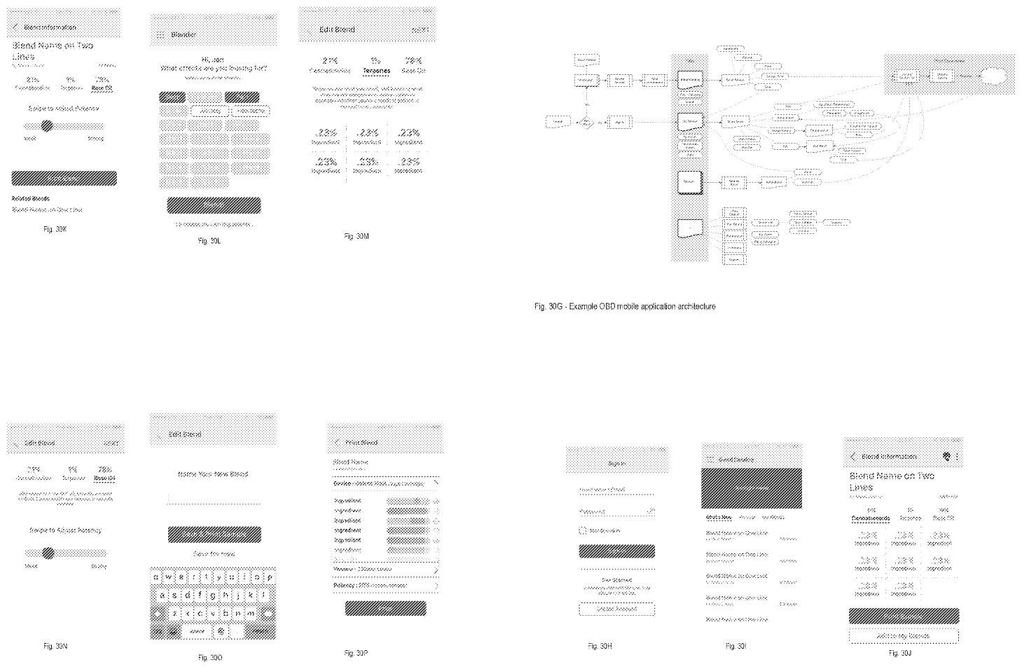

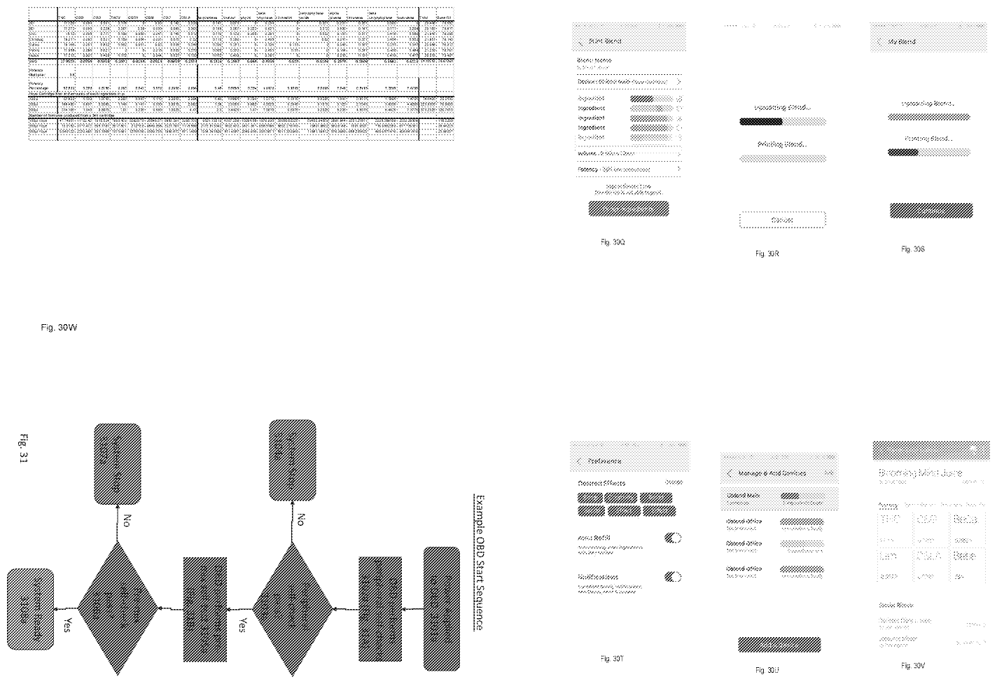

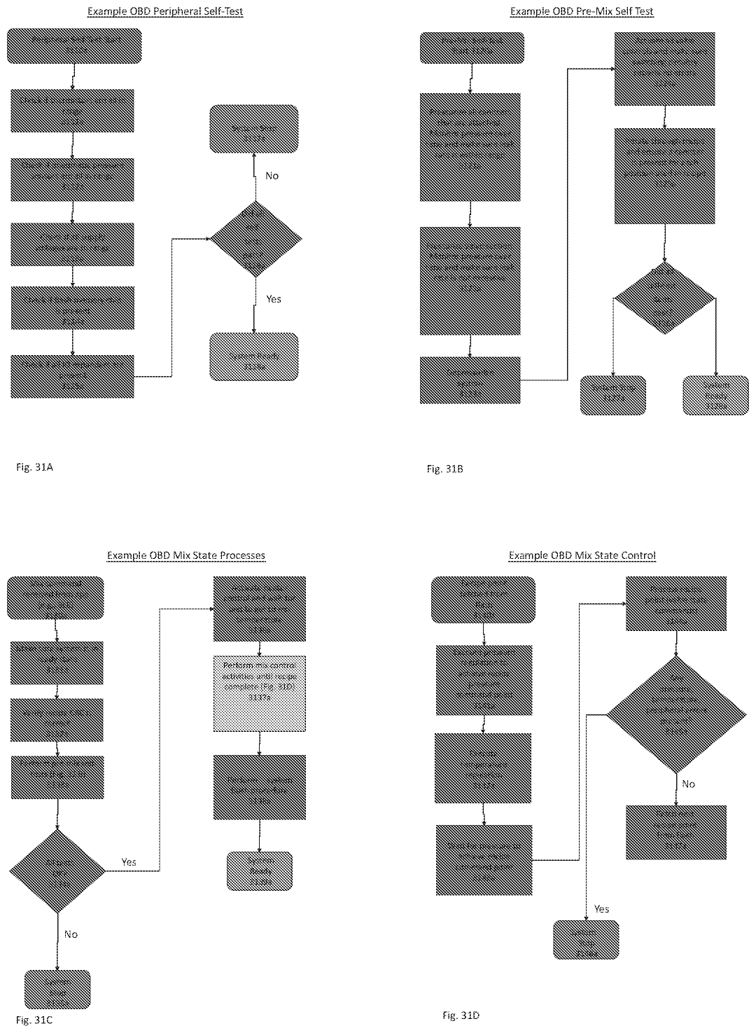

FIG. 14A-FIG. 19B show examples of OBB designs and configurations, according to some embodiments. Such designs can be configured with locks/lock mechanisms, for example, to prevent access by unauthorized individuals (e.g., child access locks on the cartridge(s) and dispensing port), prevent access during mixing and/or heating, restrict access to certain components (e.g., semi-permanent components may require special keys or authorization to service/replace to assure the OBB is safe to operate and sterile), etc. Some embodiments can include transparent and/or semi-transparent portions (which can additionally be backlit, in some embodiments) that allow viewing of the internal components and/or provide visibility to the progression of the mixing.

FIG. 20 provides an example OBB mobile device application user interface (“UI”), according to some embodiments.

For cannabis industry applications, the OBB can be configured to a variety of different components and oils, such as the 25 different oils shown in FIG. 21. Such components/oils can include THC, CBD, CBG and 20 of the primary terpenes found in the majority of cannabis strains. One or more further ports can be made available for the user to introduce flavoring(s) to their mixtures. These different fluids can be stored either on/in the machine in various quantities (e.g., from 0.250 ml to 3 ml, from 0.1 ml to 100 ml, etc.), and/or in a storage case on or adjacent to the OBB.

Some of components (e.g., terpenes and cannabinoids) are fairly viscous and are temperature controlled (e.g., up to 150 degrees F.) by the OBB in order to facilitate good fluid flow during pumping, mixing and dispensing. In some embodiments, temperature control is achieved through the use of Peltier elements and PID controllers (e.g., 2101a). Various pumps (e.g., 2101b) may be utilized, including by way of non-limiting example, stepper-syringe type, peristaltic, or piezoelectric pumps, and one or more pumps may be utilized or selected to be most effective in working with fluids of varying viscosities. For example, certain pumps may be utilized for some flow paths associated with fluids having a particular viscosity (and/or volume), while other pumps are used for flow paths of fluids with other viscosities (and/or volume).

In some embodiments, fluids are blended in various quantities, depending on which is being used. Some of the fluids can regularly constitute a higher percentage of the final (e.g., 0.1 mL-3 mL) product and can therefore be pumped in relatively larger volumes (e.g., 250 microliter (μL) to 800 uL). Others will be used in much smaller quantities and only require to be pumped in relatively smaller volumes (e.g., approx. >1 μL-100 μL). As such, the types of pumps and/or fluid cartridge dispensing port size required to move the various fluids can vary accordingly.

In some embodiments of the OBB, a user selects a recipe from a smartphone App, HTML 5 website, and/or the like, modifies the recipe if desired and orders the device to produce it using an OBB interface. The device can mix the cannabinoid oils (such as THC, CBD and CBG); Terpenes; Flavors (synthetic and natural); and bases (e.g., VG, PC) in order to create custom vapes and blended oils with a variety of flavors, aromas, medicinal and psychotropic effects.

In some embodiments, the different components, oils and terpenes are pumped into a common chamber or tube and are mixed to create a homogenous product.

The fluids can be mixed in a variety of ways, including using turbulent flow, ultra-sonic vibration, pumping air through the mixture, using a mixing cartridge, and/or the like. In some embodiments, a removable and replaceable microfluidic mixer chip, such as detailed herein, can be utilized.

The fluids are then dispensed into a receptacle in specified quantities (e.g., from a 0.1 mL or less Micro-vape to 3.0 mL or more). In some embodiments of the OBB, the receptacle can be interchangeable with most on-market vaporizer components so the user can easily disconnect the receptacle and begin vaping.

Fluid types that can be used in some embodiments of the OBB include, by way of non-limiting example: Oils, Cannabinoids, Nicotine, Terpenes, Terpinoids, Flavonoids, Cannaflaiins, Esters, botanical extracts, endocannabinoid agonists, aromatics, and/or the like. The list of Cannabinoid oils, Cannabinoids, Terpenes (including primary terpenes found in Cannabis), Terpinoids, Flavonoids and Cannaflavins that the OBB can utilize is large, and a non-limiting example list is provided as Table 2.

TABLE 2
Example Cannabinoids:

| | Complete name |
|---|---|
| D9-THC Class | |
| D9-THC | D9-Tetrahydrocannabinol |
| D9-THCA-A | D9-Tetrahydrocannabinolic acid A |
| D9-THCA-B | D9-Tetrahydrocannabinolic acid B |
| D9-THCV | D9-Tetrahydrocannabivarin |
| D9-THCVA | D9-Tetrahydrocannabivarinic acid |
| D9-THC-C4 | D9-Tetrahydrocanabinol acid C4 |
| D9-THCA-C4 | D9-Tetrahydrocanabinolic acid C4 |
| D9-THCO | D9-tetrahydrocannabiorcol |
| D9-THCOA | D9-tetrahydrocannabiorcolic acid |
| b-Fenchyl-D9-THCA | b-fenchyl-D9-tetrahydrocannabinolate |
| a-Fenchyl-D9-THCA | a-fenchyl-D9-tetrahydrocannabinolate |
| epi-Bornyl-D9-THCA | epi-bornyl-D9-tetrahydrocannabinolate |
| Bornyl-D9-THCA | bornyl-D9-tetrahydrocannabinolate |
| a-Terpenyl-D9-THCA | a-terpenyl-D9-tetrahydrocannabinolate |
| 4-Terpenyl-D9-THCA | 4-terpenyl-D9-tetrahydrocarnnabinolate |
| a-Cadinyl-D9-THCA | a-cadinyl-D9-tetrahydrocannabinolate |
| g-Eudesmyl-D9-THCA | g-eudesmyl-D9-tetrahydrocannabinolate |
| Cannabisol | Cannabisol |
| cis-D9-THC | (−)-D9-cis(6aS,10aR)-tetrahydrocannabinol |
| D8-THC Class | |
| D8-THC | D8-Tetrahydrocannabinol |
| D8-THCA | D8-Tetrahydrocannabinolic acid |
| CBG Class | |
| CBG-C5 | Cannabigerol |
| CBGA | Cannabigerolic acid |
| CBGM | Cannabigerol monomethyl ether |
| CBGAM | Cannabigerolic acid monomethyl ether |
| CBGV | Cannabigerovarin |
| CBGVA | Cannabigerovarinic acid |
| (Z)-CBG-C5 | Cannabinerolic acid |
| g-Eudesmyl-CBGA | y-Eudesmyl cannabigerolate |
| a-Cadinyl-CBGA | a-Cadinyl cannabigerolate |
| 5-Ac-4-OH-CBG | 5-acetyl-4-hydroxycannabigerol |
| 6,7-trans-CBGA | (±)-6,7-trans-epoxycannabigerolic acid |
| 6,7-cis-CBGA | (±)-6,7-cis-expoxycannabigerolic acid |
| 6,7-cis-CBG | (±)-6,7-cis-epoxycannabigerol |
| 6,7-trans-CBG | (±)-6,7-trans-expoxycannabigerol |
| 2,3-Di-OH-CBG | carmagerol |
| C15-CBG | sesquicannabigerol |
| CBC Class | |
| CBC-C5 | Cannabichromene |
| CBCA-C5 | Cannabichromenic acid |
| CBCV-C3 | Cannabichromevarin |
| CBCVA | Cannabichromevarinic acid |
| 4-Ac-CBC | (±)-4-acetoxycannabichromene |
| 3″-OH-D4″-CBC | (±)-3″-hydroxy-D4″-cannabichromene |
| 7-OH-CBC | (−)-7-hydroxycannabichromane |
| CBD Class | |
| CBD | Cannabidiol |
| CBDA | Cannabidiolic acid |
| CBDV | Cannabinodivarin |
| CBDVA | Cannabinodivarinic acid |
| CBDM | Canabidiol monomethyl ether |
| CBD-C1 | Cannabidiorcol |
| CBD-C4 | Cannabidiol-C4 |
| Cyclo5-CBD | Cannabimovone |
| CBND Class | |
| CBND-C5 | Cannabinodiol |
| CBND-C3 | Cannabinodivarin |
| CBE Class | |
| CBE-C5 | Cannabielsoin |
| CBEA-C5 A | Cannabielsoinic acid A |
| CBEA-C5 B | Cannabielsoinic acid B |
| CBE-C3 | Cannabielsoin |
| CBEA-C3 B | Cannabielsoinic acid B |
| CBL Class | |
| CBL | Cannabicyclol |
| CBLA | Cannabicyclolic acid |
| CBL-C3 | Cannabicyclovarin |
| CBN Class | |
| CBN | Cannabinol |
| CBNA | Cannabinolic acid A |
| CBN-C3 | Cannabivarin |
| CBN-C1 | Cannabiorcol |
| CBNM | Cannabinol methyl ether |
| CBN-C4 | Cannabinol-C4 |
| CBN-C2 | Cannabinol-C2 |
| 4-Terpenyl-CBNA | 4-Terpenyl Cannabinolate |
| 8-OH-CBN | 8-Hydroxycannabinol |
| 8-OH-CBNA | 8-Hydroxycannabinolic acid |
| CBT Class | |
| (−)-trans-CBT-C5 | (−)-trans-Cannabitriol |
| (+)-trans-CBT-C5 | (+)-trans-Cannabitriol |
| (±)-cis-CBT-C5 | (±)-cis-Cannabitriol |
| (±)-trans-CBT-C3 | (±)-trans-Cannabitriol-C3 |
| (−)-trans-CBT-OEt-C5 | (−)-trans-10-Ethoxycannabitriol |
| (−)-trans-CBT-OEt-C3 | (−)-trans-10-Ethoxycannabitriol-C3 |
| CBT-C3 homologue | Cannabitriol-C3 (unkown stereochemistry) |
| 8-OH-CBT-C5 | 8-Hydroxycannabitriol |
| CBDA-C5 9-O-CBT-C5 ester | Cannabidiolic acid tetrahydrocannabitriol ester |
| Miscellaneous | |
| DCBF-C5 | Dehydrocannabifuran |
| CBF-C5 | Cannabifuran |
| OH-Iso-HHCV-C3 | 8-Hydroxy-isohexahydrocannabivarin |
| CBCN-C5 | Cannabichromanone-C5 |
| CBCN-C3 | Cannabichromanone-C3 |
| CBCT-C5 | Cannabicitran |
| OTHC | 10-Oxo-D6a(10a)-tetrahydrocannabinol |
| CBR | Cannabiripsol |
| CBTT | Cannabitetrol |
| cis-D7-iso-THCV | (±)-D7-cis-isotetrahydrocannabivarin-C3 |
| trans-D7-iso-THCV | (−)-D7-trans-(1R,3R,6R)-isotetrahydrocannabivarin-C3 |
| trans-D7-iso-THC | (−)-D7-trans-(1R,3R,6R)-isotetrahydrocannabinol-C5 |
| CBCN-A | Cannabichromanone-A |
| CBCN-B | Cannabichromanone-B |
| CBCN-C | Cannabichromanone-C |
| CBCN-D | Cannabichromanone-D |
| CBCON-C5 | (−)-7R-cannabicoumarone |
| CBCONA-C5 | (−)-7R-cannabicoumaronic acid |
| Cannabioxepane | Cannabioxepane |
| 4-acetoxy-2-geranyl-5-hydroxy-3-n-pentylphenol | |
| 2-geranyl-5-hydroxy-3-n-pentyl-1,4-benzoquinone | |
| 5-acetoxy-6-geranyl-3-n-pentylphenol-1,4-benzoquinone | |

Example Terpenes:

α Pinene
Linalool
Myrcene
Limonene
Ocimene
Terpinolene
Terpineol
Valencene
β Caryophyllene
α Humulene
Phellandrene
Carene
Terpinene
Fenchol
Borneol
Bisabolol
Phytol
Camphene
Sabinene
Camphor
Isoborneol
Menthol
Cedrene
Nerolidol
Guaiol
Isopulegol
Geranyl Acetate
Cymene
Eucalyptol
Pulegone

Example Flavonoids, Cannaflavins:

cannflavine A
cannflavine B
cannflavine C
vitexin
isovitexin
apigenin
kaempferol
quercetin
luteolin
orientin

Example Essential Oils:

cardmom
balsam fir
basil
bergamot
black pepper
angelica
blue cypress
carrot seed
cedarwood
celery seed
cinnamon
cinnamon bark
cistus
citronella
clary sage
clove
copaiba
coriander
curcumin
cypress
dandelion
dill
dorado azul
elemi
eucaluptus
fennel
frankincense
geranium
chamomile
ginger
goldenrod
grapefruit
helichrysum
hinoki
hong kuai
hyssop
spruce
lemon
juniper agar oil
oodh
ajwain
angelica root
anise
asafoetida
balsam of Peru
Basil
Bay oil
Bergamot
Buchu
birch Camphor
Cannabis flower
Calamodin
Calamansi
Caraway Cardamom seed
Calamus
Cinnamon
Cistus
Citron
Clary Sage
Coconut
Clove
Coffee
Coriander
Costmary
Costus root
Cranberry seed
Cubeb
Cumin
Black seed
Cypress oil
Cypriol
Curry leaf
Davana
Dill
Echinacea
Elecampane
Elemi
Eucalyptus
Fennel seed
Fenugreek
Fir
Frankincense
Galangal
Galbanum
Geranium
Geranol
Ginger
Grapefruit
Henna
Helichrysum
Hickory nut
Horseradish
Hyssop
Idaho-grown Tansy
Jasmine
Juniper berry
Lauras nobilis
Lavender
Ledum
Lemon
Lemongrass
Lime
Litsea cubeba
Linaloe
Mandarin
Marjoram
Melaleuca See Tea tree
Melissa
Mentha arvensis
Moringa
Mountain Savory
Mugwort
Mustard
Myrrh
Myrtle
Neem
Neem Tree
Neroli
Nutmeg
Orange
Oregano
Orris
Palo Santo
Parsley
Patchouli
Perilla
Peppermint
Petitgrain
Pine
Ravensara
Red Cedar
Roman Chamomile
Rose
Rosehip
Rosemary
Rosewood
Sage
Star anise
Sandalwood
Sassafras
Savory
Schisandra
Spearmint
Spikenard
Spruce
Tangerine
Tarragon
Tea
Thyme
Tsuga
Turmeric
Valerian
Warionia
Vetiver
Western red cedar
Wintergreen
Yarrow
Ylang-ylang
Zedoary

Alternatively or in addition, fluids used in some embodiments of the OBB can include, by way of non-limiting example: collagen, calcium and/or other minerals (e.g., in solution, encapsulated, etc.), vitamins (e.g., A, B complex, C. D. E, etc.), primrose oil, mint, gingko biloba, grapeseed oil, wheatgerm oil, jojoba oil, sweet almond oil, and/or argan oil.

In embodiments of the OBB, fluids are moved in very small amounts (e.g., 1 μl or less) at various flow-rates using a system of pumps. e.g., peristaltic and piezoelectric pumps and/or a combination of larger pumps and micro-fluidic valves (e.g., 2101b). The fluids are mixed and homogenized, in either a user-replaceable or permanent mixing manifold, prior to being dispensed into a receptacle (e.g. 2101c).

In some embodiments, the OBB can be automatically calibrated based on the THC and CBD content of the source tanks. In some embodiments, power supply (e.g., 2101d), electronics boards (e.g., 2101e), CPU (e.g., 2101f) and WiFi/Bluetooth radios (e.g., 2101g) are all on board. An example touch screen display for manual operation and monitoring OBB functions is shown 2101h. The OBB can connect via an OBB on-demand ordering app or website (e.g., Oblend.com) via Bluetooth, WiFi, etc. In some embodiments, the OBB, e.g., via a micro-chip or bar-code embedded in each cartridge, can issue a notification when low on ingredients and can be set to reorder (e.g., from Oblend.com) automatically.

An OBB or associated vendor can be accessible via web or smart-phone app for the users of the OBB to post and find favorite recipes: recipes with medical applications; recipes with veterinary applications; social sharing, articles/blogs and other information about cannabis, terpenes and more.

In some embodiment, a user will be adding ingredient(s) that are sourced by the user, and the OBB can recalibrate automatically and/or be recalibrated to allow for variant concentrations and/or viscosities of fluid.

In some embodiments, the OBB is configured such that different oils and components will not touch a common chamber of the machine except for the final mixing and dispensing phase. The OBB can use disposable cartridges and/or a cleaning protocol to prevent cross-contamination of oils and other components.

As illustrated in FIG. 22, fluids can be provided to the user in pre-filled smart cartridges. The device can identify the cartridge via (e.g., via QR/bar-code, microchip, etc.) and determine: Contents, Handling requirements, Amount of fluid used/remaining in the cartridge, etc. Color coding of cartridges can be used to assist the user with cartridge replacement, and assist in identifying: fluids that may be considered extreme or unpleasant in excessive quantities; fluids that are typically combined in order to create common flavors or smells: fluids that have different flow rates and viscosities; etc. In some embodiments, fluids can be added to a smart cartridge by Third Parties and sold to the user. The Third party registers the fluid type, handling requirements, etc. with the OBB and/or associated entity. Upon approval, the Third Party could be provided with authentication/authorization information (for example, the Third Party could receive information to print out, create, update a label, QR/bar-code, microchip, etc., and attach it to or otherwise associate it with the smart cartridge. In such embodiments, the device will be configured to not accept cartridges that have not been tagged/registered/authorized with the proper security/authentication/safety information/codes.

In some embodiments, for fluids that have different flow rates and/or viscosities, the cartridges and/or internal components are designed to deliver equivalent flow rates for various materials to most effectively blend and dispense a wide range of ingredient oils within a specified time period (e.g., within one minute of being ordered). To achieve this, the OBB utilizes different internal diameter openings on tubing, fittings, materials, and/or heatings. Embodiments of the OBB incorporate methods for metering fluids within a microfluidic chip.

The OBB includes a machine that can store, mix to specific ratios and dispense automatically, a variety of liquids utilizing an App control. The following are example general specifications, according to some embodiments.

The Fluid Types utilized by the OBB can cover a wide range of pH and viscosity, and OBB components can accordingly handle a wide range of fluid pH, from acidic to basic. In some embodiments, components can be lipophobic, e.g., borosilicate tubing, polypropylene, etc. Fluid types include: Oils (Cannabinoids and Endocannabinoid agonists); Volatile aromatics (Terpenes and Esters); PG: Propylene Glycol; VG: vegetable Glycerin; Small amounts of water and/or alcohol (e.g., EtOH).

In some embodiments, the OBB can be configured to maintain temperatures (e.g., internal device temperatures) within a range that keeps oils liquid (e.g., around 150 F) and/or be configured to rapidly heat the temp of some or all surfaces that contact oils, such as cartridge/tubing, to any appropriate specified temp (e.g., in a range from room temperature to 150 F), such that the oils are fluid and can move and mix.

Example Amounts in cartridge: 0.5 ml-3 ml

Example Fluids moved for mixing in amounts from: 1 μL-1 mL

The cartridge size can be as small as 5 mm×5 cm (e.g., cylinder) or smaller, up to 1 cm×15 cm or larger, according to some embodiments.

The OBB can be configured to take up little counter space, and example device dimensions and no larger than a coffee maker/Soda Stream/toaster. In some embodiments, the OBB may be configured for wall or under-cabinet mounting, or otherwise configured to conserve space.

In some embodiments, the programming and micro-electronics of the OBB are configured as follows: a micro-controller based circuit to control the device; take fluid from up to 24 containers and mix them, to a specified amount (e.g., user selected) into a single receptacle, and may be mixed in a specified order (e.g., per user or per recipe), mix as many or as few as specified, and in an amount specified, from any container, from, e.g., 1 μL to 1 ml (e.g., 1 μL from container A; 5 μL from container B; and 300 μL from container C). The OBB can adjust the temperature of any of the 24 containers, and/or the internal temp of the device, to one or more specified temperatures (e.g., from room temperature to 150F), in order to ensure easy mixing and fluid flow.

In some embodiments, the OBB is configured to hold as few as 1 canister, any number of canisters between 2 and 24 canisters, or more than 24 canisters (e.g., 25, 30, 36, 40, 49, 50, 60, 64, 70, 80, 81, 90, 100 canisters, etc.).

In some embodiments, an OBB is configured to hold 1 canister, and to dispense a single fluid or ingredient (e.g., a single cannabinoid oil), e.g., in a metered amount. A single-canister OBB can be used, for example, to dispense the metered amount of the single fluid as a final product, or to dispense the metered amount of the single fluid as an additive to a base product that is external to the OBB. In some such implementations, the OBB can be configured to receive an identifier of the base product (e.g., via an onboard scanner configured to scan a label of the base product or a container thereof, via a wired or wireless signal from a scanner external to the OBB and configured to scan a label of the base product or a container thereof, via a user interface of the OBB (e.g., a graphical user interface (GUI), button, or other selector mechanism), and/or via a wired or wireless signal from a remote compute device operably coupled thereto, in response to a user input received thereat). As an example, a user may place an open-top container containing a base product comprising a tincture in the OBB, and in response to receiving the identifier of the tincture via one or more of the foregoing communications, the OBB can dispense an appropriate/metered amount of THC liquid into the tincture. The appropriate amount of THC liquid may be determined by the OBB based on one or more of: the tincture product identifier, one or more user inputs, an identifier of the THC liquid, etc.

In some embodiments, the OBB is configured to hold multiple canisters, and to receive an identifier of the base product (e.g., via an onboard scanner configured to scan a label of the base product or a container thereof, via a wired or wireless signal from a scanner external to the OBB and configured to scan a label of the base product or a container thereof, via a user interface of the OBB (e.g., a graphical user interface (GUI), button, or other selector mechanism), and/or via a wired or wireless signal from a remote compute device operably coupled thereto, in response to a user input received thereat). As an example, a user may place an open-top container containing a base product comprising a lotion in the OBB, and in response to receiving the identifier of the lotion via one or more of the foregoing communications, the OBB can dispense an appropriate/metered amount of one or more liquids, such as CBD liquid and a lavender oil, into the tincture. The appropriate amount of CBD liquid may be determined by the OBB based on one or more of: the lotion product identifier, one or more user inputs, an identifier of the CBD liquid, an identifier of the lavender oil, etc.

In some embodiments, an OBB is configured to hold multiple canisters, and can dispense a single fluid or ingredient at a time, e.g., in a metered amount, as well as blends.

In some embodiments, the OBB includes a blend button configured to illuminate with a first illumination (e.g., having a first predetermined and/or programmable property including one or more of: color, intensity, wavelength, illumination pattern, etc.) to indicate that the OBB is ready to receive instructions for producing a new blend (i.e., a “ready” state . . . , and configured to illuminate with a second illumination (e.g., having a second predetermined and/or programmable property including one or more of: color, intensity, wavelength, illumination pattern, etc.) to indicate that the OBB has received instructions for producing a new blend and is ready to perform the blending. In some such implementations, the OBB commences blending in response to a press of the blend button occurring when the second illumination is active, and if the blend button is pressed again during blending, the OBB cancels the blend. Once the blend is completed, the blend button can revert to the ready state, with the first illumination active.

In some embodiments, the OBB includes a progress meter (e.g., rendered in graphical form, e.g., via a user interface, and/or indicated by one or a plurality of light emitters (e.g., light-emitting diodes, LEDs). The progress meter is configured to display an indication of how far the blend has progressed (i.e., its “progress) at any given time. Progress can be represented via the progress meter in one or more of the following ways: as a percentage of completion, as a countdown timer, and via indicators that appear (or disappear or change) upon completion of each of a plurality blending phases.

In some embodiments, the OBB includes an open port through which a user can introduce a fluid to be dispensed during the blend process. Use of the open port can be employed, for example, to increase the homogenization of flud(s) as they pass through the (optionally heated) mixing chip. Alternatively or in addition, use of the open port can be employed for passing a larger amount of cleaning fluid through the OBB, for cleaning purposes, than would otherwise be possible using a canister.

In some embodiments, the OBB serves as a point-of-sale vending apparatus, for the sale and dispensing of fluids housed therein. In some such implementations, a software application running on the OBB and/or in communication with the OBB can send a signal to a display viewable by a user (e.g., via a GUI of the OBB and/or of a mobile device of the user) such that an “amount remaining” of one or more products (e.g., dispensable liquids/ingredients) and a cost associated with the one or more products are displayed. Also via the software application, the user can make a product selection (e.g., product name and/or quantity) and submit payment for the purchase. Once the payment has been processed (e.g., by the OBB and/or the software application, optionally in communication with one or more remote processors), and in response to the successful processing of the payment, the OBB dispenses the selected product(s)/ingredient(s), and optionally displays (e.g., via the software application) and/or sends (e.g., emails or otherwise wirelessly transmits) a transaction record (e.g., a receipt) to the user. In some such implementations, the OBB includes or is operably coupled (e.g., via USB) to a printer for local printing of transaction records on paper. The transaction record can include details such as the type of blend created, the components/ingredients selected to form the blend, the cost, the payment method (e.g., truncated), a location identifier, etc.

In some embodiments, the OBB is configured to send, via a software application, a request to one or more users or user demographic groups for their participation in a survey. If the OBB receives, in response to the request, an acceptance message from one or more of the recipients of the request, the OBB sends the accepting users (i.e., survey participants) the survey. The survey can include multiple questions or sets of questions, transmitted all at once or in subsets over time. In some implementations, the survey can specify one or more blends, and request that the user(s) create the blend(s) and send their feedback on the blend(s). Surveys requesting the creation of blends and the submission of associated feedback from the user can sponsored and/or offered by partner entities via the OBB platform. Participation in one or more surveys via the OBB software application can be incentivized, for example by offering the participant users discounts on blends, gift cards, cryptocurrency, or any other form of compensation.

In some embodiments, the OBB is configured to create profiles of users (“user profiles,” or “user demographics”) as they interact with the OBB and/or the software application associated with the OBB, over time. The OBB can prompt users. e.g., via the software application and/or an onboard interface, to provide biographical data such as age, gender, race, etc., for storage as part of the user profiles. User profiles can also include data such as blend history, user ratings/assessments of blends and/or ingredients, user reviews, and user behavior. In some such implementations, the OBB can send user profile data to third party entities, such as health providers, DNA profiling services, and/or social behavior analysis companies. Some studies or surveys can be performed as part of, or represent, a crowdsources clinical trial. Demographic targeting can be performed using user profile data, geographical data, medical data, blend histories, biographic data and/or behavior data. The OBB software application can be configured to prompt users to participate in surveys, as discussed above, and/or to gather information about ingredient/blend preferences or results. Alternatively or in addition, the OBB can receive data (such as DNA and medical data) for one or more users from one or more third party entities, such as health providers, DNA profiling services, and/or social behavior analysis companies, and use the received data to generate blend recommendations or make adjustments to blends for the one or more users.

In some embodiments, a blend catalog is generated to facilitate sharing of blend ideas (e.g., from individual users) with a broader community of users. A user can save a shared blend to his/her own collection (e.g., stored and/or accessible by the OBB software application) and edit the contents of the shared blend to fit his/her personal needs before optionally sharing it back into the community. Blends can be rated, assessed, and reviewed by users to reflect popularity and/or success of those blends within the community. Such ratings and/or reviews can be filtered, for example based on user biographical and/or behavior data, such that users having similar characteristics can have the most applicable ratings and/or reviews showed to them.

In some embodiments, the OBB software application is configured to make recommendations to users regarding additional ingredients that may be added to one or more blends. The recommendations can be based, for example, on a given user's search history, the given user's feedback, and/or reported efficacy from other users.

In some embodiments, a user of the OBB platform is a health care provider (or “practitioner user”), optionally defined as such within the OBB software application in response to a verification message received from another user, or according to a set of eligibility criteria being met. A health care provider user can offer, for example, blend recommendations and/or treatment plans to one or more other users (subject, in some embodiments, to approval of the one or more other users). In some such implementations, the health care provider is granted access to view the one or more other users' blend histories, offer suggestions/recommendations, and/or send a change notification to the user. Practitioner users can thus gain the ability to recommend formulations via the OBB software application, obtain patient feedback via the OBB software application, and/or adjust one or more formulations associated with the one or more other users via the OBB software application.

In some embodiments, the OBB software application is configured to calculate blends and/or blend titrations based upon one or more different types of user-provided information. A user may have an associated measure of one or more ingredients (e.g., in mg) that he/she is prescribed or otherwise directed to take, e.g., a specified number of times per day. This dosage data can be used to calculate a blend recipe and/or and amount of fluid that should be dispensed to maximize the number of servings dispensed (i.e., the OBB software application can perform a dosage calculation and adjust the dispensing parameters in accordance therewith). In some embodiments, a user may be given (e.g., by a health care provider user) or be associated with a titration schedule specifying that he/she is to increase an amount of ingredient ingested per unit of time (e.g., per week). The OBB software application can determine one or more blends based on such a titration schedule and/or other data/parameters discussed above.

In some embodiments, a blend treatment plan includes an identification of a complete blend, or identification of a combination of ingredients. A treatment plan can be applied to or combined with a treatment schedule in which the ingredients change over time. The treatment plan can specify a titration schedule according to which a user gradually increases or decreases the quantity of ingredients over time, for example to ease a transition to, or to grow accustomed to, a change in ingredients. This may also be paired with a change in medication or treatment plan unknown to the OBB/OBB software application. In some embodiments, a gradual reduction of pain medication, for example, may be paired with an increase in THC and/or CBD content of one or more ingredients and/or blends associated with that user in the OBB software application and/or dispensed by the OBB for that user.

In some embodiments, data from a treatment plan is provided to the OBB software application or directly to the OBB (e.g., from a health care professional or the user). The treatment plan can subsequently be adjusted via the OBB software application, e.g., based on feedback provided to the OBB software application by the users (e.g., in response to one or more user experiences).

In some embodiments, data associated with a user's blend history and/or review history may be factored into the OBB software application's determination of recommendations. Alternatively or in addition, a healthcare provider and/or healthcare provider user may take the user's blend history and/or review history into account when formulating a recommendation, a treatment plan, or an adjustment to a treatment plan.

In some embodiments, as a user creates blends via the OBB and/or the OBB software application, the OBB and/or the OBB software application can request (e.g., by rendering the request on a user interface) feedback from the user, for example relating to the symptoms the user is trying to alleviate. In some embodiments, a level of success of a blend is determined based, at least in part, on how frequently a blend is repeated, how the blend has been rated, and/or how frequently it is repeated as part of the treatment of a particular symptom. Alternatively or in addition, the level of success of a blend can be determined based on how is the blend has been rated (by that user and/or by other OBB users). The OBB and/or the OBB software application can detect and/or store preferred blend data for a user (i.e., representing a blend that best suits that user), for example associated with one or more indications/symptoms being treated. The OBB and/or the OBB software application can adjust the preferred blend data based on revisions made to a blend by a user (e.g., adjustments to titration amounts or other adjustments). The OBB and/or the OBB software application can also adjust the preferred blend data based on one or more detected patterns in a users blend/OBB usage behavior(s)(e.g., adjustments made to one or more blends).

In some embodiments, the OBB and/or the OBB software application is configured to determine preferred blend data for a demographic or other grouping of multiple users, based on any combination (or one or more of) the following: user blend histories, patterns of blending, data associated with how a blend is used, data associate with why a blend is used, symptoms actually alleviates by one or more blends (e.g., as determined by user feedback), blends known to be suitable/appropriate for or associated with treating one or more indications, blends known to be suitable/appropriate for or associated with alleviating one or more symptoms, what time of day one or more blends were taken, the type of consumption method associated with one or more blends, an onset time associated with one or more blends (i.e., how long before the effect takes place), and a duration of impact (i.e., how long the effect lasts).

In some embodiments, the OBB and/or the OBB software application is configured to perform calculations that allow users to use blend dispense receptacles such as bottles, containers, or cartridges that are pre-filled with a base fluid such as MCT, one or more Cannabinoid distillates, any single ingredient, or a blend of ingredients. The base fluid can be positioned in the OBB and enhanced by the introduction of one or more fluids or blends dispensed from the OBB In some such implementations, a profile of the ingredients in the base fluid can be input to, transmitted to, detected by, or otherwise made “known” to the OBB or OBB software application, such that the base fluid profile can be added to the blend information that is stored and/or displayed or sent to the user upon completion of the blending and/or dispensing.

The OBB can identify the fluid type and handling requirements for any of the containers, such as via QR/barcode and/or micro-chip.

The OBB can also track the amount of fluid dispensed from each container and associate to the chip or bar code so that if container is removed and later reinserted the device knows how much fluid is left. The OBB can also utilize sensor to check amounts via pressure and/or optical measurement.

In some embodiments, the OBB includes sensor equipment (optionally in addition to other sensor described herein) to collect sensor data associated with one or more users and/or the use of the OBB. Examples of such sensors can include, but are not limited to, internal temperature sensors, external temperature sensors, barometric pressure sensors, altitude sensors, audio sensors (e.g., to measure sound in decibels, db), optical/light sensors, and motion sensors.

The OBB can utilize networking, such as WiFi®, Bluetooth radio, etc., for communication between a smartphone/app, a server, a webservice, and/or the Micro-controller/CPU. The OBB can connect to a WiFi®/Bluetooth network, be able to be controlled by a smartphone app, send status updates to the phone, and self-order new cartridges, e.g., through an online store, when necessary. In some embodiments, one or more ingredients can be added and/or excluded from a formulation recipe based on one or more user searches (e.g., performed via a smartphone app), one or more historical usages and, optionally, feedback from the user pertaining to the one or more historical usages, and feedback from the user community (e.g., received via a smartphone app and/or via the OBB itself).

The OBB can be configured such that the microcontroller based circuit (discussed above) can be controlled from a smartphone, tablet, laptop, computer, or other compute device, communicatively connected via wired (e.g., USB) or wireless (e.g., BLUETOOTH) connection, either directly and/or over a network (e.g., Internet), though some embodiments are secured such that they cannot be remotely compromised or hacked. In some embodiments, the smartphone or other device can have complete control of the functions described, via a micro-controller based circuit or circuits. The OBB can communicate status with a smartphone, fluid types and amounts in machine, etc. In some embodiments, particularly for advanced/intensive processing, the OBB can utilize a connected device (e.g., a mobile device running an OBB software application) for processing of certain information and/or making processor-intensive determinations.

In some embodiments, the OBB is configured for exacting microfluidics and fluid handling. Implementations of embodiments that include viscous cannabinoid oils have been configured such that error tolerances are +/−10%, +/−9%, +/−8%, +/−7%, +/−6%, +/−5%, and in some configurations, error tolerance can be reduced to +/−4%, +/−3%, +/−2%, and even +/−1% when the configurations of the system are tightly regulated.

Some embodiments include a fluid container or “cartridge” system for the OBB. Fluids in container are heated and/or pumped out to be mixed into a homogeneous solution. Generally, small size is advantageous, and sizes can range, for example, from 5 mm×5 cm cylinder to a 1 cm×15 cm cylinder. Some sizes can hold up to 3 ml of fluid. Some implementations can control temperature up to 150 F. Some can be fillable using a machine similar to a standard mass production vape tank filling machine. Cartridges can contain a number of different fluid types as discussed herein. Cartridges provide a system for moving a wide range of volumes and viscosities, e.g., from 1 μl to 1 ml, into the mixing cartridge. Cartridges can be configured to handle a wide range of fluid types and pH without leaching or leaking. Cartridges can connect to OBB using secure fittings, such as Luer fittings. Cartridges and/or fittings can be formed from lipophobic and/or hydrophobic material, polypropylene, etc., and/or may have appropriate coatings or be otherwise configured for general fluid use or for use with specific fluids based on the properties of those fluids. Cartridges can be configured to be inexpensive and mass producible. A cartridge can be configured to be easy for a novice user to handle, store, identify, and insert into the device. Cartridges can be configured to be secure such that they cannot easily be opened unintentionally or accidently, or spilled or tampered with. Cartridges can be color coded and matched to color on device. The device can identify a cartridge upon insertion via (bar-code or microchip or other) and reads: Contents, Handling requirements, Amount of fluid used (so that it can be removed and inserted again later). The cartridge may also include a quality control, anti-counterfeit, and/or anti-tamper element, such as a vacuum seal portion, serial number, validation code, etc. In some embodiments, multiple cartridges (e.g., 1 mL, 2 mL, or 3 mL each) can be merged together to create larger (e.g., 6 mL, 16 mL, 24 mL, or 32 mL) cartridges.

In some embodiments of the OBB, adding and removing a cartridge can be similar to inserting an ink cartridge, so the user can easily add or remove a cartridge/container from the device. The cartridge can be under pressure and can be securely sealed using secure fittings, such as a LUER-LOK fitting (e.g., with flowrate of 100-150 uL/min if hydraulic).

The OBB is configured to handle hundreds of insertion and removal events without leaking or blocking up, and in some implementations, can be re-sealable if components are removed. The cartridge can be configured for handling by a novice user, so that it is easy to handle, store, identify, and insert into the device, and can include labeling and color coding on cartridge.

In some embodiments, there may be a Self-Priming event trigger where Fluid from cartridge is primed into place upon insertion and ready for precision handling of fluids. The configuration of the OBB and/or cartridges can be such that there is no or minimal gap of fluid between the cartridge and the entry point to the mixing manifold. The OBB can also be configured for self-cleaning and clearing of tubing and connection to mixing manifold.

In some embodiments, to support fluid handling and movement, the OBB provides a system for moving fluid out of the cartridges, into a metering cartridge then a mixing cartridge or manifold and out into a receptacle. Fluid Pumping can be via: pneumatic or hydraulic, multi-pump or single pump.

Parts of the OBB that contact the oils or other components can be configured accordingly (e.g., lipophobic). In order to provide temperature(s) to facilitate handling of the oils and other components (e.g., due to the viscous nature of oils, heating can be required to maintain accurate and effective flow), a system of Peltier elements or the like, heat sinks, cooling fans, etc., can be utilized. The contact parts can also be configured to handle acid and/or base pH fluids.

The OBB provides precision-controlled fluid movement of 1 μL or less to 1 mL or more from any of the 24 cartridges to a blending manifold. While many of the volumes to be pumped can be small, for the larger 200-800 uL, which may be more viscous, hydraulic action and tubing can be used. Example pumps include multiple small Piezoelectric Pumps, such as Bartels Micropumps mp6-PPSU, single larger Cavro XP Syringe Pump Or Exigo pump. The OBB can utilize micro valves, controlled by a microcontroller (as discussed above) to direct the flow of oils through the machine (e.g., Tagasako Solenoid Diaphragm pumps using PTFE (TEFLON)).

The OBB provides a system for blending and emulsifying the fluids. A blending manifold into which the fluids can flow and be mixed, in any specified order, can be configured to emulsify the fluids (e.g., via ultrasonic, microfluidic, air), and maintain a stable temperature of mixture across a range of specified temps, e.g., from room to 150F or more. The time to reach a specified mix temperature can depend on the embodiment and application, and can include times to reach temperature of 5 seconds, to seconds, 20 seconds, 30 seconds, 45 seconds, 60 seconds, 120 seconds, 180 second, 4 minutes, 5 minutes, 6 minutes, 7 minutes, 8 minutes, 9 minutes, to minutes, 11 minutes, 12 minutes, 13 minutes, 14 minutes, 15 minutes, 16 minutes, 17 minutes, 18 minutes, 19 minutes, 20 minutes, and/or any integers there between, or ranges there between.

A temperature controlled fluidics cartridge can be used to channel multiple oils/components for a recipe and blend into a single, stable homogenous mixture. An example fluidic mixing cartridge can include a mixing chamber with a plurality (e.g., 24) of fluid inputs from the instrument, and may be expandable (e.g., up to 256 fluid inputs). In some embodiments, cartridges can be reused and/or recycled. In some embodiments, the cartridge can assemble to the instrument by the user. In some embodiments, a mixture from the cartridge mixing chamber can be transferred to a collection tube and receptacle. In some embodiments, each fluid is added from the bottom of the cartridge mixing chamber to create mixing. Additional mixing may be provided by air dispensed through the mixing chamber and/or ultrasonics.

The OBB also provides methods for dispensing the fluid mixture into a user placed receptacle. In some embodiments, the dispensing nozzle sits over a filling port for a fillable receptacle. In some implementations, users can place a variety of receptacles ranging in size up to 50 mm×100 mm under the nozzle, while in other embodiment, the OBB can be configured to work with specified receptacles and thereby provide additional security and quality control.

The OBB provides for mechanical blending and/or emulsifying/homogenizing of the oils and/or other components prior to dispensing.

In some embodiments, forcing oils and/or other components through a single small fluidics port may cause turbulence enough to complete this process. In some embodiments, emulsification may be accomplished with ultrasonic mixing/agitation and/or air (or other gas, such as nitrogen, and/or a mixture of pharmaceutical/food grade gases).

The OBB can also provide a system for cleaning the machine. For example, in some embodiments, a user-replaceable mixer chip/manifold can be flushed out or replaced. Potentially highly sticky, viscous materials can be used, some of which have the consistency of honey or coconut oil at lower temperatures. Some embodiments may be configured to use food and/or pharmaceutical grade cleaners (e.g., H₂O/EtOH) that will risk contamination of the device. Some embodiments may be configured to avoid use of on-board cleaning fluids by minimizing the amount of time/locations that the oils are touching the same surfaces or in the same chamber or conduit within the machine. As discussed above, materials and/or coatings may be configured for ease of cleaning and maintenance of accuracy (e.g., tubing and cartridge surfaces could be lipophobic).

In some embodiments, the OBB is supported by an online resource of recipes and more (e.g., Oblend.com). Users can discover, share and build recipes for use in the OBB. The online resource can also suggest recipes to the user based on data aggregated from their history, social network, demographics, and the ingredients currently in the device. Ingredient adjustments can be provided, listed, and/or suggested, including adding ingredients, removing ingredients, and/or new ingredients. Users can also order fluid cartridges and replacement parts for the OBB. In some embodiments, recipes may be proprietary, and the OBB can be configured accordingly.

Users can instruct the OBB to dispense OBB blends on demand, and such blends can be developed to encourage Micro-Vaping. Micro-vaping is defined as a 100 μl or less vape tank created by the user for consumption/use either immediately or within a few hours. A micro-vape of 100 μl will provide approximately 30 puffs vs a standard 300 puff 1 mL vape cartridge. This micro-vaping will enable the user to build a cannabis vape experience on demand tailored for a specific mood or environment. Much like a single cup of coffee, a single micro-vape can be for short-term use.

There is currently no device that can be used by the home user, or local retail store, to blend fluids such as cannabinoid oils, esters, terpenes, and more, in micro-fluidic ratios (e.g., 1 microliter), to create a custom mixture that fits their personal desires or life-style. Doing so manually is extremely difficult and requires specialized knowledge, hard to find materials and basic chemistry equipment such as micropipettes.

For example; in the cannabis industry oils for vaping or oral ingestion are produced in large batches often from a single strain of plant. The flavor, smell, pharmacological and/or psychotropic effects are derived from the mixture of THC, CBD, CBG, the terpenes that occur in that plant naturally, and/or other components. One batch of oil from the “same” strain however, may vary slightly than a different batch from that “same” strain due to a variety of factors; growing conditions, protocols variations during oil processing, freshness of flower being processed, etc.

In some embodiments, the OBB can be utilized to approximate specific flavor and effects, for example, in cannabis applications, using pure and organic, extracted THC, CBD, CBG, other cannabinoids and terpenes that can be sourced to customers, in established ratios or “recipes” that can be reproduced.

At the broadest scope, some embodiments of the OBB allows a user to create or choose a recipe for and then produce a precisely blended mixture of fluids on-demand. Individual fluids may be mixed in amounts as small as 1 μl or less and over 3 ml. This allows the user to have an amount that may last an hour, a day, week or month depending on their desires. The OBB can mix and homogenize the fluids in any predefined order prior to dispensing, and the order may be configured to provide a desired flavor, aroma, and/or effect. Fluids may be mixed for consumption, vaping, massage, skin care, aromatic vaporization, etc.

Although discussed in terms of vaping herein, the OBB can be used in a variety of industries and applications ranging from: use in massage therapy for instant custom therapeutic oils, recreational and medicinal cannabis and nicotine vaping; cannabis oils for oral consumption; cooking oils production: at home aroma therapy; and use in pharmacies for filling prescriptions, hospitals and research facilities (e.g., for research and/or clinical trials) bars, gyms, health food stores, and for adding blends for beverages, at-home or on-mobile smell-o-vision, creating scents in public areas such as hotels, movie theaters, bars, restaurants, be built into a vehicle for on-demand aromatic scents, and/or the like.

While some examples shown herein hold 24 fluid types, additional version and/or embodiments of the OBB, such as those aimed at pharmacies, hospitals, and/or research facilities, may hold and manage several hundred different fluids in a variety of reservoirs. A more simplistic model may only hold, for example, to canisters (e.g., received in corresponding ports).

Currently, there is also no online resource for building and sharing recipes that can be blended by an OBB.

The OBB can be configured to quickly provide blends to users, such that there is little wait time. In some embodiments, the OBB can be configured to heat up in anticipation of a blend (i.e., start heating at 4 pm because a user typically requests a blend around 10 to 15 minutes later). The fast blend time is another advantage of some embodiments and includes blend times, from user request on OBB app to dispensing in ranges from about to seconds to about 40 minutes, including about to seconds, 20 seconds, 30 seconds, 45 seconds, 60 seconds, 2 minutes, 3 minutes, 4 minutes, 5 minutes, 6 minutes, 7 minutes, 8 minutes, 9 minutes, to minutes, 11 minutes, 12 minutes, 13 minutes, 14 minutes, 15 minutes, 16 minutes, 17 minutes, 18 minutes, 19 minutes, 20 minutes, 30 minutes, 40 minutes, and/or any integers there between, or ranges there between.

Another novel aspect of the OBB is that users can use a simplified interface to increase or decrease the active ingredients, such as the cannabinoid and terpene ratios found in cannabis vapes, in the final mixture. This gives the end user unprecedented controls over the cannabis experience they will be able to tailor create.

Depending upon the indication or desired effect, users can customize their formulations with regard to ingredients and/or product type (i.e., form of ingestion). A user may, for example, take into account their own knowledge regarding their recipe history and/or the time of day that they plan to take the formulation. In one example, a user that wants help sleeping may choose a recipe from an OBB site (e.g., Oblend.com) that is high in the terpene Linalool and the cannabinoid CBD, or for a more awake experience a user may choose a different THC oil with extra Pinene and/or Limonene.

In another example, a user that wants help with pain management may choose a vape or nasal spray recipe (e.g., including terpenes like limonene and pinene) in the morning, for example to wake him up and to get a rapid onset effect. In the afternoon, he may then choose to use the same active pain relieving ingredients but add in anti-inflammatory ingredients like Turmeric and Curcumin in a topical form. In the evening, he may add linalool and CBN to the same active pain relieving ingredients, to help him to sleep and to provide long-lasting pain relief throughout the night.

In yet another example, a user may identify a recipe that has worked for others with the same indication (e.g., Alzheimers, Parkinson's, pain, sleep disorder(s), etc.), where the recipe includes THC, but the user may be reluctant to use the THC ingredient since it is the psychoactive ingredient in Cannabis. The user may therefore wish to exclude THC from a formulation. The user can reduce the amount of THC to “0” or minimal and otherwise mix the formulation according to the identified recipe. Then, over time, in subsequent iterations of mixing and dispensing the same formulation, the user can gradually increase the THC amount according to their own comfort level and ability to tolerate THC, such that they can maximize the benefit that they derive from the formulation but avoid or minimize the perception of being “high.”

In other embodiments where a user identifies a recipe containing THC, instead of excluding the THC altogether, the user may elect a vape formulation instead of an edible formulation for recipes that contain THC, for example based on his tolerance of THC in vape form.

The OBB is a vital tool for home-use, retail and pharmaceutical, clinical trials and research (e.g., as performed by hospitals, universities, physicians, and research scientists, etc.), compounding pharmacies, physicians (e.g., prescribing medicines (including cannabis/cannabinoid medicines) and/or vitamins), homeopathic, and massage industries. Through research it has been determined that different mixtures of terpenes and different cannabinoids create an unlimited variety of effects for each individual user, and this is the first home use device to allow the user to create such mixtures and effects which include medical and recreational uses. Previous to the present disclosure, clinical trials pertaining to certain components or extracts of cannabis have either not been performed, or have proven difficult or infeasible due to a lack of ability to achieve precision in formulations and/or dosing thereof.

In some embodiments, the OBB and fluids to be used in it, other than regulated ones like THC, can be sourced centrally and sold to the customer in pre-filled cartridges and mixing kits. These include: sourced and packaged terpenes to be used in the OBB; sourced/packaged pre-mixed concentrated flavors and esters; cannabinoids, other than THC, i.e., CBD, CBG, also to be used in the OBB; custom, proprietary, “open” cartridges for user that want to add their own ingredients to the OBB: etc.

OBB accessories can include: Gelatin or other pill filler; ultrasonic oil diffuser, custom vaping receptacles, tips, batteries, etc., as well as one or more “Micro-vapes” and corresponding cartridges.

In some embodiments, the OBB (and/or OBB app and/or server) can be configured to capture usage information, including frequency of use, application type, user demographics, medical disorder user searching or trying to treat, recipe/ingredients selected, adjustment/customization of ingredients, frequency, form of use (e.g., vape, tincture, skin application, etc.). Such data can also, in some embodiments, be used to identify “clusters” of successful ingredients/formulations used by individuals with various demographics to treat for various medical disorders. For example, the OBB can capture usage information such as (1) the amount (either relative or actual) of ingredients used (e.g., amount of terpenes, cannabinoids, etc.); (2) the frequency of use/intake; (3) recipes used and/or how users customize/modify recipes/protocols; (4) form(s) of use/ingestion (e.g., edible, vape, tincture, etc.); and/or (5) qualitative or quantitative user feedback or input (e.g., user liked/disliked particular blend, particular blend made user feel relaxed or awake, user made blend to address back pain). Captured information from users can be processed and analyzed for a variety of applications, for example, used to reorder frequently used ingredients, used to provide blending suggestions to other users (including other user that have been identified as similar to a particular user based on demographics, usage information, etc.), provide user usage information to a medical professional that is overseeing a particular user (e.g., a doctor that prescribed that a user take a given blend or amount of a specific active ingredient), and monitoring/treatment of certain medical indications and ailments such as Parkinson's, Pain, Seizures, Epilepsy, Alzheimer's, Depression, ADHD, Anxiety, Cancer etc., and/or emotional effects. In addition, this data can be used to determine successful formulations for treating medical disorders in order to conduct clinical trials and ultimately file patents on successful drug formulations. In some embodiments, certain aspects or components of the OBB can be configured to be regulated/controlled by an administrator, such as a doctor. In some embodiments, the OBB can capture demographic and/or genetic information about one or more users while complying with applicable regulations (e.g., HIPAA, privacy controls, etc.). Alternatively or additionally, an authorized administrator (e.g., doctor or pharmacist) may cross-reference OBB data with genetic and/or medical data managed by the administrator to determine a desirable formulation/recipe for that user. In some applications, specific blends or ingredients are monitored or controlled in accordance with inputs/limits provided by the administrator (or required by regulations, reimbursement rules, etc.).

In some embodiments, the OBB provides automatic ordering, billing, shipping/delivery, and/or invoicing for tank/cartridge replacements, such as when they become low or when user orders. In some embodiments, replacements are provided with a recycle/return capability, such as a return shipping label, to facilitate a user sending empty tanks/cartridges for recycling or disposal. Although applications discussed herein pertain to human consumption and medical applications, the OBB can also be configured for veterinary applications, non-consumable applications such as plant/agriculture health and protection (including formulating pest deterrents), chemical mixing, etc.

In some implementations, a user's smartphone or other portable compute device (e.g., running an OBB application) can link to or with a nearby OBB system/device (e.g., via BLUETOOTH, RFID, near-field communication (NFC), and/or the like) and generate a validation/authentication request, for example containing a security certificate and/or credentials (e.g., username and password) to authenticate a user's identity, age, prescription, etc., along with user preference information (e.g., preferred blends/mixtures, use type (vaping, aromatherapy, etc.), and/or user location information (e.g., using portable compute device GPS coordinates and/or the like). In some embodiments, validation/authentication can be used to unlock the device (e.g., for refilling, maintenance, etc.) and/or to use the device for dispensing a mixture/blend. In some instances, the GPS coordinates can be used to secure the device against improper use. For example, if the device is taken outside a specified geographic region where one or more of the liquids or other components are not permitted, some or all functionality of the OBB may be disabled or locked down to prevent improper or illegal dispensing. The OBB can be configured to be locked down for a specified time, and/or until the proper GPS location is subsequently received and/or an authorized user has removed the lock down.

For example, a user's smartphone or other portable compute device (e.g., running an OBB application) can provide a blend options request in the form of a (Secure) Hypertext Transfer Protocol (“HTTP(S)”) POST message including data formatted according to the eXtensible Markup Language (“XML”). An example blend options request, in the form of an example HTTP(S) POST message including XML-formatted data, is provided below:

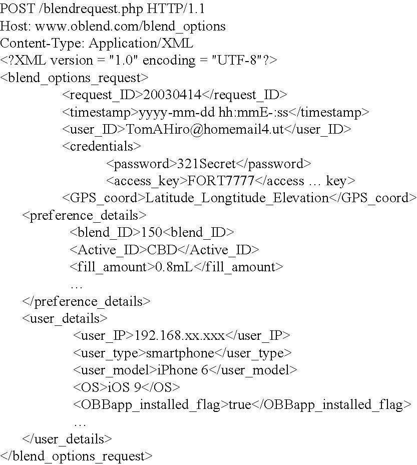

In some embodiments, a blend is transmitted to the OBB not using XML, and instead, a recipe is translated from (Ingredient, Amount), e.g., on an OBB app on a smartphone, into binary commands that are transmitted to the OBB for running the recipe on the OBB. Table 3 below provides an example recipe file comprising binary data that the OBB implements as valve timings to run/implement a particular mix routine/blend.

TABLE 3

| | | | | | | | | |
|---|---|---|---|---|---|---|---|---|
| 0 | 0 | 0 | 0 | 0 | 0 | 140 | 0 | 9 |
| 0 | 0 | 0 | 224 | 0 | 40 | 140 | 0 | 9 |
| 64 | 0 | 0 | 0 | 0 | 40 | 140 | 0 | 200 |
| 0 | 0 | 0 | 0 | 0 | 40 | 140 | 0 | 8 |
| 0 | 0 | 0 | 64 | 0 | 40 | 140 | 0 | 9 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 192 | 0 | 40 | 140 | 0 | 0 |
| 0 | 0 | 0 | 64 | 0 | 40 | 140 | 0 | 8 |
| 0 | 0 | 0 | 192 | 0 | 40 | 140 | 0 | 0 |
| 0 | 0 | 0 | 128 | 0 | 40 | 140 | 0 | 8 |
| 0 | 0 | 0 | 224 | 0 | 40 | 140 | 0 | 0 |
| 0 | 0 | 0 | 96 | 0 | 40 | 140 | 0 | 18 |
| 0 | 0 | 0 | 224 | 0 | 40 | 140 | 0 | 19 |
| 0 | 0 | 0 | 225 | 0 | 40 | 140 | 0 | 0 |
| 0 | 0 | 0 | 33 | 0 | 40 | 140 | 0 | 28 |
| 0 | 0 | 0 | 97 | 0 | 40 | 140 | 0 | 49 |
| 0 | 0 | 0 | 225 | 0 | 40 | 140 | 0 | 49 |
| 0 | 0 | 0 | 161 | 0 | 40 | 140 | 0 | 0 |
| 0 | 0 | 0 | 33 | 0 | 40 | 140 | 0 | 18 |
| 0 | 0 | 0 | 97 | 0 | 40 | 140 | 0 | 19 |
| 0 | 0 | 0 | 225 | 0 | 40 | 140 | 0 | 0 |
| 0 | 0 | 0 | 161 | 0 | 40 | 140 | 0 | 18 |
| 0 | 0 | 0 | 225 | 0 | 40 | 140 | 0 | 0 |
| 0 | 0 | 0 | 97 | 0 | 40 | 140 | 0 | 18 |
| 0 | 0 | 0 | 225 | 0 | 40 | 140 | 0 | 20 |
| 0 | 0 | 0 | 33 | 0 | 40 | 140 | 0 | 19 |
| 0 | 0 | 0 | 32 | 0 | 40 | 140 | 0 | 9 |
| 0 | 0 | 0 | 0 | 0 | 40 | 140 | 0 | 49 |
| 0 | 0 | 0 | 0 | 0 | 0 | 140 | 0 | 19 |
| 100 | | | | | | | | |

In other embodiments, the blend options request may be generated as a result of a user manually requesting, e.g., via an interface on the OBB, information pertaining blending and dispensing options provided by the OBB. The OBB and/or OBB app can, in some embodiments, send a user preferences request to an OBB server. In some implementations, the OBB server can receive a (Secure) Hypertext Transfer Protocol (“HTTP(S)”) POST message including data formatted according to the eXtensible Markup Language (“XML”). An example user preferences request, in the form of a HTTP(S) POST message including XML-formatted data, is provided below:

```
POST /sample_user_preference_query.php HTTP/1.1
Host: www.oblend.com/OBB_dispense
Content-Type: Application/XML
<?XML version = ″1.0″ encoding = ″UTF-8″?>
<sample_query_request>
    <request_ID>20061003</request_ID>
    <timestamp>yyyy-mm-dd hh:mmE-:ss</timestamp>
    <user_ID>SethAHiro@homemail4.nj</user_ID>
    <credentials>
        <password>Secure123</password>
        <access_key>Fort1992</access_key>
    <GPS_coord>Latitude_Longitude_Elevation</GPS_coord>
  <sample_user_preference_query name=″user_profile″>
    <query num=1>
      Select Type.Number, Blend.Number Formulation.Pref from
User_Profiles where UserAccountNum=SethAHiroNum
    ...
    </query>
    <query>
    ...
    </query>
  </sample_user_preference_query>
</sample_query_request>
```

The OBB server can perform the requested query (e.g., via user account preference query) on a user account database to determine user preference information (e.g., preferred blend(s)/formulation(s), preferred use(s), use device type(s) owned/used, preferred filling amount(s), etc.). The OBB server can, in turn and as a result of the query, return a user preferences response to the OBB.

The OBB and/or OBB app can compile information obtained from one or both of the user mobile compute device and a OBB user account database (e.g., via an OBB server) in order to provide blending/mixing interface options, including one or more of the following: user authentication verification, location(s) of OBB(s), blend liquids/ingredient levels available within the OBB(s), reorder information, payment information, etc., and may display the available blend liquids to the user, e.g., via the user mobile compute device and/or via a user interface on the OBB. In some embodiments, the OBB is not configured with substantial processing capability and is instead configured to receive and execute recipes and other instructions from an OBB app and/or OBB server, which can improve the overall functionality of the OBB as it will not require upgrades or updates that could otherwise be expensive or difficult, and instead rely on changes or updates to the OBB app or OBB server.

In some embodiments, the OBB can be configured to provide blends based on a user profile. For example, a user can provide a saliva sample, blood sample, hair sample, and/or urine sample (e.g., to the OBB server or a third party in communication with the OBB server) and that sample used to determine a vitamin, mineral, or other deficiency, and the OBB can receive and provide a blend that addresses the determined deficiency. User profiles can be based on chromosomal analysis, genome analysis, chemical analysis, deficiency assessment, disease predisposition, etc., and such profiles can be utilized to provide a blend that is tailored to the user. In some applications, an administrator/doctor can provide a “prescription” for patient to the OBB (i.e., over a secure network and via a authenticated and verified communication) and that prescription determines some or all of the mixing and dispensing provided by the OBB. In some embodiments, the OBB is configured to receive ingredients that are prescription ingredients, and can include a validation mechanism or process. For example, the OBB can include one or more ports that require physical and/or logical (i.e., computer-based) compatibility to assure that the ingredient is from the proper source and/or verify to an administrator or regulator that the ingredient has been attached/supplied to the OBB and is being dispensed properly. In some embodiments, the OBB can be configured to utilize profiles, such as those discussed in U.S. Pat. App. Pub. No. 2016/0300289 (the entirety of which is herein expressly incorporated by reference for all purposes), to provide a blend or blends for a user.

The OBB can be configured for a variety of applications and for a variety of industries, including but not limited to the cannabis industry, medicine/hospital/pharmacy, aroma industry, mixology, personal products, vitamins, etc. For example, the OBB can provide blends for tinctures (including medicinal tinctures), butters and oils (including for cooking/baking), balms/creams/lotions/etc., edibles/ingestibles (confections, drinks, pills, capsules, lozenges, etc.), sprays (e.g., oral sprays, nasal sprays), lubricants, shampoos/conditioners, perfumes/colognes, bath soaps, bubble bath materials, massage oil, body lotion, sunscreen, e-cigarette vape blends that include nicotine, cooking oils with botanical oils and/or spices/spice oils to create “taste”-infused and/or healthy cooking oils, as drink mixers/additives, etc. The OBB can be configured to form or facilitate the formation of such products (e.g., the micro-blend can be added to a base that is warmed to a specified temperature, such as by an attachment to the OBB that has a macro mixer and heating element. The particular amounts that can be processed and received by the OBB are variable and can be configured for use in such applications (i.e., accept ingredient tanks that are relatively larger than those generally discussed above and provide mixtures in amounts that are larger than those discussed above). In some embodiments, the OBB is configured to be connected/used with one or more other OBB to provide increased functionality (e.g., a plurality of OBBs can be configured to work together and/or be controlled together, such as by one mobile device/mobile device application instance). Similarly, the size of the OBB can be smaller than is discussed above, such as a “traveler” version that utilizes a smaller set of liquids/ingredients (e.g., only uses 6 or fewer liquids).

As illustrated by FIG. 23A-FIG. 23F, in some embodiments, there are three pieces within the microfluidic chip/card assembly: a first rigid piece in which the fluid channels reside, a thin sheet (e.g., comprised of a plastic or elastomer) that can be used to form or define the monolithic membrane valves, and a second rigid piece in which the air channels reside. Each of the rigid pieces can be bonded to the membrane to seal off the channels. Bonding methods can include adhesives, thermal bonding, ultrasonic bonding, and/or the like. Alternatively or in addition, pieces (or “layers”) of the microfluidic chip/card assembly can be screwed together or otherwise mechanically fastened to one another, to secure the assembly and to ensure that the fluid channels are sealed (i.e., due to the force applied to the layers by the screws).

The fluid manifold distributes oils/reagents from each of the cartridges/tanks into a central mixing chamber. The fluid paths can be sized to provide a known flow resistance so that a relationship can be determined/defined between the pressure within a/the cartridge and the flow rate of the fluid into the mixing chamber. Each fluid path can also include a pneumatically-controlled membrane valve, which allows the control electronics to turn the flow of each fluid on and off independently. In some embodiments, also included in the fluid manifold are two lines, one at each end of the mixing chamber, configured to provide for the introduction of a cleaning solution into the mixing chamber. There can be two additional lines that allow for air flow to the mixing chamber so that it can be pressurized or subjected to a vacuum. The cleaning solution may run through every ingredient channel and/or may exit the OBB via the nozzle. In some embodiments, more than two cleaning lines are included in the manifold.

The pneumatic manifold can include an inlet port for each of the valves. As an inlet port is pressurized, the flexible membrane within its corresponding valve is forced onto the fluid manifold, preventing fluid from flowing through the valve. As a vacuum is pulled on an inlet port, the differential pressure within the valve pulls the membrane away from the fluid manifold, allowing fluid to flow through the valve.

FIGS. 24A to 26E provide details for example OBBs according to some embodiments of the disclosure.

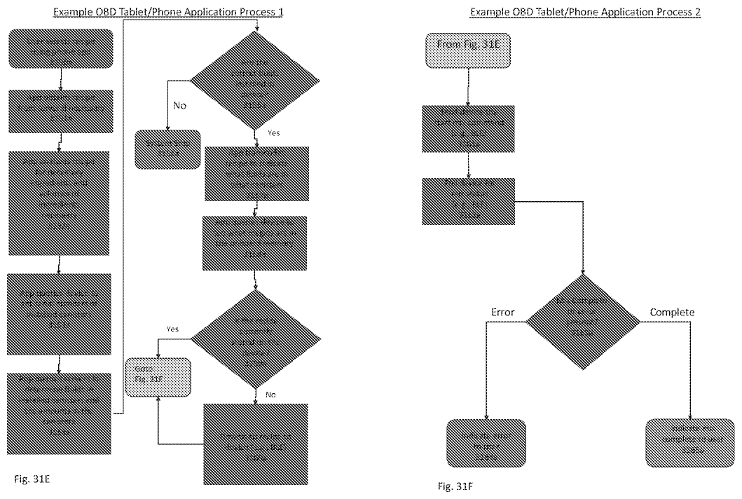

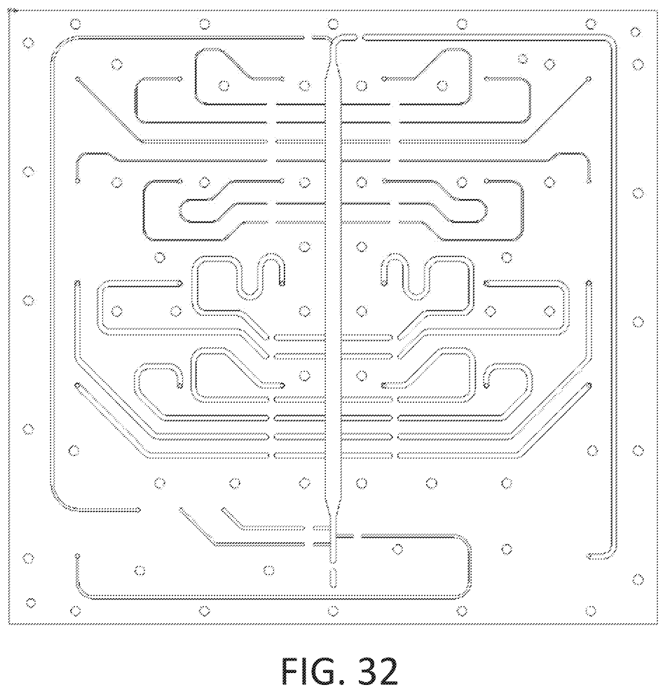

FIGS. 27A to 27E provide details for an example OBB with a cover removed according to some embodiments of the disclosure.

FIG. 27F provides details for an example OBB with cover removed and components including a microfluidic mixer chip 2701a, solenoid plates 2711a, cable management cap 2713a, sealing cap 2714a, fluid vials/cartridges 2715a, a vial heater/heater block 2716a, a microfluidic mixer chip heater/heating block 2717a, pumps 2718a and air chambers 2719a, and a controller 2720a labeled. FIG. 27G shows another view of the OBB showing the fluid dispensing region/cavity 2722a. FIG. 27H shows an embodiment of the OBB in a base housing component 2723a with an activity indicator 2725a affixed or placed on top, and FIG. 27I shows an embodiment of the OBB in a base housing 2723a and middle housing 2724a that are configured to protect the internal components of the OBB, and also including an activity indicator 2725a affixed or placed on the top of the OBB internal components. In some embodiments, the activity indicator will provide a visual display when the OBB is active (e.g., blending), starting up/warming up, shutting down/turning off, etc.

FIGS. 28A to 28H provide internal details of some example OBBs according to some embodiments of the disclosure, with the same or similar internal components and structure to those shown in FIGS. 27F-27I.

FIG. 29 provides a view of another example OBB microfluidic mixer chip according to some embodiments of the disclosure.

FIGS. 30A-30C shows an example OBB with the cover removed, having removable reservoirs 3007 and an OBB microfluidic mixer chip 3005.

In some embodiments (e.g., similar to that of FIG. 6B), an OBB includes a single heater. In some such embodiments, the microfluidic mixer chip comprises a metal (e.g., aluminum) or other thermally-conductive material, in some instances the metal (or other material) having a coating to facilitate the microfluidic function, such as, by way of non-limiting example, TEFLON. As an example, for embodiments in which there are three pieces within the microfluidic chip/card assembly: a first rigid piece in which the fluid channels reside, a thin sheet (e.g., comprised of a plastic or elastomer) that can be used to form or define the monolithic membrane valves, and a second rigid piece in which the air channels reside, the second rigid piece in which the air channels reside can comprise Teflon-coated, machined aluminum. The single heater heats the fluid vials/cartridges of the OBB, and physically contacts the metal-containing microfluidic mixer chip so as to heat it. Such configurations can result in lower-energy-consumption operation, reduce thermal load, faster heating and temperature responsiveness, improved temperature uniformity, and/or a smaller form factor or footprint. In some such configurations, the microfluidic mixer chip heater/heating block can be replaced with a plastic support block.

In some embodiments, an OBB includes multiple heaters, one or more of which may be a flex heater, such that targeted areas of the OBB can be heated.

In some embodiments, fluids mixed by the OBB include one or more of: nano-encapsulated cannabinoids, micro-encapsulated cannabinoids, nano-encapsulated terpenes, and/or micro-encapsulated terpenes. Encapsulation of cannabinoids and/or terpenes can be achieved, for example, using a microfluidizer. Encapsulation can include mixing nanoparticles and/or microparticles with a surfactant (e.g., a lipid-based surfactant) that coats the particles. Encapsulated particles can have an altered appearance (e.g., can be optically transparent or translucent). Such encapsulation of cannabinoids and/or terpenes (e.g., mixed with one or more carriers and, optionally, a solubilizer such as terpene, to prevent recrystallization) can result in several benefits, such as longer shelf life; increased absorption (e.g., buccal and/or mucosal); extended release: reduced corrosion to the mixer chip and/or other components of the OBB; improved bioavailability; homogenization when blended in a suspension; Newtonian consistency and correspondingly lower heat to maintain fluidity; improved ability to pass through a user's system without being retained, while retaining the intended therapeutic effect(s); predictability with regard to time-to-onset of therapeutic effects (e.g., control of time-release via encapsulant thickness); desired therapeutic effects with less fluid in the formulation (since the active ingredient(s) can be more readily absorbed into a user's bloodstream); ability to mix plant derivatives with water without coagulation; and ability to ingest the formulation via a form of consumption other than vaping. Encapsulation can also be beneficial in that it reduces or eliminates corrosion of the chip (and/or components thereof) that can be caused by exposure of chip materials to particular ingredients, such as cannabinoids and/or terpenes (e.g., limonene). When encapsulated cannabinoids and/or terpenes are used exclusively in the fluids (i.e., no non-encapsulated/“naked” cannabinoids or terpenes are included in the fluids), a modified geometry and/or surface chemistry of the microfluidic channels of the microfluidic mixer chip may be used. For example, narrower microfluidic channels may be employed since the liquids have a much lower viscosity than they do without encapsulation. Different adhesives (e.g., adhesives that are more susceptible to the corrosive effects of non-encapsulated terpenes) may also be used to assemble the microfluidic mixer chip in the OBB, and different solvents may be used to clean the microfluidic channels. Nano-encapsulated cannabinoids, micro-encapsulated cannabinoids, nano-encapsulated terpenes, and/or micro-encapsulated terpenes can be particularly suitable for use in applications such as edibles and beverages.

In some embodiments, an encapsulated material (e.g., nano-encapsulated or microencapsulated; see e.g., U.S. Pat. No. 8,629,177, the entirety of which is expressly incorporated by reference herein for all purposes) used by the OBB comprises a concentrically spherical particle (i.e., comprising a plurality of concentric spheres) having a first liquid core surrounded by a first shell, the first shell surrounded by a second liquid, the second liquid surrounded by a second shell. In some such embodiments, one or more additional, alternating liquid and shell layers are disposed about (and encompass) the second shell. Each liquid in the concentrically spherical particle can differ from other liquids thereof, and each shell of the concentrically spherical particle can have a predetermined thickness such that dissolution of each sequential layer (moving from the outermost shell toward the core), and corresponding release of an adjacent liquid layer, occurs at predetermined times.

In some embodiments, the OBB is configured to nano-encapsulate and/or micro-encapsulate one or more ingredients therewithin (i.e., within the OBB housing itself) prior to mixing in the microfluidic mixer chip. Additionally or alternatively, the OBB can be configured to nano-encapsulate and/or micro-encapsulate one or more mixed formulations therewithin after mixing the one or more mixed formulations in the microfluidic mixer chip, and prior to dispensing.

In some embodiments, any plant material that can be pulverized (or otherwise converted into a powdered form) can be nano-encapsulated or micro-encapsulated and processed by the OBB. Examples of such plant materials include any set forth herein, for example Echinacea, turmeric, tulsi, aloe vera, gotu kola, calendula, basil, thyme, rosemary, lavender, chamomile (e.g., German chamomile), fenugreek, sage, peppermint, lemon balm, globe artichoke, ashwangandha, lemon grass, bryophyllum, panfuti, rui, costus, khus, vitex negundo, sagargota, bonduc nut, stevia, marsh mallow, great burdock. Chinese yam, ginseng (e.g., Siberian ginseng), Great Yellow Gentian, sea buckthorn, tea tree, or any Ayurvedic medicinal plant.

In some embodiments in which encapsulated particle ingredients are used, the OBB can include one or more of the following, e.g., to maintain uniform distribution of the particles in the fluid: sonication, mechanical stirring, magnetic stirring, and agitation.

Depending upon the embodiment, a base oil or carrier oil can include a drug or non-drug broad leaf or narrow leaf botanical extract.

In some embodiments, small amounts of terpenes can be used as solubilizers in fluid formulations. Advantages of using natural materials (e.g., with medium-chain triglycerides (“MCTs”), for example) can include the ability to keep cannabinoids such as THCa and CBD dissolved in the carrier (e.g., MCT) and stable, without recrystallization of the THCa/CBD. Reducing or eliminating recrystallization results in a more stable, uniform final dispensed product.

In some embodiments, a fluid formulation comprises a eutectic mixture with a reduced melting point.

In some embodiments, fluids mixed by the OBB can include one or more nutrients, such that the dispensed, mixed formulations can be referred to as “nutraceuticals.”

In some embodiments, fluids mixed by the OBB and/or the dispensed, mixed formulations produced by the OBB include “microdoses” (also referred to as “sub-therapeutic” doses) of one or more substances, such as cannabinoids, terpenes, phenethylamines, tryptamines, dopamine receptor agonists and/or antagonists, dopamine receptor agonists and/or antagonists. GABA receptor agonists and/or antagonists, etc.

In some embodiments, the dispensing nozzle of the OBB includes a heated nozzle. For example, the dispensing nozzle (and, optionally, a coupler configured to mechanically couple the nozzle to the OBB) can comprise a thermally conductive material, such as stainless steel, to improve thermal transfer to the nozzle from other, heated portions of the OBB. In other implementations, the dispensing nozzle and/or the coupler can be directly heated by a dedicated local heater.

In some embodiments, a dispensing port/nozzle of the OBB is sealed (e.g., hermetically sealed) such that the dispensing fluidics form a closed system from which fluid cannot escape. In some such embodiments, dispensing of mixed fluids is accomplished due to pressurization (e.g., gas and/or mechanical) but is not accomplished due to gravity (i.e., no gravity-assist). For example, one or more cartridges can be configured to physically force a fluid contained therein to move into the mixer chip. In some such embodiments, a disc member, to separate fluid from gas, can be disposed inside one or more of the cartridges. In some sealed implementations, fluids can be mixed and dispensed regardless of the orientation of the OBB in three-dimensional space. This can facilitate the operation of the OBB in zero-gravity environments.

In some embodiments, the OBB includes a cleaning capability. For example, a flushing agent tank can be attached to the OBB such that the flushing agent tank and the mixing channels are in fluid communication with one another. During use, the flushing agent tank can be filled (e.g., by a user, or automatically through remote valve control, etc.) with a flushing agent such as ethanol (e.g., high-proof ethanol) and the flushing agent can be caused to move (e.g., via gravity, pressurization, or both) through the mixing channels, and the used flushing agent can be passed via the OBB to a waste tank that is also in fluid communication with the mixing channels, and/or can exit the OBB via the nozzle thereof.

In some embodiments, gasketing materials used in the OBB can include Viton (e.g., 70 Shore A durometer Viton). The gasket can have a flat sheet configuration with perforations and/or openings at a plurality of locations on the gasket that, when in use, correspond to and substantially align with, or are substantially centered on, each of a plurality of nozzle interfaces of the OBB. For example, the perforations can comprise cross-shaped cuts (e.g., 0.3″×0.3″) that create normally-closed valves that open when pressure is applied to the fluid in the tanks/reservoirs.

In some embodiments, the OBB and/or one or more of a web-based OBB software application, a mobile OBB software application, or a cloud-based OBB software application is configured to access, compile and/or analyze external data from one or more sources of clinical trial data, published studies, pain treatment center data (e.g., provided by volunteer patients), plant strain data, user-provided data, other user data, and/or the like, so as to generate suggested formulations for a given user and/or user condition/symptom that are “predicted” to have a substantially high likelihood of efficacy. This source data can be qualitative and/or quantitative, and can have a variety of precision levels, ranging from binary (e.g., good/bad; [symbol] / [symbol] ; etc.) to the highest-precision decimal data (e.g., out to as many as 38 decimal places). Source data formats can include categorical, ordinal, binomial, count (i.e., nonnegative integers), nominal, numeric, discrete, and/or continuous data. The accessing, compiling and/or analysis can be performed individually by, or through cooperation among, any of the following: the OBB itself, a web app, a mobile/smart-phone app, and one or more remote servers. In some such embodiments, suggested formulations are obtained through cloud computing and/or crowd-sourcing. Alternatively or in addition, machine learning (i.e., artificial intelligence, “AI”) is applied to one or more datasets that may evolve over time, to determine suggested formulation options for a given user and/or user symptom. Suggested formulations can be stored as “profiles” in the app and/or the OBB itself and presented to a user, for example via a user interface (“UI”). The computation or determination of suggested profiles is also referred to herein as “precision medicine.” In some example implementations, source data includes prescription information (e.g., historical information). In other example implementations, prescription information is not included, since user compliance can skew the data. In some example implementations, the OBB is configured to electrically, and optionally mechanically, connect with a “smart” vape pen. The smart vape pen includes a local memory, and the OBB is configured to read data (e.g., historical usage data) from the smart vape pen. Data obtained by the OBB from the smart vape pen can be incorporated with other source data discussed above for the purpose of determining the suggested formulations.

In some embodiments, the OBB (e.g., via a web or smart-phone app) collects data about what is being dispensed by two or more networked OBBs, self-assessments of the users, self-reported or device-reported usage date, demographic information and/or psychographic data about the user base. Correlations can be derived from such data over time, and incorporated into a model for predictive matching of blends and derivatives of blends for specific uses and/or for specific types of individuals. User feedback can be obtained by the OBB, for example, via responses to therapy-specific questions or surveys (e.g., based on standardized assessments) provided to the user based on the context of the formulation(s) that the user is dispensing. For example, if the user is dispensing a recipe for treatment of PTSD-related symptoms, a CAP standard survey or derivative thereof can be presented to the user so that he/she can provide a gauge of the relative benefit and improvement over time of the recipe being used.

In some embodiments, a web or smart-phone app for the users of the OBB is configured to adjust a recipe (e.g., corresponding to a data model) and, optionally, a user interface of the app, based on the desired end use vehicle (e.g., edible, topical, etc.). For example, long chain triglycerides and lipids can be used as excipients for active ingredients in hand creams and edibles, but are not appropriate for vaping or otherwise inhaling. Limitations on and/or adjustments to recipes can be based on a type of dispense kit that that is being used by the OBB at the time of dispensing.

In some embodiments, a web or smart-phone app for the users of the OBB is configured to track dosages (e.g., at microdose levels or higher) and, based on feedback received at the OBB and/or the app by the user, incrementally adjust the dosage until just above the level at which the desired therapeutic effect is not detectable to the user (i.e., the “sub-perceptual” dosage amount). Adjustments to dosages can be made autonomously by the OBB and/or based on inputs from a user, and can be referred to as “self-titration” (e.g., up-titration or down-titration). In some embodiments, the OBB is configured (e.g., via a software-supported process) to dispense very small, “sub-therapeutic” amounts of one or more substances. In some implementations, such microdosing can utilize labeled (e.g., isotope-labeled) compounds for purposes of clinical trials, etc. In some implementations, microdosing can include components or ingredients that have an effect at extremely small amounts (in some instances, sub-threshold amounts), and utilize serotonin receptor agonists, e.g., 5-HT1 receptor agonists (5-HTA-5-HT1F receptor agonists), 5-HT2A receptor agonists, 5-HT2B receptor agonists 5-HT2c receptor agonists, 5-HT3 receptor agonists, 5-HT4 receptor agonists, 5-HT5A receptor agonists, 5-HT6 receptor agonists, and/or the like; and/or nootropic, psychoactive, and/or psychedelic substances, e.g.: racetams such as piracetam, oxiracetam, and/or aniracetam; salvinorin A; cannabinoids, such as THC, CBG, CBN, etc.; tryptamines such as lysergic acid diethylamide, N,N-dimethyltryptamine, psilocybin, psilocin, etc.; phenethylamine such as mescaline, 1-(2,5-Dimethoxy-4-methylphenyl)-2-aminopropane, (RS)-1-(1,3-benzodioxol-5-yl)-N-methylpropan-2-amine, 1-(2H-1,3-Benzodioxol-5-yl)propan-2-amine, 2-(3,4,5-trimethoxyphenyl)ethanamine, etc.; and/or the like, such that an authorized adult user can receive the beneficial effects thereof without the inconvenient effects of experiencing the “high” that some can induce.

In some embodiments, a heater of the OBB is configured, at least in part, to increase a concentration of cannabinoids, terpenes, and/or flavonoids of a liquid ingredient, for example by driving off a portion of one or more volatile components thereof.

In some embodiments, the OBB includes one or more magnets and/or one or more magnetic fixtures, seals, or locks, configured to mate with a mixer chip, mixing kit, and/or dispense kit received thereon or therein.

In some embodiments, a microfluidic mixer chip assembly comprises four parts (for example as shown and described above with reference to FIG. 10), including a mixer chip top, a mixer chip via layer, a mixer chip membrane, and a mixer chip bottom. The mixer chip via layer and the mixer chip membrane can be thermally bonded to one another using a combination of pressure and temperature to form an intermediate assembly. The mixer chip top and/or the mixer chip bottom can then be bonded to the thermally bonded layers of the intermediate assembly using an adhesive (e.g., any adhesive set forth herein).

In some embodiments, a comprises four parts, including a fluid channel layer, a mixer chip via layer, a mixer chip membrane layer, and an air channels layer. The assembly of the four parts of the microfluidic mixer chip assembly can be performed as follows: (1) the mixer chip via layer and the fluid channel layer are thermally bonded to one another; (2) the mixer chip membrane layer is thermally bonded to the mixer chip via layer; (3) pressure-sensitive adhesive is applied to the mixer chip membrane layer; and (4) the air channels layer is placed onto the pressure-sensitive adhesive. In some such implementations, the pressure-sensitive adhesive is not exposed to any terpenes during use, and/or is only in contact with substantially inert substances (e.g., air). Advantages of this type of assembly approach can include eliminating the need to thermally bond the air channels layer, which in some embodiments is thicker than other layers of the microfluidic mixer chip assembly.

In some embodiments, the microfluidic mixer chip includes two or more sub-chips where a first sub-chip is designed to process a first fluid (e.g., a terpene) or set of fluids and a second sub-chip is designed/configured to separately process a second fluid (e.g., a cannabinoid) or set of fluids (i.e., that may have different properties from the first fluid or first set of fluids). The first and second sub-chips can be comprised of different materials, for compatibility with their respective fluids/set of fluids. In some implementations, a first sub-chip and second sub-chip are not in fluid communication with one another, while in some embodiments a first sub-chip and a second sub-chip can be configured to have limited fluid communication.

In some embodiments, the OBB comprises two microfluidic mixer chips, at least one of the two microfluidic mixer chips including a reaction chamber configured to receive more than one fluid, the more than one liquid including a reactant.

In some embodiments, a microfluidic mixer chip includes at least two sub-chips, at least one of the two sub-chips including a reaction chamber configured to receive more than one fluid, the more than one liquid including a reactant.

In some embodiments, the microfluidic mixer chip comprises, consists of, or consists essentially of, Nylon (e.g., injection-molded Nylon). In other embodiments, the microfluidic mixer chip comprises, consists of, or consists essentially of, FEP (e.g., thermally bonded FEP). During chip fabrication, Nylon and FEP can be mechanically machined and/or lasered out to create the microfluidic channels.

In some embodiments, one or more adhesives used in the assembly and bonding of layers of the OBB is a pressure-sensitive adhesive (“PSA”).

In some embodiments, a power port of the OBB is disposed within the dispensing window of the OBB. The power port can include, for example, SPI and/or I2C interfaces configured to communicate with an accessory when the accessory is disposed within (e.g., mechanically and/or electrically coupled to) the port. In some implementations, the power port provides functionality for control over one or more of: temperature, mixing parameters, detection of an accessory connection event, measuring a power level of the accessory, and powering the accessory. In addition or alternatively, the OBB can be wirelessly powered and/or charged.

In some embodiments, the microfluidic mixing chip is designed to reduce or eliminate the occurrence of occlusions (i.e., accumulation of compounds) within the microfluidic channels thereof. For example,

In some embodiments, valve actuation in the OBB is piston-driven (e.g., via one or more solenoid pistons) instead of pressure-driven, for example to increase operational life and/or to reduce valve leakage that may be caused by membrane deformation. Implementations of such embodiments can exclude the rigid air channel layer from the mixing chip assembly, such that a piston of a solenoid (disposed, for example, at each gasket perforation (e.g., the plurality of cross-shaped cuts)) is configured to compress the valve membrane upward against the via layer.

FIG. 30D illustrates an example edit/create blend recipe flow for an OBB interface according to some embodiments, FIG. 30E illustrates an example recipe/recipe collection overview for an OBB interface according to some embodiments, and FIG. 30F illustrates an example user profile and history overview for an OBB interface according to some embodiments: such embodiments may be provided on a web app, device app, and/or mobile application (e.g., executed on a smart phone or tablet). FIG. 30G provides an example OBB mobile application architecture, according to some embodiments. FIGS. 30H-30V provide example user interfaces for an OBB mobile application according to some embodiments where an OBB is configured for communication with a mobile device, the mobile device OBB application configured to allow a user to sign-in, validate, and verify, their identity and/or qualifying trait (e.g., age to access a substance or substances that have prohibitions against use by minors, such that the OBB can assure compliance with applicable regulations and/or laws). FIG. 30W provides examples of blends/recipes that the OBB produces, according to some implementations.

FIG. 31 provides a flow chart illustrating an example OBB start sequence, according to some embodiments. Here, when power is applied to the OBB 3101a (e.g., turned on), the OBB performs a peripheral self-check 3102a (see also FIG. 31A for additional detail), and if 3103a not passed, the system stops 3104a, but if 3103a passed, OBB performs a pre-mix self-test 3105a (see also FIG. 31B for additional detail), and if 3106a not passed, the system stops 3107a, but if 3106a passed, the system is determined to be ready 3108a.

FIG. 31A provides a flow chart illustrating an example OBB peripheral self-test, according to some embodiments. At start 3110a, thermistors 3111a, pressure sensors 3112a, and supply voltages 3113a are checked to determine if they are in range, and the presence of a flash memory chip or the like 3114a and IO expanders 3115a are determined. If 3116a not all self-tests are passed, the system is stopped 3117a (and an alert or other noticed issued and/or recorded), while if 3116a all self-tests are passed, the system is determined to be read, at least for peripherals.

FIG. 31B provides a flow chart illustrating an example OBB pre-mix self-test, according to some embodiments. The test starts 3120a and attached canisters/vials are pressurized 3121a, valve sections are pressurized 3122a, and leak rate determined for each over time. The system is then depressurized 3123a, all valve controls are actuated to make sure switching circuitry reports no errors 3124a, and the recipe is iterated through to ensure a canister is present for each position used in the recipe 3125a. The system is either stopped 3127a or deemed ready 3128a depending on whether all pre-mix self-test items were passed 3126a.

FIG. 31C provides a flow chart illustrating example OBB mix state processes, according to some embodiments. As shown, a mix command is received 3130a (e.g., from an app on a mobile device), and system is confirmed to be ready 3131a, recipe verified 3132a, pre-mix self-test is performed (as discussed above with respect to FIG. 31B), and if all test ok 3134a, the heater control is activated and unit gets to mix temperature 3136a, after which mix control activities are performed until completed 3137a (see FIG. 31D for additional detail), after which system flush procedure is performed 3138a, and the system is ready again 3139a.

FIG. 31D provides a flow chart illustrating example OBB mix state control, according to some embodiments. The recipe point fetched from flash 3140a, pressure regulation is executed to achieve recipe pressure command point 3141a, temperature regulation is executed 3142a, and once the recipe command point pressure is achieved 3142a, process recipe point (e.g., valve state commands) 3144a, and as long as there are no errors present 3145a, the next recipe point is fetched from flash 3147a.

FIG. 31E and FIG. 31F provide a flow chart illustrating example OBB tablet/smart phone application processes, according to some embodiments. As shown, a user can select a blend recipe using an app on their smart phone or tablet 3150a, and if necessary, the app obtains the recipe from the server 3151a, analyzes the recipe for necessary ingredients and volumes/amounts 3152a, queries the OBB to get serial numbers or other identifiers of installed canisters 3153a, and can issue queries to determine fluid amounts of the installed canisters 3154a. In some embodiments, the OBB is configured to track volume levels of individual canisters to assure proper amounts. Additionally, security can be implemented around canisters such that the amount is tracked universally, including authorized refills, and thereby track unauthorized refills or counterfeits and thereby promote consumer/user safety and security (e.g., in such embodiments, only authorized canisters could be utilized in the OBB). If the correct fluids are available/installed 3155a, the mobile app transcodes recipe to indicate which fluids are in which canisters 3157a, and queries OBB to determine which recipes are in onboard memory 3158a. If the recipe is not currently on the OBB 3159a, the app downloads the recipe to the OBB 3160a (e.g., via BLUETOOTH low energy or the like). Then the app sends the OBB a start-mix command 3161a, and polls the OBB for mix status 3162a, and when complete 3163a, notifies the user 3165a. By having a mobile OBB app performing a number of the calculations and analysis for blending, the OBB system can enhance security, reduce OBB processing time, and better address errors or complications (e.g., if a particular ingredient is low or not available/present at the OBB, the mobile app can suggest alternative mixtures, reorder the ingredient, etc.).

FIG. 32 illustrates an example OBB microfluidic mixer chip for some embodiments according to the disclosure.

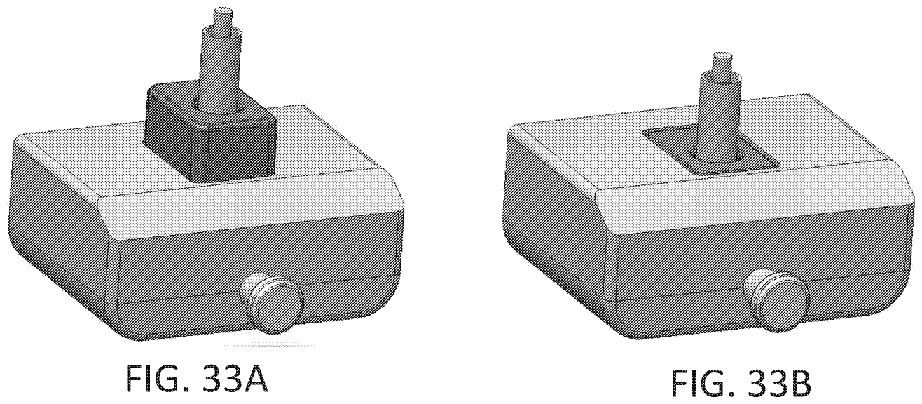

In some embodiments, the OBB includes a vape cartridge tray. The vape cartridge tray can include a mechanical actuator (e.g., a knob) configured to rotate/turn (for example, about 90°), such that a cam mechanically coupled thereto contacts and applies force to a bottom of the vape cartridge holder so as to advance/raise it to a predetermined height. In some implementations, the height corresponds to a specified vape cartridge size. In some embodiments, the predetermined height is adjustable (e.g., by a user and/or via the OBB itself or a mobile app in communication therewith). FIGS. 33a and 33b show renderings of an example vape cartridge try in raised and lowered configurations, respectively.

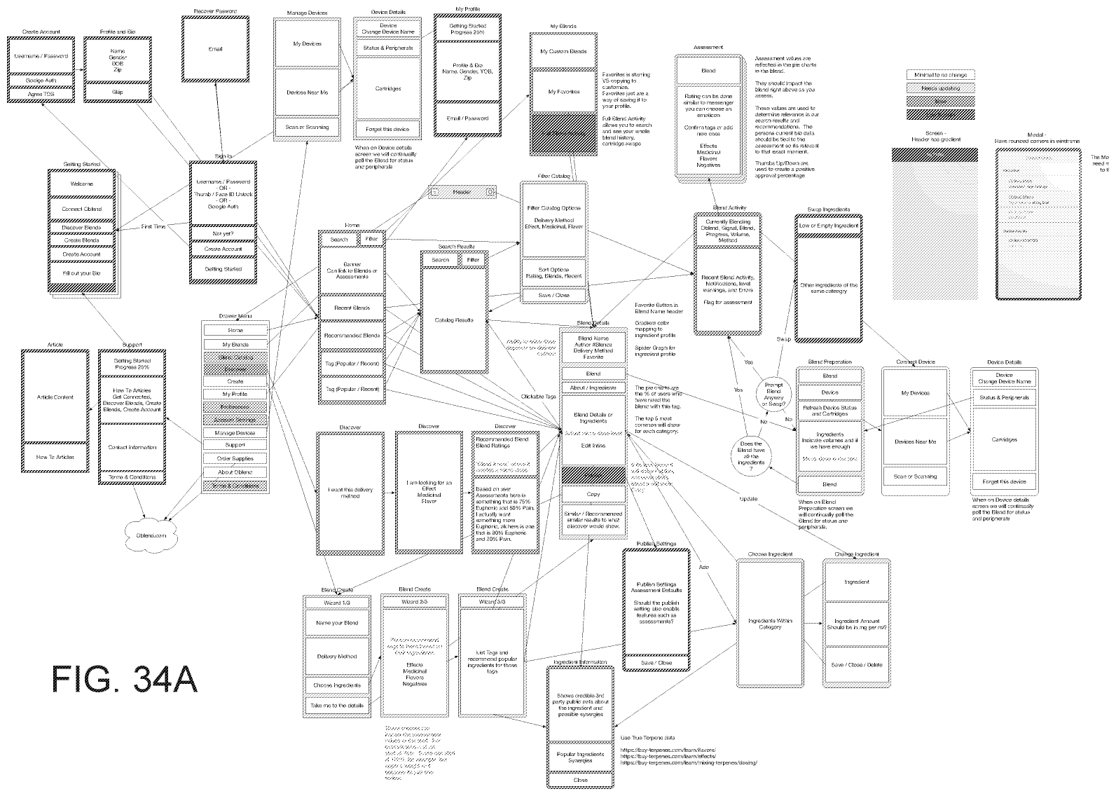

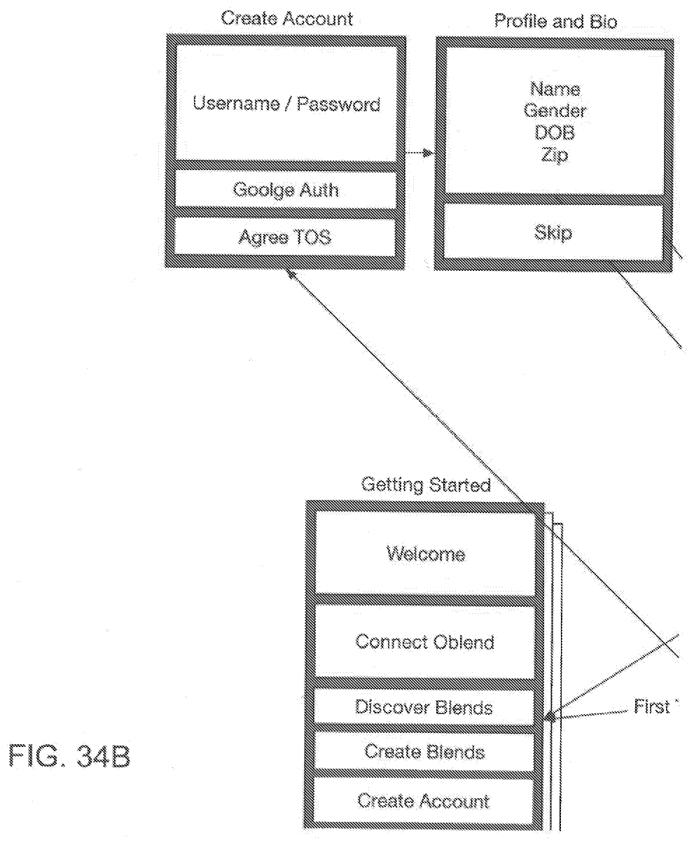

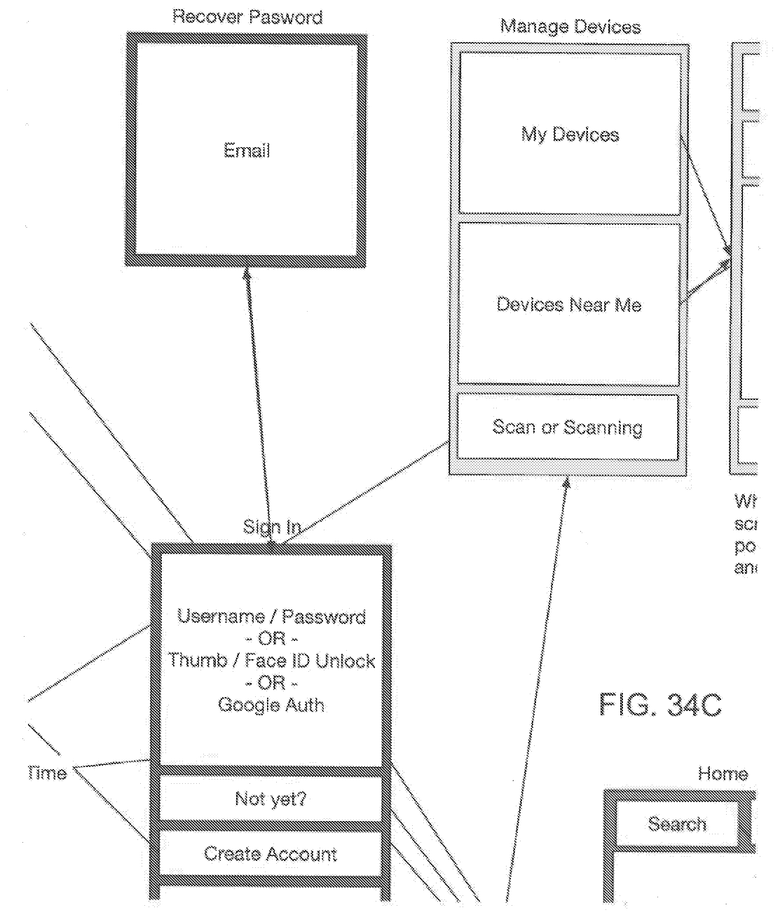

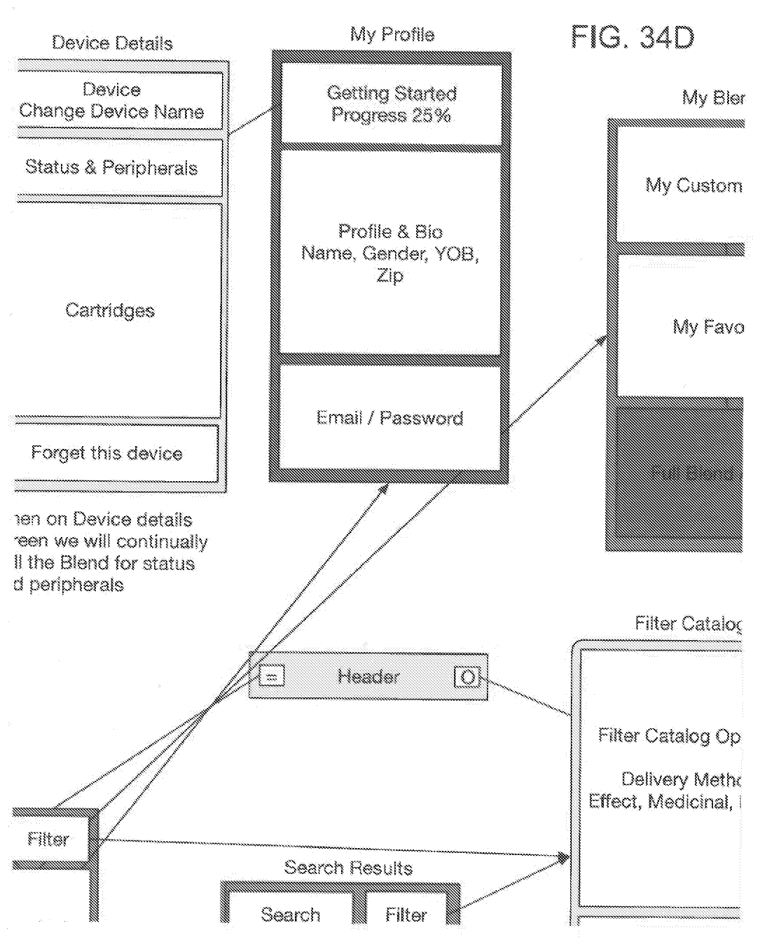

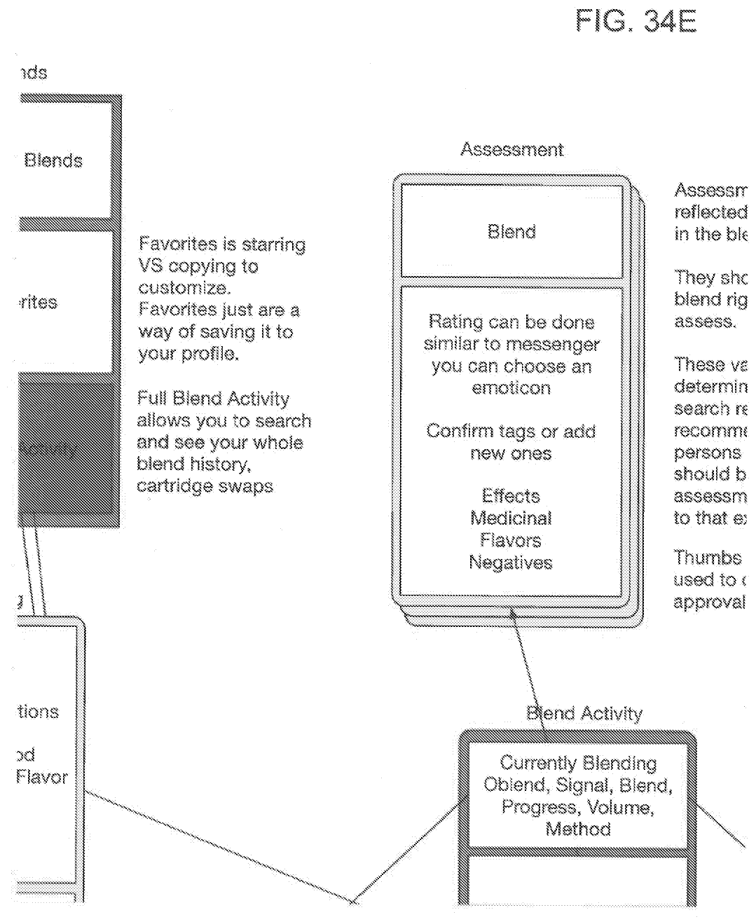

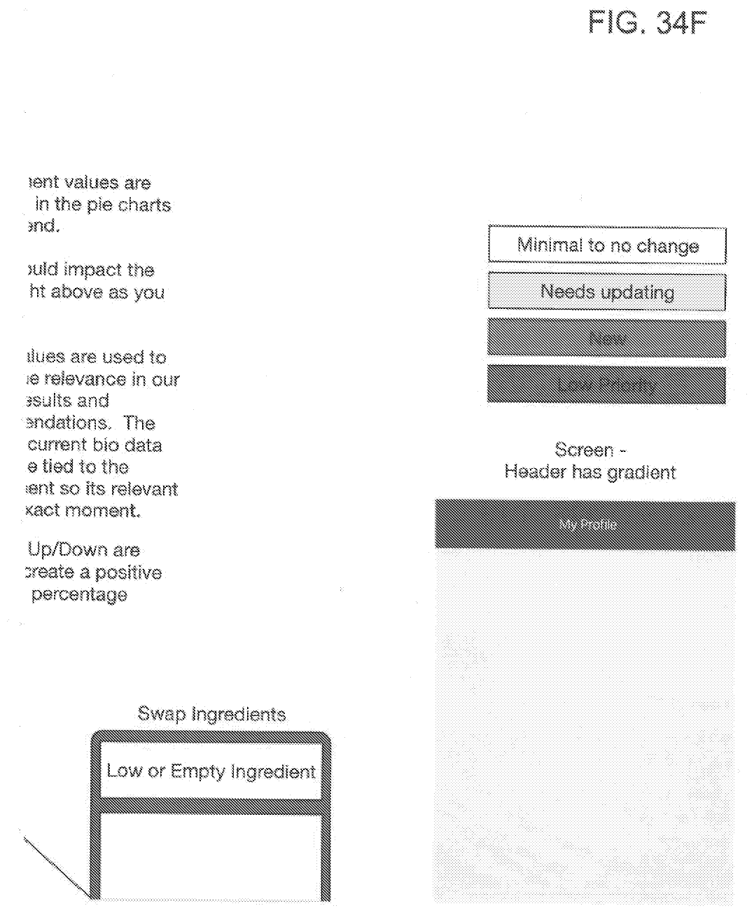

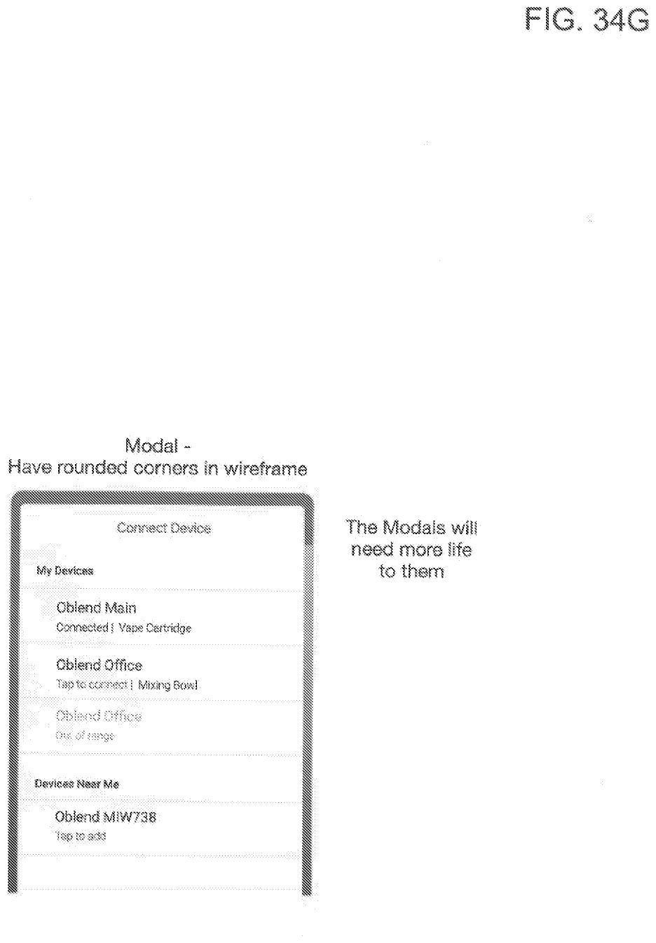

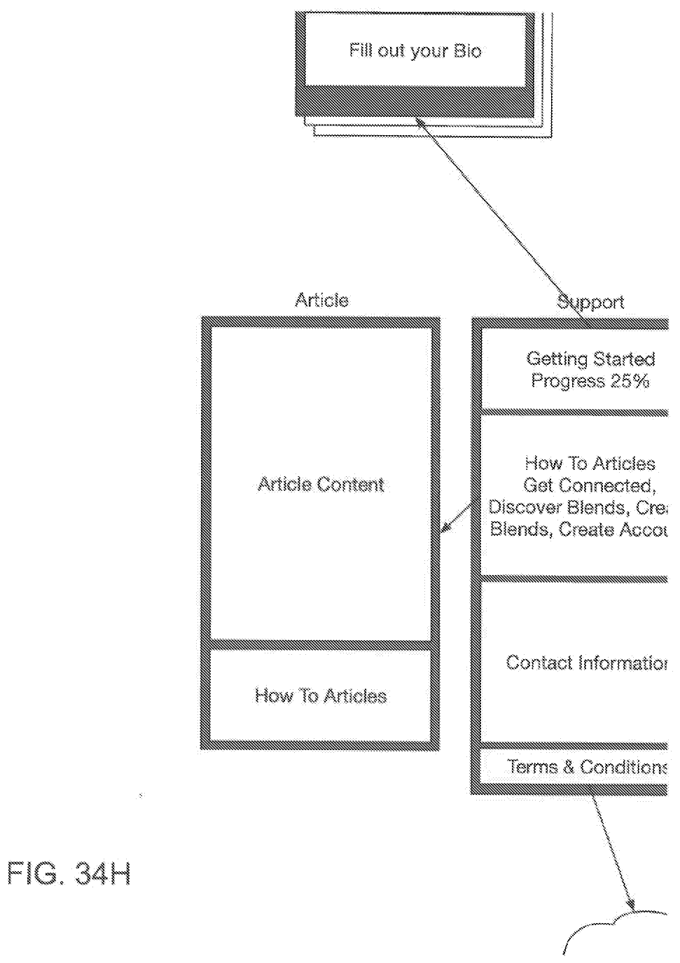

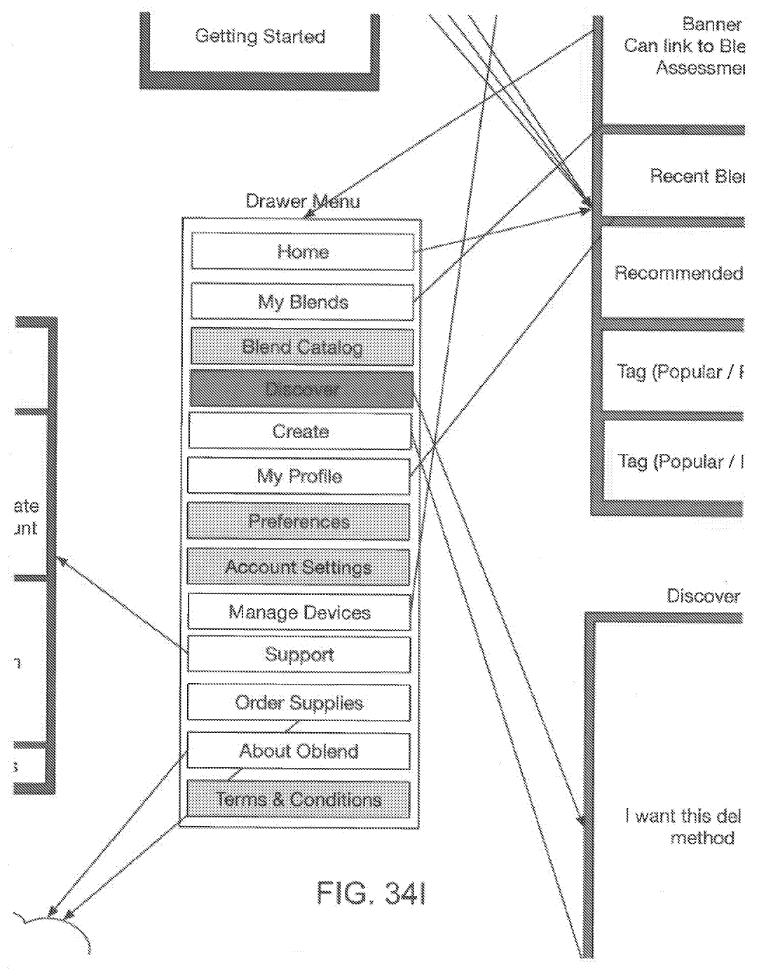

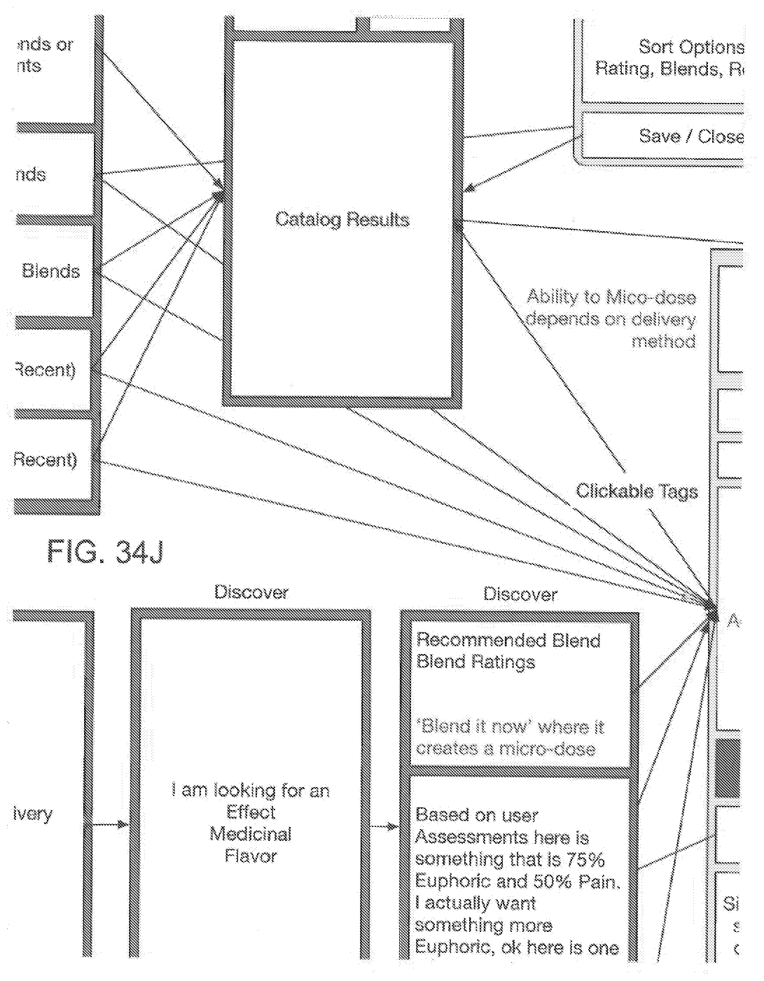

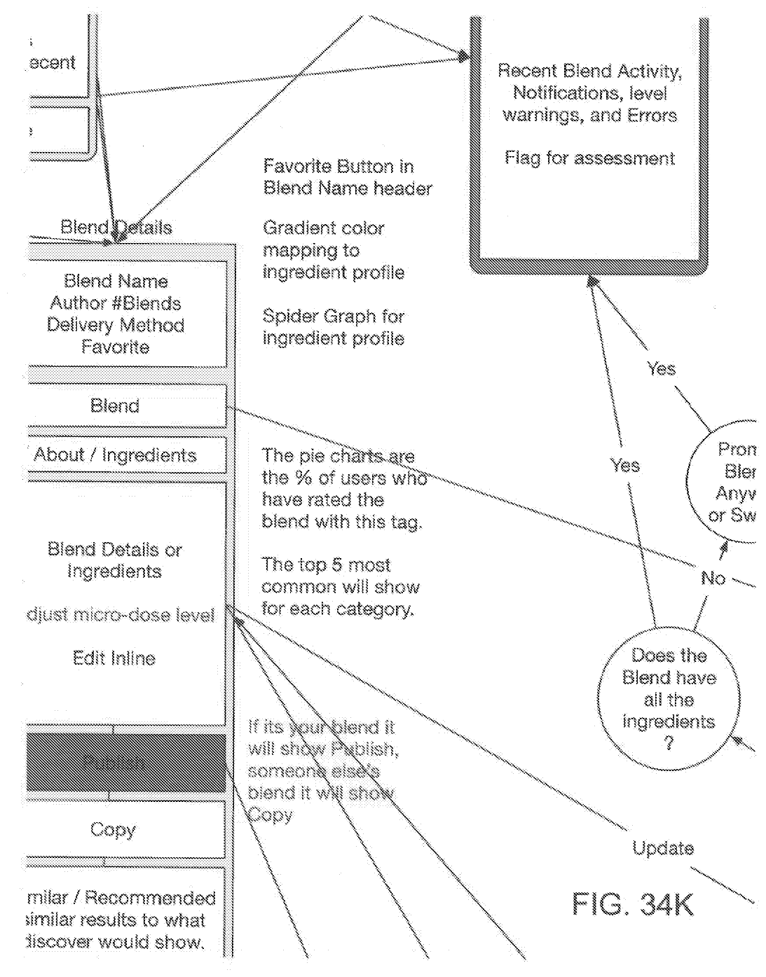

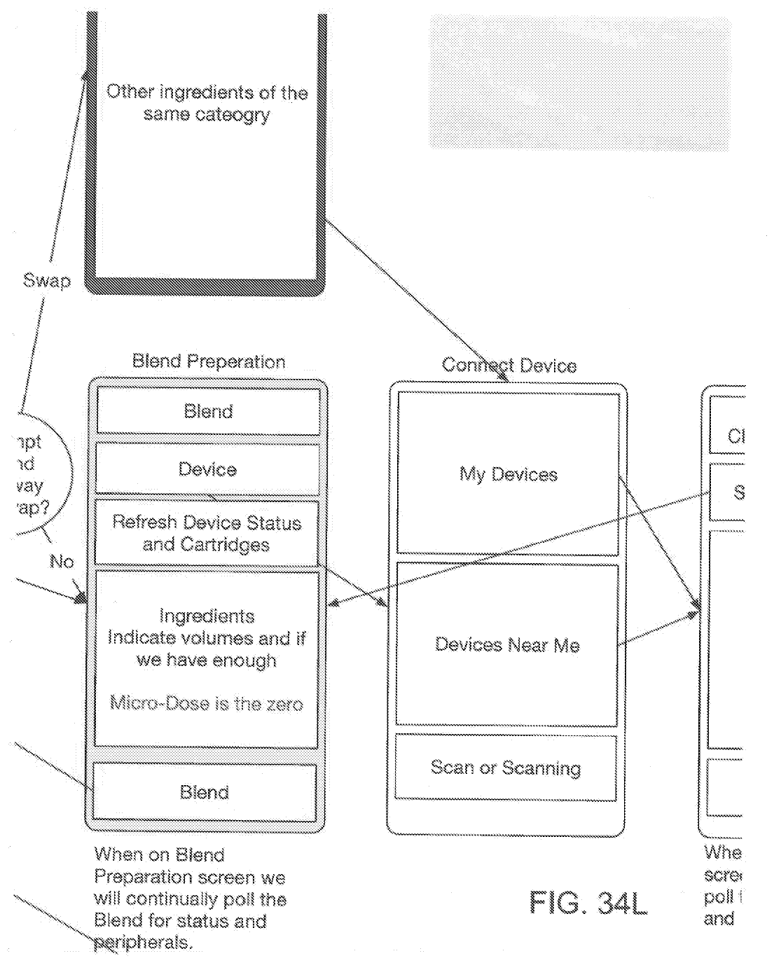

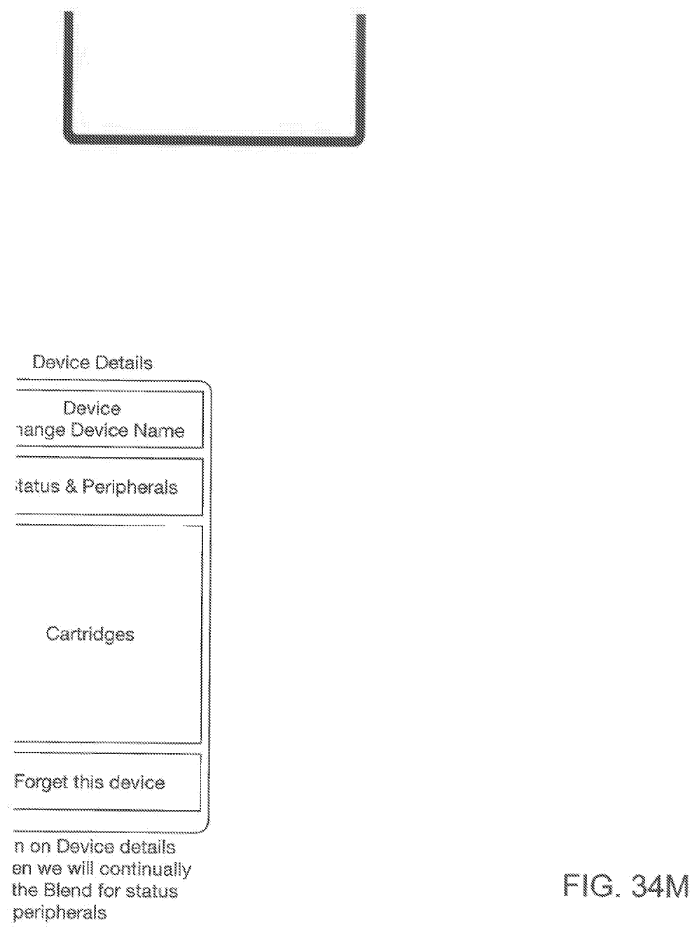

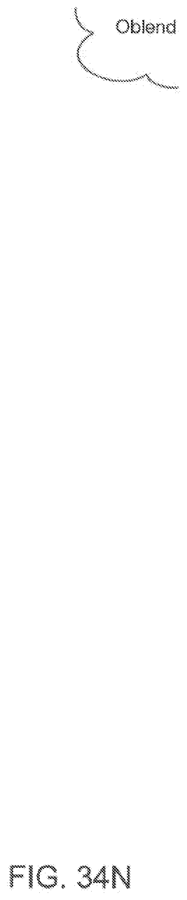

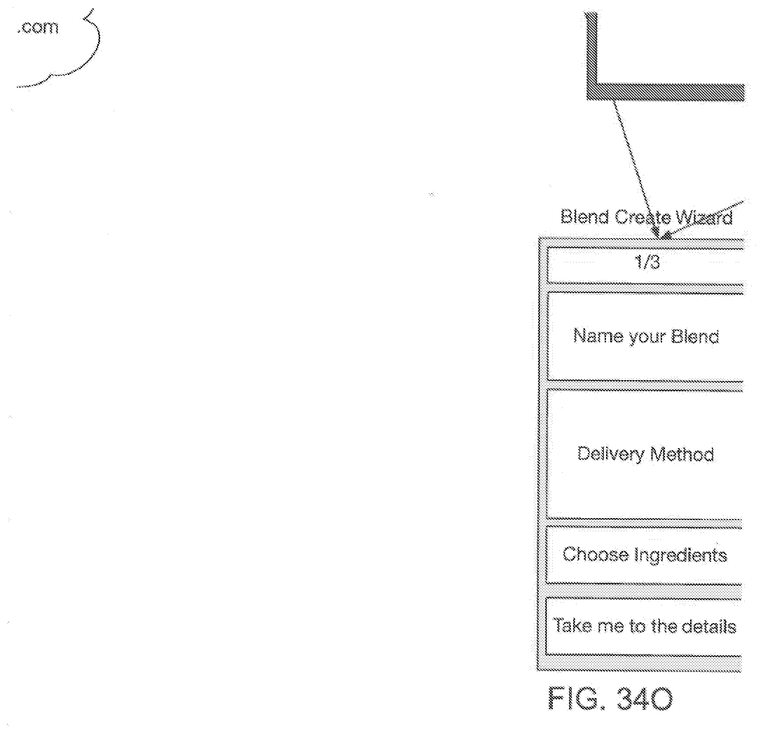

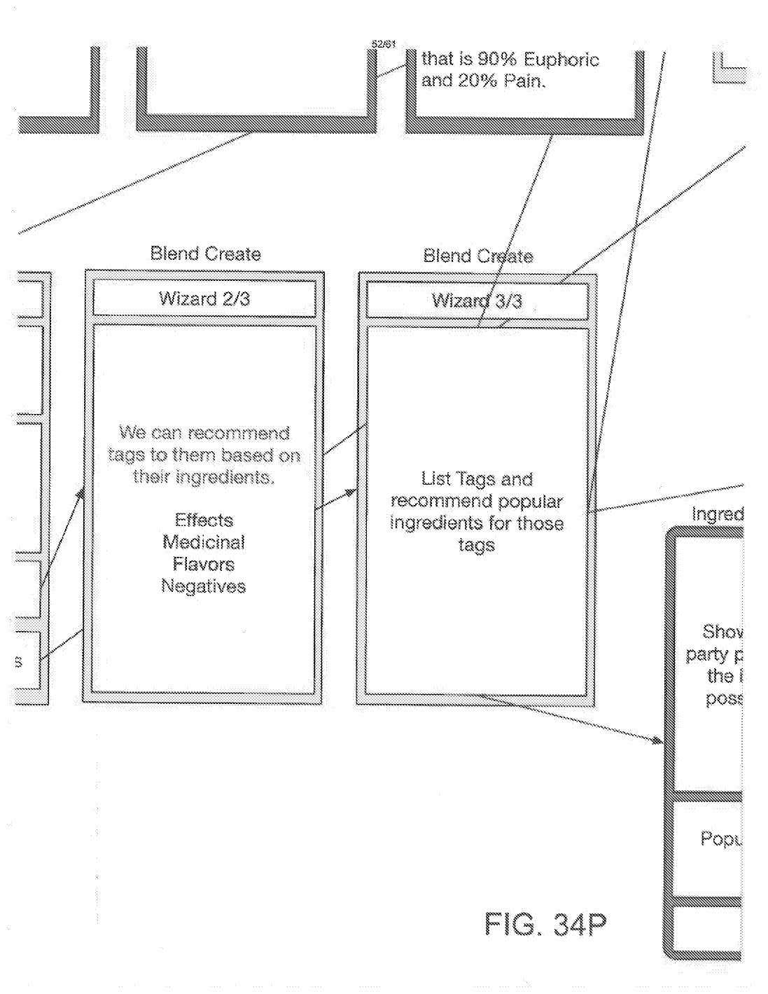

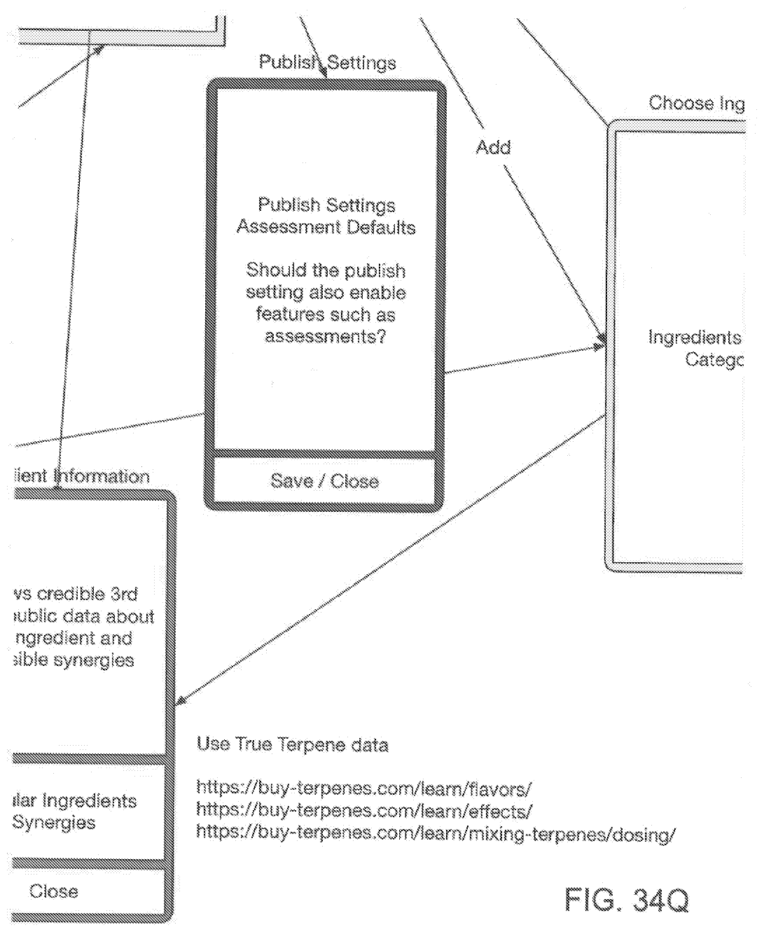

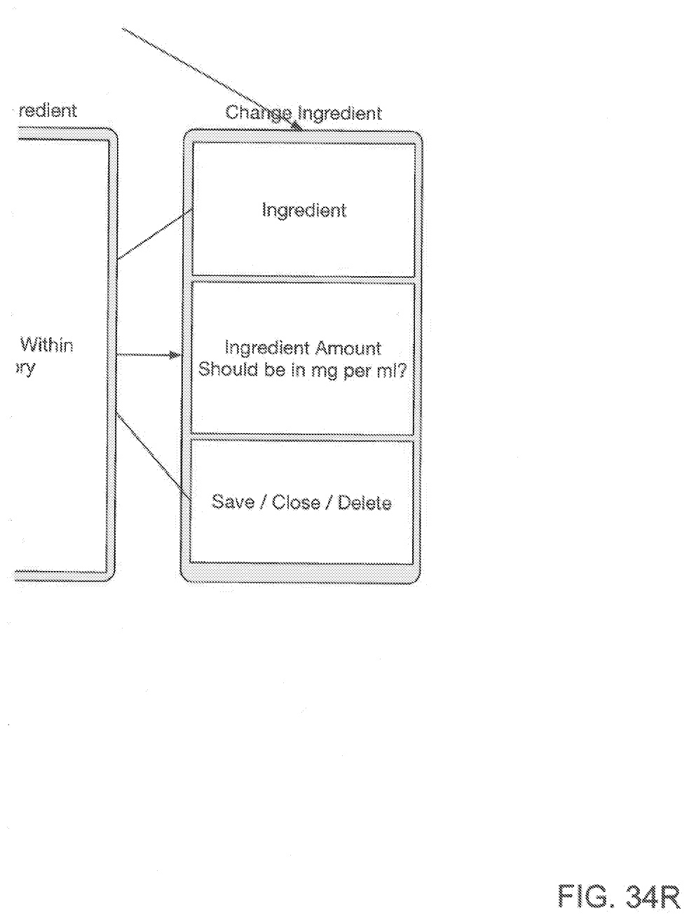

FIG. 34A is a global view of a wireframe schematic showing elements of an application interface, and FIGS. 34B-34R are zoomed-in views of the constituent regions of the schematic of FIG. 34A.

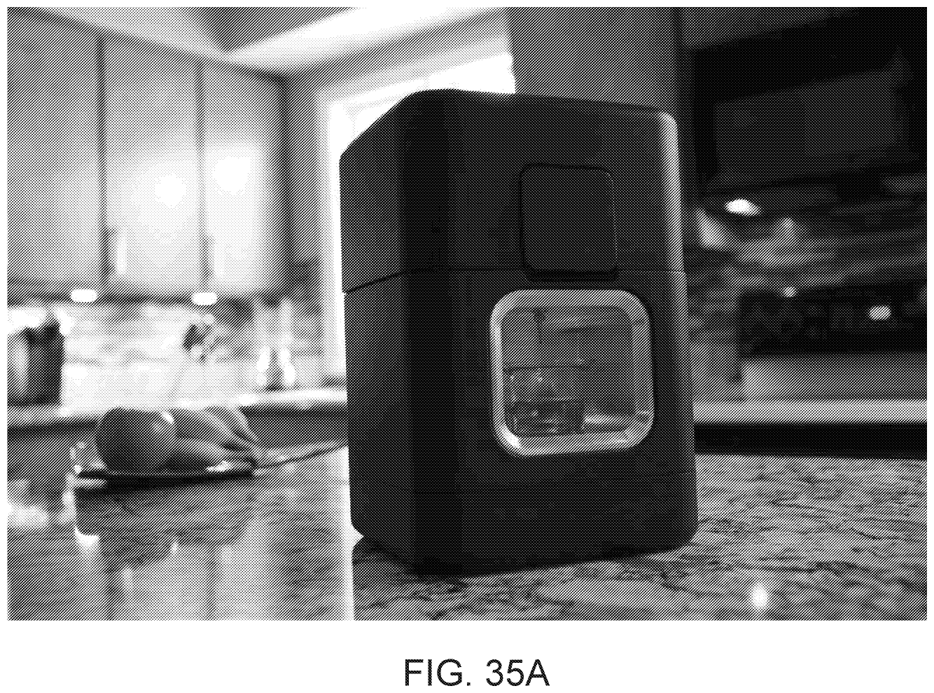

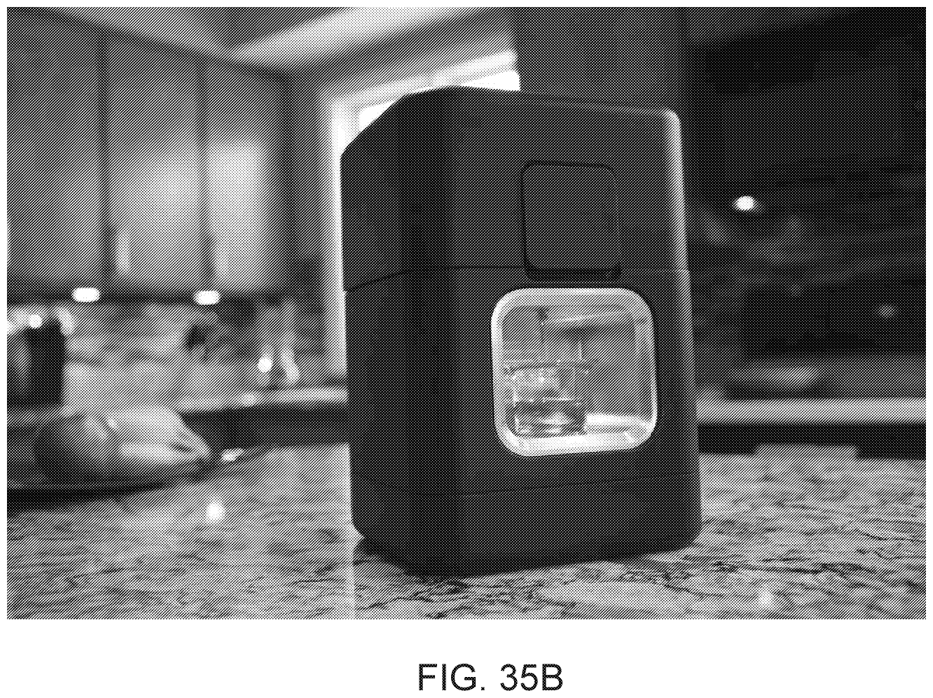

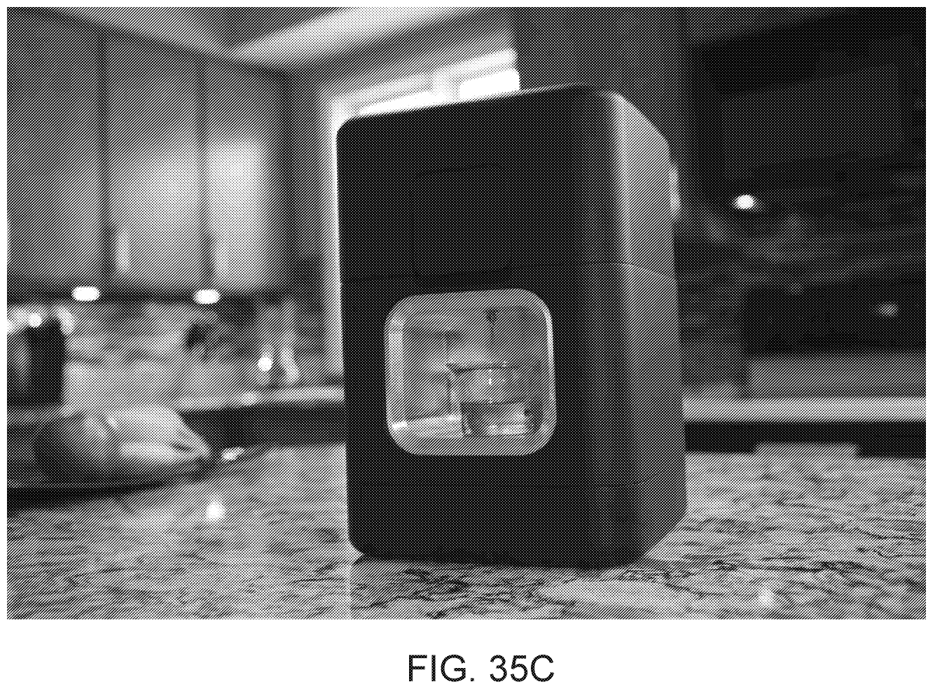

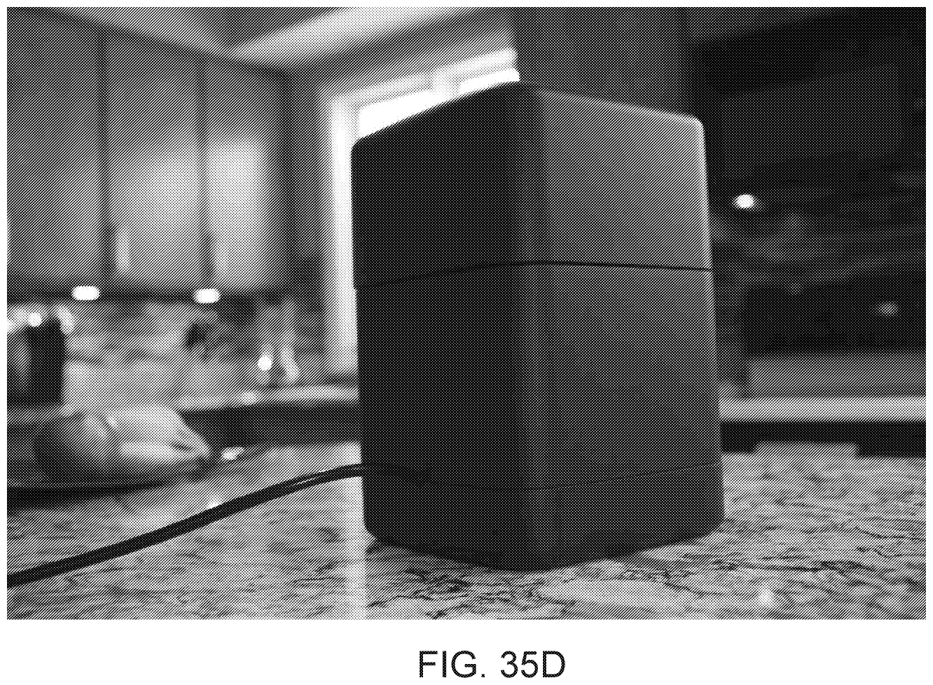

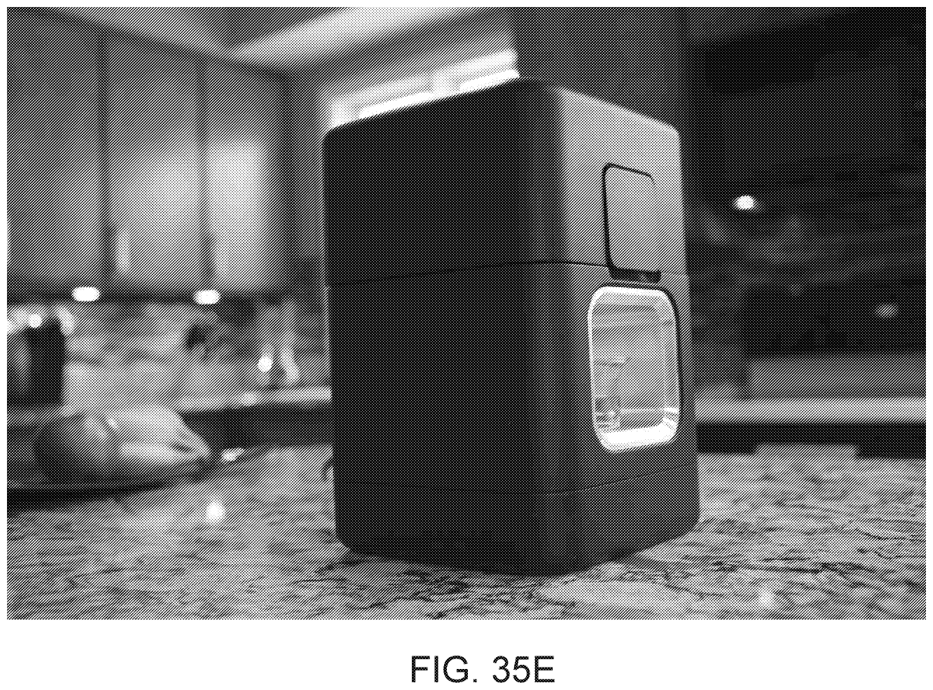

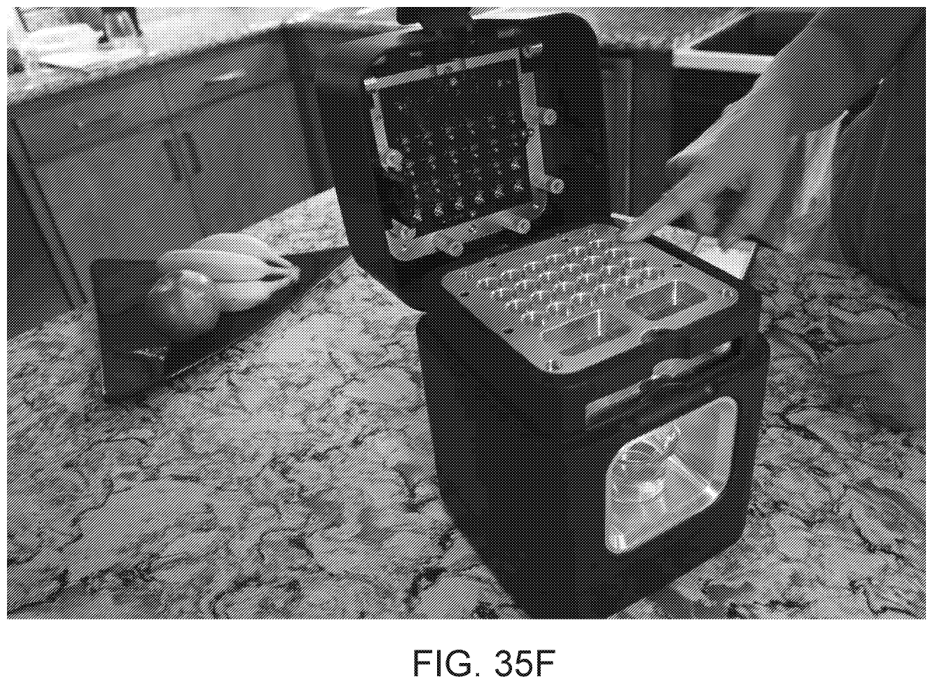

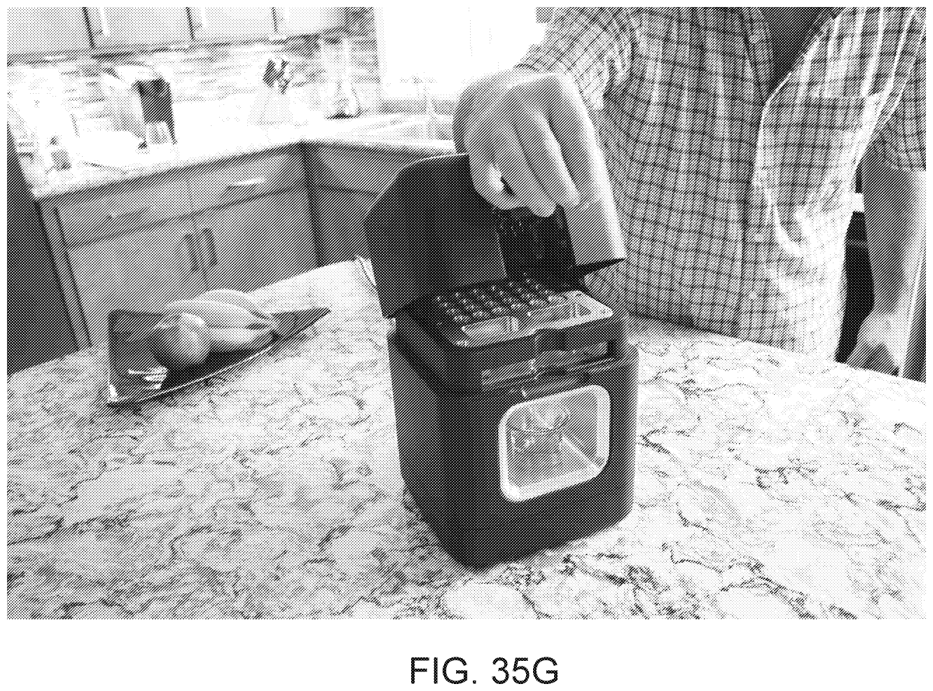

FIGS. 35A-35G are photographic images of an implementation of an embodiment of the OBB, during use.

As discussed herein, the OBB can be configured to formulate a variety of blends and/or compositions. For example, the OBB can be configured to blend compositions comprising, consisting of, and/or consisting essentially of at least one first purified cannabinoid and at least one of a second purified cannabinoid, a purified terpene, a purified flavonoid, and/or a purified mineral. In some embodiments, the OBB is configured to blend one or more of 7,8-dihydroionone, Acetanisole, Acetic Acid, Acetyl Cedrene, Anethole, Anisole, Benzaldehyde. Bergamotene (α-cis-Bergamotene) (α-trans-Bergamotene), Bisabolol (P-Bisabolol), Borneol, Butanoic/Butyric Acid, Cadinene (α-Cadinene) (γ-Cadinene), Cafestol, Caffeic acid, Camphene, Camphor, Capsaicin, Carene (Δ-3-Carene), Carotene, Carvacrol, Carvone, Dextro-Carvone, Laevo-Carvone, Caryphyllene (β-Caryophyllene), Caryophyllene oxide, Castoreum Absolute, Cedrene (α-Cedrene) (β-Cedrene), Cedrene Epoxide (α-Cedrene Epoxide), Cedrol, Cembrene, Chlorogenic Acid, Cinnamaldehyde (α-amyl-Cinnamaldehyde) (α-hexyl-Cinnamaldehyde), Cinnamic Acid, Cinnamyl Alcohol, Citronellal, Citronellol, Cryptone, Curcumene (α-Curcumene) (γ-Curcumene), Decanal, Dehydrovomifoliol, Diallyl Disulfide, Dihydroactinidiolide, Dimethyl Disulfide, Eicosane/Icosane, Elemene (β-Elemene), Estragole, Ethyl acetate, Ethyl Cinnamate, Ethyl maltol, Eucalyptol/1,8-Cineole, Eudesmol (α-Eudesmol) (α-Eudesmol) (γ-Eudesmol), Eugenol, Euphol, Farnesene, Farnesol, Fenchol (β-Fenchol), Fenchone, Geraniol, Geranyl acetate, Germacrenes, Germacrene B, Guaia-1(10), 11-diene, Guaiacol, Guaiene (α-Guaiene), Gurjunene (α-Gurjunene), Herniarin, Hexanaldehyde, Hexanoic Acid, Humulene (α-Humulene) (β-Humulene), Ionol (3-oxo-α-ionol) (β-Ionol), Ionone (α-Ionone) (β-Ionone), Ipsdienol, Isoamyl acetate, Isoamyl Alcohol, Isoamyl Formate, Isoborneol, Isomyrcenol, Isopulegol, Isovaleric Acid, Isoprene, Kahweol, Lavandulol, Limonene, γ-Linolenic Acid, Linalool, Longifolene, α-Longipinene, Lycopene, Menthol, Methyl butyrate, 3-Mercapto-2-Methylpentanal, Mercaptan/Thiols, β-Mercaptoethanol, Mercaptoacetic Acid, Allyl Mercaptan, Benzyl Mercaptan, Butyl Mercaptan, Ethyl Mercaptan, Methyl Mercaptan, Furfuryl Mercaptan, Ethylene Mercaptan, Propyl Mercaptan, Thenyl Mercaptan, Methyl Salicylate, Methylbutenol, Methyl-2-Methylvalerate, Methyl Thiobutyrate, Myrcene (β-Myrcene), γ-Muurolene, Nepetalactone, Nerol, Nerolidol, Neryl acetate, Nonanaldehyde, Nonanoic Acid, Ocimene, Octanal, Octanoic Acid, β-cymene. Pentyl butyrate. Phellandrene, Phenylacetaldehyde, Phenylethanethiol, Phenylacetic Acid, Phytol, Pinene, β-Pinene, Propanethiol, Pristimerin, Pulegone, Retinol, Rutin, Sabinene, Sabinene Hydrate, cis-Sabinene Hydrate, trans-Sabinene Hydrate, Safranal, α-Selinene, α-Sinensal, β-Sinensal, β-Sitosterol, Squalene, Taxadiene, Terpin hydrate, Terpineol, Terpine-4-ol, α-Terpinene, γ-Terpinene, Terpinolene, Thiophenol, Thujone, Thymol, α-Tocopherol, Tonka Undecanone, Undecanal, Valeraldehyde/Pentanal, Verdoxan, α-Ylangene, Umbelliferone, and/or Vanillin.

In some embodiments, the OBB is configured to blend one or more of Cannabigerolic Acid (CBGA), Cannabigerolic Acid monomethylether (CBGAM), Cannabigerol (CBG), Cannabigerol monomethylether (CBGM), Cannabigerovarinic Acid (CBGVA), Cannabigerovarin (CBGV), Cannabichromenic Acid (CBCA), Cannabichromene (CBC), Cannabichromevarinic Acid (CBCVA), Cannabichromevarin (CBCV), Cannabidiolic Acid (CBDA), Cannabidiol (CBD), Cannabidiol monomethylether (CBDM), Cannabidiol-C4 (CBD-C4), Cannabidivarinic Acid (CBDVA), Cannabidivarin (CBDV), Cannabidiorcol (CBD-C1). Tetrahydrocannabinolic acid A (THCA-A), Tetrahydrocannabinolic acid B (THCA-B), Tetrahydrocannabinol (THC), Tetrahydrocannabinolic acid C4 (THCA-C4), Tetrahydrocannbinol C4 (THC-C4), Tetrahydrocannabivarinic acid (THCVA), Tetrahydrocannabivarin (THCV), Tetrahydrocannabiorcolic acid (THCA-C1), Tetrahydrocannabiorcol (THC-C1), Delta-7-cis-iso-tetrahydrocannabivarin, Δ8-tetrahydrocannabinolic acid (Δ8-THCA), Δ8-tetrahydrocannabinol (Δ8-THC), Cannabicyclolic acid (CBLA), Cannabicyclol (CBL), Cannabicyclovarin (CBLV), Cannabielsoic acid A (CBEA-A), Cannabielsoic acid B (CBEA-B), Cannabielsoin (CBE). Cannabinolic acid (CBNA). Cannabinol (CBN). Cannabinol methy)ether (CBNM), Cannabinol-C4 (CBN-C4), Cannabivarin (CBV), Cannabino-C2 (CBN-C2), Cannabiorcol (CBN-C1), Cannabinodiol (CBND), Cannabinodivarin (CBDV), Cannabitriol (CBT), 10-Ethoxy-9-hydroxy-Δ6a-tetrahydrocannabinol, 8,9-Dihydroxy-Δ6a(10a)-tetrahydrocannabinol (8,9-Di-OH-CBT-C5), Cannabitriolvarin (CBTV), Ethoxy-cannabitriolvarin (CBTVE), Dehydrocannabifuran (DCBF), Cannbifuran (CBF), Cannabichromanon (CBCN). Cannabicitran (CBT), 10-Oxo-Δ6a(10a)-tetrahydrocannabinol (OTHC), Δ9-cis-tetrahydrocannabinol (cis-THC), Cannabiripsol (CBR), 3,4,5,6-tetrahydro-7-hydroxy-alpha-alpha-2-trimethyl-9-n-propyl-2,6-methano-2H-1-benzoxocin-5-methanol (OH-iso-HHCV), Trihydroxy-delta-9-tetrahydrocannabinol (triOH-THC), Isocanabinoids, and/or Epigallocatechin gallate.

In some embodiments, the OBB is configured to blend one or more of Cannabigerolic Acid (CBGA), Cannabigerolic Acid monomethylether (CBGAM), Cannabigerol (CBG), Cannabigerol monomethylether (CBGM), Cannabigerovarinic Acid (CBGVA), Cannabigerovarin (CBGV), Cannabichromenic Acid (CBCA). Cannabichromene (CBC), Cannabichromevarinic Acid (CBCVA), Cannabichromevarin (CBCV), Cannabidiolic Acid (CBDA), Cannabidiol (CBD), Cannabidiol monomethylether (CBDM), Cannabidiol-C4 (CBD-C4), Cannabidivarinic Acid (CBDVA), Cannabidivarin (CBDV), Cannabidiorcol (CBD-C1), Tetrahydrocannabinolic acid A (THCA-A), Tetrahydrocannabinolic acid B (THCA-B), Tetrahydrocannabinol (THC). Tetrahydrocannabinolic acid C4 (THCA-C4), Tetrahydrocannbinol C4 (THC-C4), Tetrahydrocannabivarinic acid (THCVA), Tetrahydrocannabivarin (THCV), Tetrahydrocannabiorcolic acid (THCA-C1), Tetrahydrocannabiorcol (THC-C1), Delta-7-cis-iso-tetrahydrocannabivarin, Δ8-tetrahydrocannabinolic acid (Δ8-THCA), Δ8-tetrahydrocannabinol (Δ8-THC). Cannabicyclolic acid (CBLA). Cannabicyclol (CBL), Cannabicyclovarin (CBLV). Cannabielsoic acid A (CBEA-A), Cannabielsoic acid B (CBEA-B), Cannabielsoin (CBE), Cannabinolic acid (CBNA), Cannabinol (CBN), Cannabinol methylether (CBNM), Cannabinol-C4 (CBN-C4), Cannabivarin (CBV), Cannabino-C2 (CBN-C2), Cannabiorcol (CBN-C1), Cannabinodiol (CBND), Cannabinodivarin (CBDV), Cannabitriol (CBT), 10-Ethoxy-9-hydroxy-Δ6a-tetrahydrocannabinol, 8,9-Dihydroxy-Δ6a(10a)-tetrahydrocannabinol (8,9-Di-OH-CBT-C5), Cannabitriolvarin (CBTV), Ethoxy-cannabitriolvarin (CBTVE), Dehydrocannabifuran (DCBF), Cannbifuran (CBF), Cannabichromanon (CBCN), Cannabicitran (CBT), to-Oxo-Δ6a(10a)-tetrahydrocannabinol (OTHC), Δ9-cis-tetrahydrocannabinol (cis-THC), Cannabiripsol (CBR), 3,4,5,6-tetrahydro-7-hydroxy-alpha-alpha-2-trimethyl-9-n-propyl-2,6-methano-2H-1-benzoxocin-5-methanol (OH-iso-HHCV), Trihydroxy-delta-9-tetrahydrocannabinol (triOH-THC), Yangonin, Isocanabinoids, Epigallocatechin gallate, Dodeca-2E,4E,8Z,10Z-tetraenoic acid isobutylamide, or Dodeca-2E,4E-dienoic acid isobutylamide; and a second purified cannabinoid chosen from Cannabigerolic Acid (CBGA), Cannabigerolic Acid monomethylether (CBGAM). Cannabigerol (CBG), Cannabigerol monomethylether (CBGM), Cannabigerovarinic Acid (CBGVA), Cannabigerovarin (CBGV), Cannabichromenic Acid (CBCA), Cannabichromene (CBC), Cannabichromevarinic Acid (CBCVA), Cannabichromevarin (CBCV), Cannabidiolic Acid (CBDA), Cannabidiol (CBD), Cannabidiol monomethylether (CBDM), Cannabidiol-C4 (CBD-C4), Cannabidivarinic Acid (CBDVA), Cannabidivarin (CBDV), Cannabidiorcol (CBD-C1), Tetrahydrocannabinolic acid A (THCA-A), Tetrahydrocannabinolic acid B (THCA-B), Tetrahydrocannabinol (THC), Tetrahydrocannabinolic acid C4 (THCA-C4), Tetrahydrocannbinol C4 (THC-C4), Tetrahydrocannabivarinic acid (THCVA), Tetrahydrocannabivarin (THCV), Tetrahydrocannabiorcolic acid (THCA-C1), Tetrahydrocannabiorcol (THC-C1), Delta-7-cis-iso-tetrahydrocannabivarin, Δ8-tetrahydrocannabinolic acid (Δ8-THCA), Δ8-tetrahydrocannabinol (Δ8-THC), Cannabicyclolic acid (CBLA), Cannabicyclol (CBL), Cannabicyclovarin (CBLV), Cannabielsoic acid A (CBEA-A), Cannabielsoic acid B (CBEA-B), Cannabielsoin (CBE), Cannabinolic acid (CBNA), Cannabinol (CBN), Cannabinol methylether (CBNM), Cannabinol-C4 (CBN-C4), Cannabivarin (CBV), Cannabino-C2 (CBN-C2), Cannabiorcol (CBN-C1), Cannabinodiol (CBND), Caimabinodivarin (CBDV), Calmabitriol (CBT), 10-Ethoxy-9-hydroxy-Δ6a-tetrahydrocannabinol, 8,9-Dihydroxy-Δ6a(10a)-tetrahydrocannabinol (8,9-Di-OH-CBT-C5), Cannabitriolvarin (CBTV). Ethoxy-cannabitriolvarin (CBTVE), Dehydrocannabifuran (DCBF). Cannbifuran (CBF), Cannabichromanon (CBCN), Cannabicitran (CBT), 10-Oxo-Δ6a(10a)-tetrahydrocannabinol (OTHC), Δ9-cis-tetrahydrocannabinol (cis-THC), Cannabiripsol (CBR), 3,4,5,6-tetrahydro-7-hydroxy-alpha-alpha-2-trimethyl-9-n-propyl-2,6-methano-2H-1-benzoxocin-5-methanol (OH-iso-HHCV), Trihydroxy-delta-9-tetrahydrocannabinol (triOH-THC), Yangonin, Isocanabinoids, Epigallocatechin gallate, Dodeca-2E,4E,8Z,10Z-tetraenoic acid isobutylamide, and/or Dodeca-2E,4E-dienoic acid isobutylamide.

In some embodiments, the OBB is configured to blend one or more of phenolic acids, stilbenoids, dihydroflavonols, anthocyanins, anthocyanidins, polyphenols, tannins, flavones, flavan-3-ols, Flavan-4-ol, Flavan-3,4-diol flavonols, stilbenoids, phytochemicals, antioxidants, homoisoflavonoids, phenylpropanoids, Phloroglucinols coumarins, Phenolic acids, Naphthodianthrones, Steroid glycosides, bioflavonoids, isoflavonoids, and neoflavonoids. In some embodiments, the OBB is configured to blend one or more of Adenosine, Adhyperforin, amentoflavone, Anandamide, Apigenin. Cannaflavin B, Catechin (C), Catechin 3-gallate (Cg), Chlorogenic acid, cichoric acid, caftaric acid, Daidzein, Delphinidin, Eleutherosides, Epicatechin 3-gallate (ECg), Epicatechins, Epicatechin, epigallocatechin, myricetin, Oxalic acid, Pelargonidin, Tannin, Theaflavin-3-gallate, Theanine, Theobromine, Theophylline, Tryptophan, Tyramine, Xanthine, Caffeine, Cannaflavin A, Cannaflavin B, Catechin (C), Catechin 3-gallate (Cg), Epicatechin 3-gallate (ECg), Epicatechins (Epicatechin (EC)), epigallocatechin, Epigallocatechin (EGC), Epigallocatechin 3-gallate (EGCg), Gallocatechin (GC), Gallocatechin 3-gallate (GCg)), Gamma amino butric acid, Genistein, Ginkgo biloba, Ginsenosides, Quercetin, Quercitrin, and/or Rutin. In some embodiments, the OBB can be configured to blend a variety of compounds, such as those discussed in U.S. Pat. App. Pub. No. 2016/0250270, the entirety of which is herein expressly incorporated by reference for all purposes. In some embodiments, the OBB is configured to blend one or more of Caffeine, Cannaflavin A, Cannaflavin B, Catechin (C), Catechin 3-gallate (Cg), Epicatechin 3-gallate (ECg), Epicatechins (Epicatechin (EC)), epigallocatechin, Epigallocatechin (EGC), Epigallocatechin 3-gallate (EGCg), Gallocatechin (GC), Gallocatechin 3-gallate (GCg)), Gamma amino butyric acid, Genistein, Ginkgo biloba, Ginsenosides, Quercetin, Quercitrin, and/or Rutin.

Cannabinoids are reported to have certain desirable and/or therapeutic effects on those who ingest them.

Some reports indicate that users of the cannabinoid Tetrahydrocannabinol (THC) can experience one of more of the following benefits: pain relief, relaxation, reduced pain from nerve damage, reduced risk of nerve damage, controlled anxiety, suppression of muscle spasms and convulsions, control of certain cancers, reduced nausea, slowed inflammation, combatting of free radicals in the blood stream, stimulated appetite, stimulated new growth in nerve tissue, relief of chronic eye pressure and pain caused by glaucoma and other eye disorders.

Some reports indicate that users of the cannabinoid Cannabidiol (CBD) can experience one of more of the following benefits: control of certain cancers, pain relief, stimulation of bone growth, slowed or stopped growth of bacteria, suppression of muscle spasms and convulsions, slowed inflammation, reduced blood sugar levels, reduced risk of artery obstructions, decreased pressure in blood vessel walls, improved control over epileptic seizures, reduced risk of nerve damage, decreased feelings of social isolation caused by THC, and eased nausea.

Some reports indicate that users of the cannabinoid Cannabichromene (CBC) can experience one of more of the following benefits: pain relief, reduced or stopped growth of fungi, slowed inflammation, stimulated bone growth, encouraged cell growth, reduced or stopped growth of bacteria, and assistance in the contraction of blood cells.

Some reports indicate that users of the cannabinoid Tetrahydrocannabiuarin (THCU) can experience one of more of the following benefits: appetite suppression, control of obesity, and potentially control of Type II diabetes.

Some reports indicate that users of the cannabinoid Cannabinol (CBN) can experience one of more of the following benefits: sleep aid, combatting of free radicals in the blood stream, pain relief, suppression of muscle spasms and convulsions, and slowed inflammation.

Some reports indicate that users of the cannabinoid Cannabigerol (CBG) can experience one of more of the following benefits: reduced or stopped growth of bacteria, stimulation of bone growth, and encouraged cell growth.

Terpenoids are reported to have certain desirable and/or therapeutic effects on those who ingest them. Terpenes commonly found in cannabis include Myrcene, Limonene, Caryophyllene, Linalool, α-Pinene and β-Pinene. Some terpenes have immunomodulatory and anti-inflammatory effects in users.

Some reports indicate that users of the terpenoid α-Pinene can experience one of more of the following benefits: sleep aid, memory aid, anti-anxiety effects, sedative effects, bronchodilation, pine aroma, stress relief, energy increase, alertness, gastroprotective effects, anticonvulsion effects, anti-epileptic effects, asthma relief, and anti-inflammatory effects. α-Pinene is also found in pine needles, orange peel and parsley. α-Pinene can have an aroma of pine, wood, and/or mountain air.

Some reports indicate that users of the terpenoid Linalool can experience one of more of the following benefits: sleep aid, anti-anxiety effects, sedative effects, anxiolytic effects, anti-bacterial effects, pain relief, floral aroma, anticonvulsant effects, stress relief, anti-neoplastic effects, anti-psychotic effects, anti-epileptic effects, anti-convulsant effect, and analgesic effects. Linalool is also found in lavender, laurel and mint. Linalool can have a sweet, floral, citrus aroma, and can help with anxiety, provide sedation, and act as an anti-depressant.

Some reports indicate that users of the terpenoid Myrcene can experience one of more of the following benefits: sleep aid, relaxation, anti-tumor effects, anti-fungal effects, anti-cancer effects, anti-spasm effects, sedative effects, relief from aids insomnia, anti-inflammatory effects, anti-bacterial effects, muscle relaxation, accelerated onset of THC effects, and a “couch lock effect” at levels >0.5%. Myrcene is also found in hops, fresh mango and lemongrass. Myrcene can have a musky, earthy, clove-like, herbal aroma.

Some reports indicate that users of the terpenoid β-Caryophyllene can experience one of more of the following benefits: anti-tumor effects, anti-fungal effects, anti-septic effects, anti-inflammatory effects, anti-bacterial effects, arthritis relief, relief from gastrointestinal disorder, and muscle relaxation. Caryophyllene can have a rich, peppery, spicy aroma.

Some reports indicate that users of the terpenoid Carophyllene Oxide can experience one of more of the following benefits: anti-fungal effects, pain relief, a spicy aroma, anti-ischemic effects, and anti-inflammatory effects. Carophyllene can provide anti-inflammatory, analgesic, digestion-protective, anti-depressant and antiseptic effects in users, and can help to preserve tract cell lining. Caryophyllene is also found in black pepper, Thai basil, and cloves. Caryophyllene can have a spicy wood or pepper aroma.

Some reports indicate that users of the terpenoid α-Humulene can experience one of more of the following benefits: anti-tumor effects, anti-bacterial effects, a hoppy aroma, anti-inflammatory effects, and appetite suppression.

Some reports indicate that users of the terpenoid Limonene can experience one of more of the following benefits: anti-anxiety effects, anti-depression effects, anti-tumor effects, anti-fungal effects, anti-spasmodic effects, anxiolytic effects, gastroprotective effects, immunostimulant effects, antiseptic effects, stress relief, immunostimulation, apoptosis of breast cancer cells, anti-microbial effects, dissolution of gallstones in a clinical setting, relief of heartburn and/or gastrointestinal reflux, and increased blood flow from the heart. Limonene is also found in citrus fruit rinds, juniper, and peppermint. Limonene can have a citrus (e.g., lemon, orange) aroma.

Some reports indicate that users of the terpenoid Terpinolene can experience one of more of the following benefits: anti-bacterial effects, anti-fungal effects, a smokey woody aroma, anti-insomnia effects, and antiseptic effects.

Methods of Administration of cannabis products include inhalation methods, oral/sublingual methods, transdermal, and topical.

Inhalation methods include the smoking or vaporization of flower and/or concentrates, leading to CBR1 and CBR2 activation. Cannabinoids are absorbed into the user's bloodstream through the respiratory system.

Oral/sublingual methods include ingestion of edible food products, fresh juice (e.g., non-psychoactive), oral sprays, lozenges, tinctures, and capsules, leading to CBR1 and CBR2 activation. Cannabinoids are absorbed into the user's bloodstream through the oral mucosa and the digestive system. Liver metabolism of THC produces metabolites including ii-Hydroxy-THC.

Transdermal administration methods include transdermal patches, transdermal gels, rectal suppositories, and vaginal suppositories, leading to CBR1 and CBR2 activation. Cannabinoids are absorbed into the user's bloodstream through the user's skin or integumentary system, and bypass the first pass through the liver, thereby reducing the production of 11-Hydroxy-THC metabolites.

Topical administration includes application of cannabis products topically to skin, in the form of lotions, salves, balms, ointments, and bath salts or soaks, leading to CBR2 activation (but not CBR1 activation). Cannabinoids in topically administered products do not penetrate the skin sufficiently for the cannabinoids to enter the bloodstream. Topical formulations can be non-psychoactive, for example used for localized relief of pain, spasms, neuropathy or various skin condition.

Some reports indicate that Cannabinoids can act as therapeutic agents for cancer and neuroimmune diseases.

Cancers for which Cannabinoids may have a therapeutic effect include prostate cancer, breast cancer, multiple myeloma, non-Hodgkin's lymphoma, chronic lymphotytic leukemia, mantle cell lymphoma, hairy cell leukemia, bladder cancer, colorectal cancer, kidney cancer, and ovarian cancer.

Autoimmune diseases for which Cannabinoids may have a therapeutic effect include lupus, Crohn's disease, Hashimoto's thyroiditis, polymyositis, Sjogren's syndrome, Behcet's disease, primary biliary cirrhosis, irritable bowel syndrome (IBS), psoriasis and dermatitis.

Indications for which Cannabinoids may have a therapeutic effect include myalgic encephalopathy (“ME”), chronic fatigue syndrome (“CFS”), Gulf War Syndrome, autism, autism spectrum disorder (“ASD”), multiple sclerosis (“MS”), Parkinson's disease, amytrophic lateral sclerosis (“ALS”), fibromyalgia, chronic lyme disease, (“OCD”), (“ADHD”), and Post-Traumatic Stress Disorder (“PTSD”).

Applications of the devices and systems set forth herein can include the treatment of post-traumatic stress disorder (PTSD). In such applications, outcome measures can include primary measures such as a Clinician-Administered PTSD Scale (“CAPS”) score, for example after 3 weeks of self-administration. Outcome measures can also include secondary measures such as Posttraumatic Symptom Checklists based on the Diagnostic and Statistical Manual of Mental Disorders, Fifth Edition (“DSM-5”), actigraphy (an objective sleep measure), Inventory of Depression and Anxiety Symptoms (“IDAS”), Timeline Follow Back (“TFB”), and/or Inventory of Psychological Functioning (“IPF”).

Endocannabinoid receptor locations for CBR1 include the central nervous system (“CNS”), brain and spinal cord, nerves, organs and peripheral tissues. Endocannabinoid receptor locations for CBR2 include organs and peripheral tissues, skin and the immune system.

All combinations of the foregoing concepts and additional concepts discussed herewithin (provided such concepts are not mutually inconsistent) are contemplated as being part of the inventive subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

In order to address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the disclosed innovations may be practiced. The advantages and features of the application are of a representative sample of embodiments only, and are not exhaustive and/or exclusive. They are presented to assist in understanding and teach the disclosed principles. It should be understood that they are not representative of all innovations within the scope of the disclosure. As such, certain aspects of the disclosure have not been discussed herein. That alternate embodiments may not have been presented for a specific portion of the innovations or that further undescribed alternate embodiments may be available for a portion is not to be considered a limitation of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various inventive concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, “terpene” can refer to a number of naturally occurring hydrocarbons based on combinations of the isoprene unit, and include by way of non-limiting example, the listed terpenes and terpenoids, Hemiterpenes, Monoterpenes, Sesquiterpenes, Diterpenes, Sesterterpenes, Triterpenes, Sesquarterpenes, Tetraterpenes, other Polyterpenes, citral, menthol, camphor, salvinorin A, ginkgolide, bilobalide, curcuminoids, Hemiterpenoids, Monoterpenoids, Sesquiterpenoids, Diterpenoids, Sesterterpenoids, Triterpenoids, Tetraterpenoids, Polyterpenoids, Norisoprenoids, Meroterpenes, as well as isomers and stereoisomers of any of the aforementioned, along with synthetic versions thereof.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements): etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein, the terms “about” and “approximately” generally mean plus or minus 10% of the value stated. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure. Where a list of values is provided, it is understood that ranges between any two values in the list are also contemplated as additional embodiments encompassed within the scope of the disclosure, and it is understood that each intervening value to the tenth of the unit of the lower limit unless the context clearly dictates otherwise, between the upper and lower limit of said range and any other listed or intervening value in said range is encompassed within the disclosure; that the upper and lower limits of said sub-ranges can independently be included in the sub-ranges is also encompassed within the disclosure, subject to any specifically excluded limit.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including.” “carrying,” “having,” “containing,” “involving.” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A portable microfluidic mixer system, comprising:
a blend application configured to issue blend instructions based on a specified recipe; and
a microfluidic mixer device, including:
a microfluidic mixer device housing with hinged articulated opening;
a plurality of microfluidic pumps disposed within the device housing;
a plurality of microfluidic valves disposed within the device housing;
a microfluidic dispenser at least partially extending through the device housing;
a microfluidic mixer chip disposed within the device housing and configured to receive and meter microfluidic amounts of each of at least a first fluid, a second fluid, and an at least one third fluid, each fluid having a viscosity different from a viscosity of each of the other fluids;
a mix controller disposed within the device housing and configured to electronically communicate with the blend application and receive blend application blend instructions therefrom;
the microfluidic mixer device including a plurality of fluid pathways defined therein and contained within the device housing, the fluid pathways including a fluid pathway providing fluid communication from a first fluid canister containing the first fluid to the microfluidic mixer chip, a fluid pathway providing fluid communication from a second fluid canister containing the second fluid to the microfluidic mixer chip, a fluid pathway providing fluid communication from a third fluid canister containing the at least one third fluid to the microfluidic mixer chip, and a fluid pathway providing fluid communication from the microfluidic mixer chip to the microfluidic dispenser, the microfluidic dispenser configured to receive metered microfluidic amounts of each of the first fluid, second fluid, and at least one third fluid from the microfluidic mixer chip for dispensing;
the mix controller configured to: (i) communicate with the blend application and receive blend application blend instructions, and (ii) based on blend instructions received from the blend application:
(a) control each of the plurality of microfluidic pumps and each of the plurality of microfluidic valves and thereby control a system pressure within the microfluidic mixer device, such that: (1) the first fluid is delivered to the microfluidic mixer chip, (2) the second fluid is delivered to the microfluidic mixer chip, (3) the at least one third fluid is delivered to the microfluidic mixer chip, (4) each of the first fluid, second fluid, and at least one third fluid are metered at microfluidic amounts according to the recipe to provide a microfluidic mixture of each of the first fluid, second fluid, and at least one third fluid; and
(b) control each of the plurality of microfluidic pumps and each of the plurality of microfluidic valves such that microfluidic mixture is dispensed from the microfluidic dispenser.

2. The microfluidic mixer system of claim 1, wherein the microfluidic mixer device further includes:
a microfluidic mixer chip heater, disposed within the device housing and configured to heat the microfluidic mixer chip; and
a canister heater block disposed within the device housing and configured to replaceably receive fluid canisters and heat received fluid canisters,
wherein the mix controller is further configured to, based on blend instructions received from the blend application, control the canister heater and the microfluidic mixer chip heater to establish a mix temperature for each of the fluids and thereby increase the viscosity of at least one of the fluids, according to the recipe;

3. The microfluidic mixer system of claim 1, wherein the device housing is separable such that the microfluidic mixer chip can be removed from the microfluidic mixer device, the device housing including a lock that prevents separation of the device housing when the lock is engaged.

4. The microfluidic mixer system of claim 2, wherein the device housing is separable such that fluid canisters can be removed from or placed in the canister heater block, the device housing including a lock that prevents separation of the device housing when the lock is engaged.

5. The microfluidic mixer system of claim 1, wherein the device housing is partial separable and includes an electronic lock that prevents separation of the device housing when the electronic lock is engaged, the electronic lock controlled by the mix controller and configured such that the electronic lock can be disengaged based on the mix controller receiving unlock instructions from the blend application such that the housing can be hingedly opened.

6. The microfluidic mixer system of claim 1, wherein the microfluidic mixer chip comprises fluorinated ethylene propylene.

7. The microfluidic mixer system of claim 1, wherein fluid channels defined in the microfluidic mixer chip configured to receive fluids are configured such that substantially all surfaces of each fluid channel consists essentially of fluorinated ethylene propylene.

8. The microfluidic mixer system of claim 1, wherein the microfluidic mixer chip consists essentially of fluorinated ethylene propylene.

9. The microfluidic mixer system of claim 1, wherein the microfluidic mixer chip consists of fluorinated ethylene propylene.

10. The microfluidic mixer system of claim 1, wherein the mix temperature is between 120 degrees F. and 300 degrees F.

11. The microfluidic mixer system of claim 1, wherein the mix temperature is between 130 degrees F. and 200 degrees F.

12. The microfluidic mixer system of claim 1, wherein the mix temperature is between 140 degrees F. and 175 degrees F.

13. The microfluidic mixer system of claim 1, wherein the mix temperature is between 150 degrees F. and 170 degrees F.

14. The microfluidic mixer system of claim 1, wherein system pressure from about 0.1 to 10 PSI.

15. A microfluidic cannabinoid mixer system, comprising:
a blend application implemented on a compute device; and
a microfluidic mixer device, including:
a microfluidic mixer device hinged, secure, articulated housing;
at least one microfluidic pump;
at least one microfluidic valve;
a microfluidic dispenser;
a microfluidic mixer chip configured to receive and mix a microfluidic amount of a first cannabinoid oil, a microfluidic amount of at least one second cannabinoid oil, and a microfluidic amount of an at least one terpene to form a microfluidic cannabinoid mixture, the first cannabinoid oil and the second cannabinoid oil each having a viscosity different from a viscosity of the at least one terpene;
the microfluidic mixer device including a plurality of fluid pathways defined therein, including a fluid pathway providing fluid communication from a first cannabinoid canister containing the first cannabinoid oil to the microfluidic mixer chip, a fluid pathway providing fluid communication from a second cannabinoid canister containing the second cannabinoid oil to the microfluidic mixer chip, a fluid pathway providing fluid communication from a terpene canister containing the at least one terpene to the microfluidic mixer chip, and a fluid pathway providing fluid communication from the microfluidic mixer chip and a microfluidic dispenser, the microfluidic dispenser configured to receive the microfluidic mixture from the microfluidic mixer chip and dispense the microfluidic mixture from the device; and
a mix controller in communication with the blend application implemented on the compute device and configured to, based on instructions received from the blend application, control each of the at least one microfluidic pump and the at least one microfluidic valve, such that: (1) a microfluidic amount specified by the instructions from the blend application of the first cannabinoid oil is delivered to the microfluidic mixer chip, (2) a microfluidic amount specified by the instructions from the blend application of the second cannabinoid oil is delivered to the microfluidic mixer chip, (3) a microfluidic amount specified by the instructions from the blend application of the at least one terpene is delivered to the microfluidic mixer chip, (4) the microfluidic mixer chip mixes the first cannabinoid oil, the second cannabinoid oil, and the at least one terpene to form the microfluidic mixture, and (5) the microfluidic mixture is dispensed from the microfluidic dispenser.

16. An apparatus, comprising:
at least one microfluidic pump;
at least one microfluidic valve;
a microfluidic dispenser;
a microfluidic mixer chip configured to receive and mix a microfluidic amount of a first fluid with a microfluidic amount of at least one second fluid to form a microfluidic mixture, the first fluid having a viscosity different from a viscosity of the at least one second fluid;
the apparatus including a plurality of fluid pathways defined therein, including a fluid pathway providing fluid communication from a reservoir containing the first fluid to the microfluidic mixer chip, a fluid pathway providing fluid communication from a reservoir containing the at least one second fluid to the microfluidic mixer chip, and a fluid pathway providing fluid communication from the microfluidic mixer chip and a microfluidic dispenser, the microfluidic dispenser configured to receive the microfluidic mixture from the microfluidic mixer chip and dispense the microfluidic mixture from the apparatus;
a mix controller configured to control each of the at least one microfluidic pump and the at least one microfluidic valve, such that: (1) the microfluidic amount of the first fluid is delivered to the microfluidic mixer chip, (2) the microfluidic amount of the at least one second fluid is delivered to the microfluidic mixer chip, (3) the microfluidic mixer chip mixes the first fluid and the at least one second fluid to form the microfluidic mixture, and (4) the microfluidic mixture is dispensed from the microfluidic dispenser.

17. The apparatus of claim 16, the apparatus further comprising at least one heater configured to change the viscosity of at least one of the first fluid and the at least one second fluid.

18. The apparatus of claim 16, the apparatus further comprising at least one heater including a reservoir heater and a microfluidic mixer chip heater

19. The apparatus of claim 16, wherein the microfluidic mixer chip comprises fluorinated ethylene propylene (FEP).

20. The apparatus of claim 16, wherein fluid channels defined in the microfluidic mixer chip configured to receive and mix the microfluidic amount of the first fluid with the microfluidic amount of the at least one second fluid to form a microfluidic mixture are configured such that substantially all surfaces of each fluid channel consists essentially of FEP.

21. The apparatus of claim 16, wherein fluid channels defined in the microfluidic mixer chip configured to receive and mix the microfluidic amount of the first fluid with the microfluidic amount of the at least one second fluid to form a microfluidic mixture are configured such that substantially all surfaces of each fluid channel consists of FEP.

22. The apparatus of claim 16, wherein the microfluidic mixer chip essentially consists of FEP.

23. The apparatus of claim 16, wherein the microfluidic mixer chip consists of FEP.

24. A portable microfluidic mixing and dispensing device, comprising:
a housing;
a computer processor;
a plurality of liquid reservoirs disposed within the housing;
at least one microfluidic mixer chip disposed within the housing and in fluid communication with the plurality of liquid reservoirs, the microfluidic mixer chip configured to receive and convey fluids from the plurality of liquid reservoirs and mix the received fluids, the fluids having different viscosities;
one or more valves in communication with the computer processor and configured to dispense liquids from at least two of the plurality of liquid reservoirs into the microfluidic mixer chip based on one or more signals from the computer processor; and
a dispenser in fluid communication with the at least one microfluidic mixer chip and configured to dispense the mixed fluids.

25. The portable microfluidic mixing and dispensing device of claim 24, further comprising an outlet aperture defined in the housing, the outlet aperture configured such that the dispenser extends through the outlet aperture dispense the mixed fluids.

26. The portable microfluidic mixing and dispensing device of claim 24, wherein the housing defines a port configured to receive a receptacle into which mixed fluid can be dispensed from the dispenser.

27-29. (canceled)

30. A portable microfluidic system, comprising:
a software application configured to issue instructions based on a specified recipe; and
a microfluidic device, including:
a microfluidic device housing with hinged articulated opening;
a microfluidic pump disposed within the device housing;
a microfluidic valve disposed within the device housing;
a microfluidic dispenser at least partially extending through the device housing;
a microfluidic chip disposed within the device housing and configured to receive and meter a microfluidic amount of a fluid;
a controller disposed within the device housing and configured to electronically communicate with the software application and receive instructions therefrom;
the microfluidic device including a fluid pathway defined therein and contained within the device housing, the fluid pathway providing fluid communication from a fluid canister containing the fluid to the microfluidic chip, and a fluid pathway providing fluid communication from the microfluidic chip to the microfluidic dispenser, the microfluidic dispenser configured to receive metered microfluidic amounts of the fluid from the microfluidic chip for dispensing;
the controller configured to: (i) communicate with the software application and receive instructions, and (ii) based on instructions received from the software application:
(a) control the microfluidic pump and the microfluidic valve to control a system pressure within the microfluidic device, such that: (1) the fluid is delivered to the microfluidic chip, (2) the fluid is metered at a microfluidic amount according to the recipe to provide a microfluidic volume of the fluid; and
(b) control each of the microfluidic pump and the microfluidic valve such that the microfluidic volume of the fluid is dispensed from the microfluidic dispenser.
